(19) United States
(12) Patent Application Publication
(10) Pub. No.: US 2007/0288247 A1
(43) Pub. Date: Dec. 13, 2007

(54) Digital life server

(76) Inventor: Michael Mackay, Los Altos, CA (US)

Correspondence Address: PERKINS COIE LLP, P.O. BOX 2168, MENLO PARK, CA, 94026, US

(21) Appl. No.: 11/451,614

(22) Filed: Jun. 11, 2006

(51) Int. Cl. G06Q 10/00; G06Q 30/00

(52) U.S. Cl. 705/1

(57) ABSTRACT

In various embodiments, a digital life server is provided. In an embodiment, a method is provided. The method includes receiving at a remote server from an authenticated user a request for data. The method further includes determining if the data is stored at the remote server. The method also includes providing the data to the authenticated user.

### BACKGROUND

People currently have a wide variety of digital devices and applications at their disposal for accessing online information and services including different types of personal computers, mobile devices, personal digital assistants, and so on. Most of these products have a design point for significant upgrade or replacement of three to five years, thus confronting their owners with the periodic challenge of backing-up and restoring their personally valuable digital information and dealing with any breakages that occur as part of the process. This process is frequently error-prone, time-consuming, and can entail significant costs if existing applications need to be replaced or new ones acquired in order to retain access to the individual's or small group's accumulated data. Specific types of failures frequently encountered as part of the backup/upgrade cycle include:
loss of file system access control and security settings;
loss of file system linked references;
loss of application data references resulting in broken logical relations between items such as e-mail and linked documents, financial or other applications and their linked databases, etc.
data loss due to damaged or improperly maintained backup media or mis-configured backup software; and
mistakes made during the upgrade/restore process for which there is simply no means of recovering the lost data.

These types of failures cost people time in recreating the original organization, and it may not even be possible to fully recover all the material. While these types of problems represent challenging issues for seasoned IT professionals when upgrading within the same technology/product line, they are nearly impossible for individuals or groups to contend with in their activities. Finally, attempting to completely move the individual's data from one product to a different manufacturer's completely different operating system or set of applications further complicates an already difficult process.

Once online, a practically limitless variety of services can be accessed using well-established internet and web protocols, providing people with the ability to navigate to and access information content about practically any topic of interest to them. While paid content services exist, many if not most information services are available for no direct cost to people except for their willingness to assent, usually implicitly, to being tracked for demographic profiling purposes. Sophisticated techniques integrated with the standard web browsing experience make it possible for online services to develop sophisticated knowledge of an individual's interests, tastes, relationships, purchasing habits, academic and work activities, travel profiles, etc.—the list is almost as long as there are parties who have the motivation to characterize, instrument, and track a discernable unit of activity. While most people are willing to accept the exchange of value based on demographic analytics and modeling that underlies advertising revenue-supported access to most online information sources, there is no means for them to actually benefit from or develop equivalent insight about themselves based on the same transactional data. Knowledge intrinsic in the transactional data flow between the individual's browser and the web is completely ephemeral and unavailable for enhancing their own ongoing awareness of themselves, the groups they participate in, or the world.

Moreover, people are increasingly drawn to open registration web-based services as a place for conducting all manner of discussions and information sharing. Diverse topics ranging from healthcare, popular culture, and legal issues, to family photos and vacations, are exchanged through increasingly open and direct channels using technologies such as threaded e-mail discussions, wikis, web logs (blogs), chat forums, photo-sharing sites, and so on. Effects of bad actors notwithstanding, legitimate participants may never have any personal relationship beyond their online interaction and therefore little means for gauging either the value or consequences of that interaction. Similarly, most of these systems are operated without any uniform or enforceable guarantee of how long they will retain or use the recorded information, and how the information might be reused under a change of control or sale of the business (and of course, how the information might be captured and retained in other open systems). Research by analysts such as the Pew Internet and American Life Project indicate that the large majority of users never fully read the posted policies, and fewer still are aware of subtleties that may exist in what they do read.

Over time and across many interactions, it is increasingly well understood and articulated in academic research, that correlation of personal data across many sites and transactions can lead to collapse of any perception of privacy, context, or community that might have been assumed as part of the original communication. Taken out of context, seemingly transient or innocuous discussions can come back years later with surprising effects. Information relevant to family, career, academic, or personal interests and relationships, once exposed, can never effectively be contained through these types of systems. Public access versus public exposure are practically indistinguishable, and over time and countless interactions, individually unmanageable.

The relatively short-term approach to management and protection of personally valuable information intrinsic in the design of contemporary computing products mixed with the unpredictable long-term effects of web-based activity, creates a tenuous foundation for individuals, insitutions, and society at large, to move confidently forward in building sophisticated institutions based wholly on digital transactions and information artifacts. Yet, tremendous investment of time, effort, and wealth is applied to bringing more social, financial, and governmental infrastructure increasingly online in digital form, regardless of whether its related to medicine and health, education, banking, or general commerce. While the exchange of data is easier in the moment using current web technologies, the ability to confidently retain a personal history or record or the events is difficult.

People are effectively on their own when it comes to assuring long term availability and protection of their personally valuable information. In the face of growing dependence on a lifetime of digital information created or accumulated from personal, online, and institutional interactions, there is no coherent solution for how to manage, control, and benefit from this valuable history.

While the wide diversity of online information sharing and portal services available on the web offer potentially great opportunity for both consumers and providers alike, the more services in which people participate, the more complexity they need to manage. If the original goal was to facilitate sharing a limited amount of information with a small number of close relations—for example between family members or a group, the overhead of participating in increasingly more services, possibly as a consequence of being invited or needing to participate in activities with a different set of relations, quickly becomes complicated. Strategies such as technologies to synchronize the individual's data across their different accounts may seem like an appealing option, but this raises still other issues. In particular, to the extent the individual or the groups in which they participate choose to employ different services for the purpose of segregating different personal activities or conversations, most individuals perceive in doing so that those conversations or activities can be effectively separated. Research by the MIT Media Lab shows that many users employ strategies such as creation of multiple pseudonyms as an ad hoc strategy for maintaining privacy by trying to minimize cross-linkage and correlation of identities across different accounts. However, this and other research further shows that such strategies are brittle and prone to collapse over time as individuals fail to maintain perfect isolation of their activities and relationships across the multiple services. As previously discussed, common demographic profiling techniques employed by most commercial sites tend to further erode the effectiveness of ad hoc approaches to privacy. If the individual desires to create multiple accounts on different systems while maintaining a strong degree of privacy, then they require tools that can assist in maintaining strong separation between those activities. If the individual prefers a trusted, personal experience, then they require a different approach to achieving their goal.

In the case of peer-to-peer network overlay architectures, file sharing using common personal computers requires the user's willingness to expose a portion of their file system to other members of the peer network. A wide variety of peer-to-peer protocols exist with different design features for anonymity, availability, optimization of network transfer speed, etc. Systems designed for strong anonymity may use techniques such as onion routing protocols; designs for high availability and transfer speed may use protocols derived from the Bittorrent line of technology; and there are many others. Regardless of the protocol design or network connection topology, these systems all build on sharing of local system resources, thus leading to inconsistent guarantees regarding security of the local system and other information assets on that system. There is no systematic basis for trust in these systems, save possibly except for weak reputation-based or shunning techniques for limiting the effects of free-rider participants or bad actors who may inject corrupt or malicious data into the peer overlay network. Ultimately, the lack of systematic trust management and risks associated with peer-to-peer shared resources (such as mis-configuration of local file system access controls or vulnerabilities in the sharing software itself) minimize the desirability of these techniques for controlled and secure distribution of personally-valuable information.

Finally, institutional expectations over the next decade for expanded electronic healthcare services, online government, academic, and public services, will only increase the need for people and small groups to have a durable, personal, secure, and coherent approach to managing their data over long periods of time and different contexts. Availability of such a solution can have a dual benefit both to individual users and the creation of new business opportunities generally.

### BRIEF DESCRIPTION OF THE DRAWINGS

The present invention is illustrated by way of example in the accompanying drawings. The drawings should be understood as illustrative rather than limiting.

FIG. 1 is a schematic diagram illustrating relationships and configuration of a DLS server appliance in an embodiment.

FIG. 2 is a schematic diagram illustrating relationships and configuration of a DLS server appliance in another embodiment.

FIG. 3 is a schematic diagram illustrating relationships and configuration of two DLS server appliances in an embodiment.

FIG. 4 is a schematic diagram illustrating the major functional areas of the DLS architecture in an embodiment.

FIG. 5 is a schematic diagram illustrating details of functional subsystems that make up a DLS architecture in an embodiment.

FIG. 6 is an illustration of the volume partitioning and layout for secure storage areas on a DLS server appliance disk system in an embodiment.

FIG. 7 is a diagram illustrating DLS subsystem relationships involved in configuration of the DLS server appliance in an embodiment.

FIG. 8 is a diagram illustrating DLS subsystem relationships involved in configuration of the DLS server appliance in another embodiment.

FIG. 9 is a schematic diagram illustrating the data structure fields and layout of a collections object in an embodiment.

FIG. 10 is a schematic diagram illustrating the data structure fields and layout of a canonical DLS storage object (DSO) in an embodiment.

FIG. 11 is a schematic diagram illustrating the data structure fields and layout of a preservation services epoch archive data record (arcdata) structure in an embodiment.

FIG. 12 is a schematic diagram illustrating the protocol data flows and relationships for writing preservation arcdata from the DLS server appliance to an online preservation service (OPS) system in an embodiment.

FIG. 13 is a schematic diagram illustrating the protocol data flows and relationships for reading preservation arcdata to the DLS server appliance from an OPS system in an embodiment.

FIG. 14 is a schematic diagram illustrating the logical components of an operational support services (OSS) system and the relationship with a DLS server appliance in an embodiment.

FIG. 15 is a schematic diagram illustrating the logical components of an online preservation service (OPS) system and the relationship with a DLS server appliance in an embodiment.

FIG. 16 is a block diagram of the major components of a semantic history navigator in an embodiment.

FIG. 17 is a block diagram illustrating detail of the semantic history navigator day context pane in an embodiment.

FIG. 18 is a block diagram illustrating detail of the semantic history navigator day context pane and correlated activities and interests relationships with elements displayed in the current activities pane in an embodiment.

FIG. 19 is a block diagram illustrating detail of the semantic history navigator day context pane and correlated activities and interests relationships with elements displayed in the timeline and events pane in an embodiment.

FIG. 20 is a block diagram illustrating detail of the semantic history navigator day context pane and correlated activities and interests relationships with elements displayed in the context navigator pane in an embodiment.

FIG. 21 is a block diagram illustrating detail of the semantic history navigator day context pane and correlated activities and interests relationships with elements displayed in the current activities pane in an embodiment.

FIG. 22 is a block diagram illustrating an example alternative layout for the semantic history navigator in an embodiment.

FIG. 23 is a graphical representation of the semantic history navigator in an embodiment.

FIG. 24 is a block diagram illustrating structural layout relationships between the personal semantic workspace, various context panes, the semantic history navigator, and contextually-correlated relationships between the presentation data elements in each pane in an embodiment.

FIG. 25 is a graphical representation of the personal semantic workspace in an embodiment.

FIG. 26 is an illustration showing a graphical representation of the personal semantic workspace and the use of color in indicating correlated relationships between various data elements in an embodiment.

FIG. 27 is a block diagram illustrating an alternative layout for structural relationships between the personal semantic workspace, various context panes, the semantic history navigator, and contextually-correlated relationships between the presentation data elements in each pane in an embodiment.

FIG. 28 is a diagram illustrating DLS subsystem relationships involved in configuration of the DLS server appliance for semantic application and browsing activities using an instance of a client browser and the personal semantic workspace in an embodiment.

FIG. 29a is a graphical representation of the memory task interface as a floating overlay in an embodiment.

FIG. 29b is a graphical representation of the memory task interface as a composited web page toolbar element in an embodiment.

FIG. 29c is a graphical representation of the fact collection task basic overlay interface in an embodiment.

FIG. 29d is a graphical representation of the fact collection task advanced overlay interface in an embodiment.

FIG. 30a is a graphical representation of the memory task interface as a floating overlay on a representative web page in an embodiment.

FIG. 30b is a graphical representation of the fact collection task overlay on a representative web page in an embodiment.

FIG. 31 is a diagram illustrating DLS subsystem relationships involved in configuration of the DLS server appliance for semantic application and browsing activities using an instance of a client browser and the memory task application/fact collection task overlay interface in an embodiment.

FIG. 32 is a schematic diagram illustrating the protocol data flows and relationships for processing and delivering a memory task overlay application from the DLS server appliance in an embodiment.

FIG. 33 is a flow diagram illustrating an embodiment of a webpage access process using a DLS.

FIG. 34 is a flow diagram illustrating an embodiment of a webpage overlay process using a DLS.

FIG. 35 is a flow diagram illustrating an embodiment of a process of storing data using a DLS.

FIG. 36 is a flow diagram illustrating an embodiment of a process of storing a document using a DLS.

FIG. 37 is a flow diagram illustrating an embodiment of a process of storing event information using a DLS.

FIG. 38 is a flow diagram illustrating an embodiment of a process of retrieving stored information from a DLS.

FIG. 39 is a block diagram illustrating an embodiment of a network which may be used with a DLS and related components.

FIG. 40 is a block diagram illustrating an embodiment of a machine which may be used with or as a DLS and related components.

### DETAILED DESCRIPTION

A system, method and apparatus is provided for a digital life server. This may allow for long-term management and preservation of valuable digital information by individuals and small groups. Various embodiments generally relate to secure long-term storage, navigation, and processing of digital information in consumer devices and networks. More particularly, some embodiments relate to systems and techniques for storage, archival preservation, and historical navigation of digital information that is aggregated, created, organized, used, and distributed by individuals over very long periods of time, typically, over a lifetime.

Additionally, some embodiments further relate to systems and methods of semantic processing and annotation of transactional information flows initiated by an individual between a web browser or other application and arbitrary information services such as those commonly found on the web. Also, some embodiments relate to systems and methods for automated organization of personally valuable digital information according to temporal, topical, or other contextual relationships using metadata either specified or synthetically derived using analytic or inference techniques. Moreover, various embodiments relate to systems and methods for privacy, trust management, and protection of an individual's or small group's accumulated data, and mechanisms for the controlled sharing of information created and/or accumulated by them in conjunction with distributed storage services and applications.

The specific embodiments described in this document represent exemplary instances of the present invention, and are illustrative in nature rather than restrictive. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

In one embodiment, a software-based distributed system for secure preservation and organization of digital information is presented. Such information may be created or collected by individuals or small groups over long periods of time, both through the use of conventional personal computer systems, applications, and devices, and through online web browsing activities. Services provided for direct use by the individual or small group may be configured in a set of server-based software components, and are referred to in this embodiment as the digital life server (DLS). DLS functionality in this embodiment includes:
support for interoperability with common personal computer and device file service protocols and applications including electronic mail and messaging, calendar data, syndicated web content feeds, and web services;
support for transparent application-level proxies for interaction with other distributed systems in support of some or all of the DLS-supported interoperability protocols;
uniform object-based storage for data stored and managed by the DLS in conjunction with all of the supported interoperability protocols and their associated data types;
durable long-term organization, annotation, and enrichment through references, linking, and addition of semantic metadata to any of the stored data objects;
automated recovery and transformation services for orphaned datatypes, including provenance information for variant renditions of the original data;
uniform security semantics and trust relationships between all data objects stored and managed by the DLS system, and related security principals including individual users and role-based groups;
secure, automated preservation functions on all data objects managed by the DLS system, including integrated historical navigation over the collective preservation record;
support for strong privacy between all security principals including users and role-based groups;
support for trusted sharing of authorized data objects between distributed DLS systems;
support for seamless integration of web-based content management and transactions with all DLS managed data objects; and
support for semantic processing techniques on all DLS-managed data objects including automated and user-directed creation of facts and concepts metadata, reasoning, and semantic queries over the individual's collective set of data objects.

In an embodiment, the DLS provides information processing and long-term storage services configured in the form of a network-attached server appliance for deployment in an IP network. The DLS network-attached server appliance may be realized as a separate physical device including a processor, dedicated disk storage, memory, network connections, and potentially including other features. Similarly, the DLS may be implemented as part of a system or device, rather then a separate device.

Alternatively, in other embodiments, the DLS network-attached server appliance may be realized in a purely software-based implementation. Thus, the DLS may be implemented as a virtualized server, or “soft appliance,” using hypervisor technologies, such as VMWare™ or XEN™ on a shared computer. Whether the DLS server appliance is embodied in the form of a dedicated physical device or as a virtual server using shared physical computing resources, it may provide the same functionality as a network-attached server

Whether implemented as hardware, software, or some combination of the two, multiple individuals sharing an IP network, may share a single instance of a DLS server appliance. In such cases, each individual may be a unique security principal and their view of the system is through their personal account. Certain DLS services can also be accessed from locations external to the home network using standard internet protocols from a remotely connected web browser application running on any type of device.

The system, in some embodiments, additionally provides two sets of distributed services called operational support services (OSS), and online preservation services (OPS), which may be operated remotely from the DLS. Distributed OSS systems in such embodiments provide functionality including:
operational support for software maintenance and upgrade of DLS systems;
historical tracking, identification, and distribution of official software configurations and their components;
distribution of operational knowledge bases;
verification of DLS authenticity claims;
distribution of third-party software functional extensions and framework plug-ins;
distribution of security policies for DLS systems;
threat monitoring and tracking; and
DLS emergency response services.

There can be multiple OSS service instances and they can be operated by a variety of different commercial operators/providers.

The OPS in such embodiments provides the distributed services interface to online mass storage for preservation of DLS users' data sets. In such embodiments, the DLS is typically operated with a configured OPS service. Distributed OPS systems provide functionality including:
OPS account authentication;
preservation services including transaction authorization and session management;
distribution of preservation policies for DLS systems;
management and administration of per-account policies; and
management and administration of mass storage system policies.
There can be multiple OPS service instances and they can be operated by a variety of different commercial operators/providers.

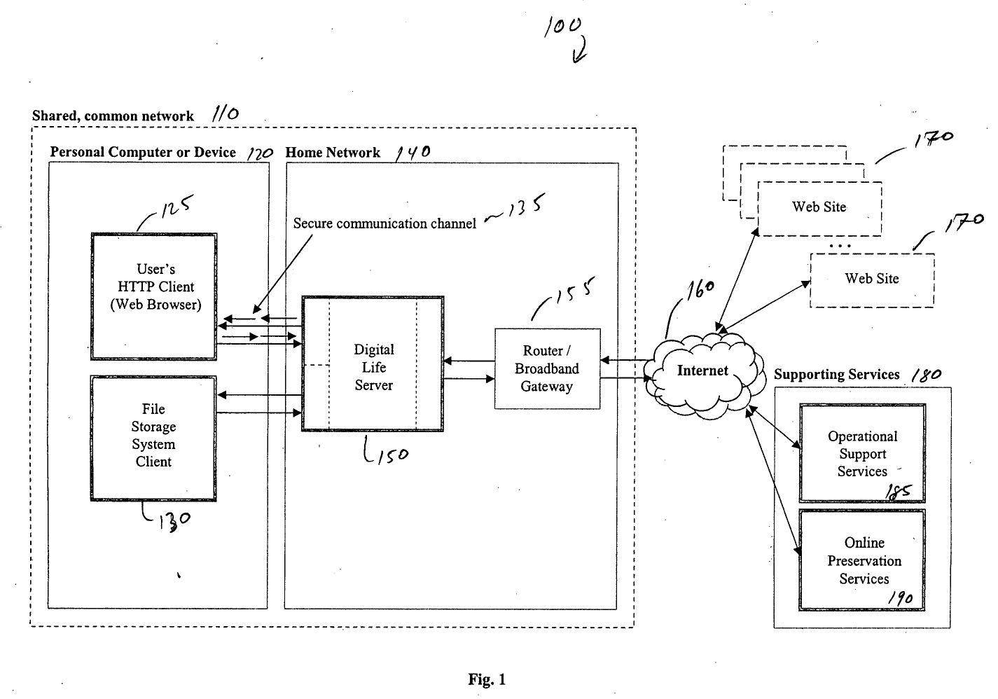

FIG. 1 illustrates an embodiment of the network topology relationships between the digital life server (DLS) appliance, its supporting online preservation service (OPS) and operational support services (OSS) systems, and a personal computer or device connected to the DLS over a common, or “home network” configuration. Communications between the personal computer operating system's file storage client software and the DLS are illustrated; these communications utilize protocols native to the operating system, examples of which may including Microsoft CIFS™, Microsoft SMB™, IETF WebDAV, and potentially others.

FIG. 1 also illustrates communication between the personal computer user's web browser and the DLS. Communications over this channel use standard web protocols such as W3C HTTP and/or SOAP; and potentially a wide variety of standard content formats such as W3C DHTML, XML, CSS, etc.; scripting languages such as JavaScript; and potentially dynamically uploadable active content such as Java Applets, Midlets, or similar active content types from a variety of vendors. The actual web protocols, formats, script code, and active content are determined primarily as a function of the remote web application and the capabilities of the web browser application of a given embodiment or instance.

In more detail, communications between the personal computer user's web browser and the DLS are identified as part of a secure communications channel. In the case of this illustration, the secure channel is provided for communication between the user's web browser and a web application running on the DLS. Techniques for securing this channel may utilize standard transport security protocols for communication over IP networks. In an embodiment, the channel is secured using the IETF TLS transport layer security protocol. More specifically, the IETF TLS protocol provides for a mutual authentication option that allows the communication endpoints using TLS to engage in a set of transactions using identity certificates as proofs of their authenticity. Secure communications between the user's web browser and the DLS may employ the mutual authentication option, and utilize DLS-generated identity certificates for the trust proof. The related certificates are created by the DLS' Trust Manager for the user to install in their browser using its normal mechanisms. Certificates are provided for each web browser/device combination that the user chooses to configure. The certificates are requested by the user and provided to them using a web-based administrative interface provided by the DLS in conjunction its support for user account administration.

The personal computer user's web browser is also used for communication with a wide variety of web sites over the internet. Browsing activities with third-party web sites are conducted in the normal manner utilizing the protocols and possible transport layer security mechanisms selected by the third party web site.

With further reference to FIG. 1, system 100 includes a local network 110, internet 160, websites 170 and supporting services 180. Supporting services 180 include the OSS 185 and OPS 190. The local network 110 includes a personal computer 120 with an HTTP client 125 and a file storage system 130, and a home network with a router 155 and a DLS 150 interposed between the router 155 and the personal computer 120. Personal computer 120 may be any number of different devices, such as a computer, a personal digital assistant, a cellular telephone, an intelligent appliance, or another device including a processor and memory.

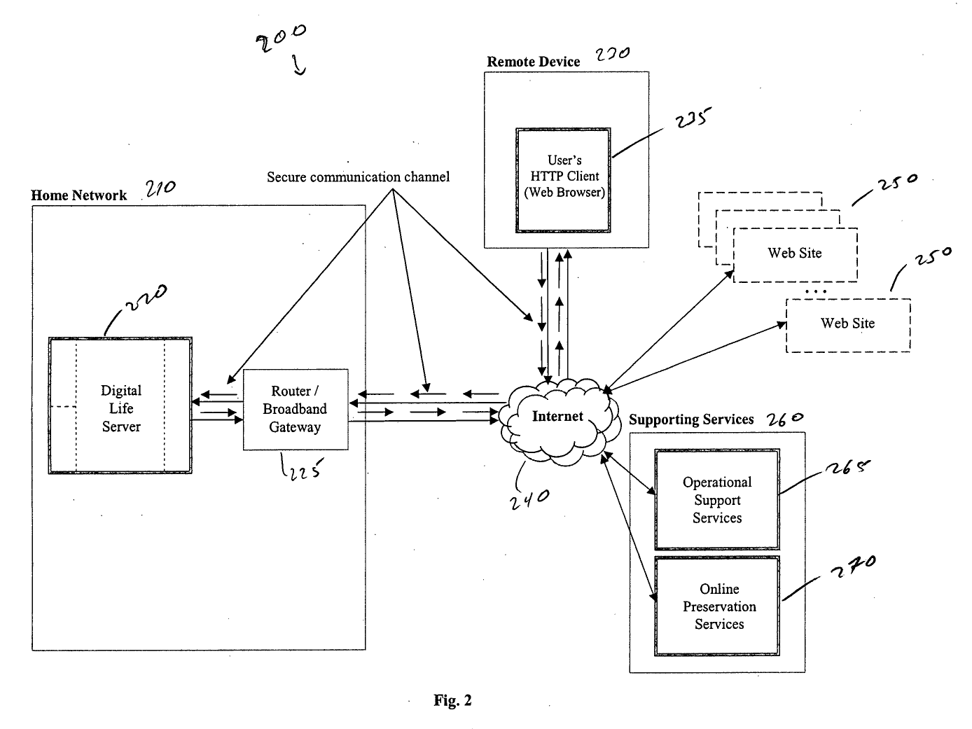

FIG. 2 illustrates many similar elements to the embodiment of FIG. 1. However in this system 200, the user's web browser 235 is provided on a remote device 230 outside of the home network 210. The remote device 230 is able to connect to the DLS system 220 in the home network 210 using standard techniques such as Dynamic DNS as described in IETF specifications RFC 2136, RFC 2671, and RFC 2845, or possibly peer interconnect services provided in conjunction with IPv6 Internet Multimedia Services (IMS) protocols. Similar to FIG. 1, the communications channel between the remote device and the DLS in FIG. 2 is a secure channel. Channel security in the remote case is supported in the same manner as local case in FIG. 1, using TLS in an embodiment and DLS-generated certificates for mutual authentication. Communication occurs through the Internet 240 and the router 225. Moreover, operations may implicate websites 250, and supporting services 260 such as OSS 265 and OPS 270.

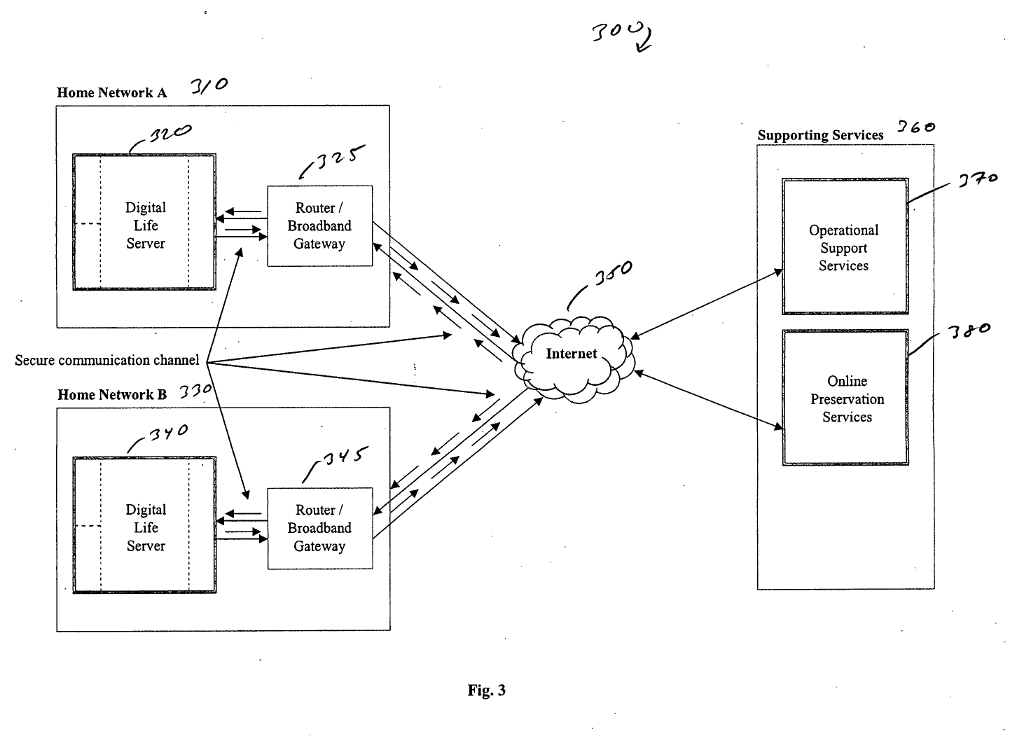

FIG. 3 illustrates the network topology relationships between two DLS appliances connected using Trusted Sharing Services (TSS) in an embodiment. There is no functional limit on the number DLS systems that can be connected using TSS. Again, as previously illustrated in FIGS. 1 and 2, communications between the DLS systems in home network A and home network B as illustrated in FIG. 3 are conducted using a secure communications channel. Creation and distribution of the identity certificates between the distributed DLS systems is provided by administrative functions specific to the TSS. Regardless, the secure channel established between the DLS systems utilizes mutual authentication and trust certificates created and authorized using the DLS.

FIG. 3 illustrates a system 300 with home networks A 310 and B 330. Home network A 310 includes a DLS 320 and a router 325. Home network B 330 includes a DLS 340 and a router 345. The secure communications channel passes through the internet 350, even though it is maintained in a secure manner as much as possible. Supporting services 360, including OSS 370 an OPS 380 are also available to either DLS 320 or DLS 340.

Typical for the secure communications channels of the embodiments described in FIGS. 1, 2, and 3, are the following:
access to DLS web applications, or between services provided by the DLS to web-based clients and/or between DLS server appliances using subsystems such as TSS, are always conducted over a secure communications channel;
secure communications channels between a client web browser or other application and the DLS, or between DLS server appliances, are always mutually authenticated; and
identity certificates used for mutual authentication of a secure communications channel with the DLS are generated by the DLS system that is responsible for verifying the certificate required for trust between the requesting client and that specific DLS system.

In more detail, in these embodiments, each DLS is responsible for generating the certificates required for communications with it. This means that certificates required for mutual authentication with one DLS will only work with the specific DLS, and authorization required for communication with another DLS must be explicitly granted in the form of another certificate for that particular DLS. Consequently, this approach establishes a web-of-trust topology designed on the principle that each DLS only trusts itself, and must therefore authorize each party that desires to speak to it explicitly. This style of trust management topology is consistent with the expected use of the DLS as a system for individuals or small groups, and comparatively small numbers of parties who may be authorized for shared access to a particular DLS using the TSS subsystem (which itself is only configured for operation between DLS server appliances).

In some embodiments, DLS-generated identity certificates are based on IETF specification RFC 2693, the Simple Public Key Infrastructure (SPKI) standard. It is possible using delegation as specified in the IETF SPKI standard, to construct trust chains that can effectively model hierarchical trust topologies, as well as web-of-trust approaches. It is therefore also possible to configure DLS systems in a manner that allows for hierarchical trust management, thus allowing for alternative hierarchical trust management designs that could employ one identity certificate for mutual authentication with multiple DLS systems. This is a feature of the SPKI standard that could be configured for the DLS system. Regardless, in such embodiments, trust management for establishment of secure communications channels with the DLS utilizes identity certificates without delegation in order to directly model the relationship between the DLS and each authorized partner device.

In all cases, the DLS is connected to the internet through use of a separate router/gateway system. More specifically, the DLS may require functionality typically provided by a router/gateway system or device for network configuration information including its IP address assignment and configuration of DNS address entries, typically using the IETF DHCP protocol. It is equally acceptable to incorporate the router/gateway function(s) in a server appliance with the DLS, although in such a case, the router and broadband gateway function(s) still remain functionally distinct.

Overview of the DLS Architecture

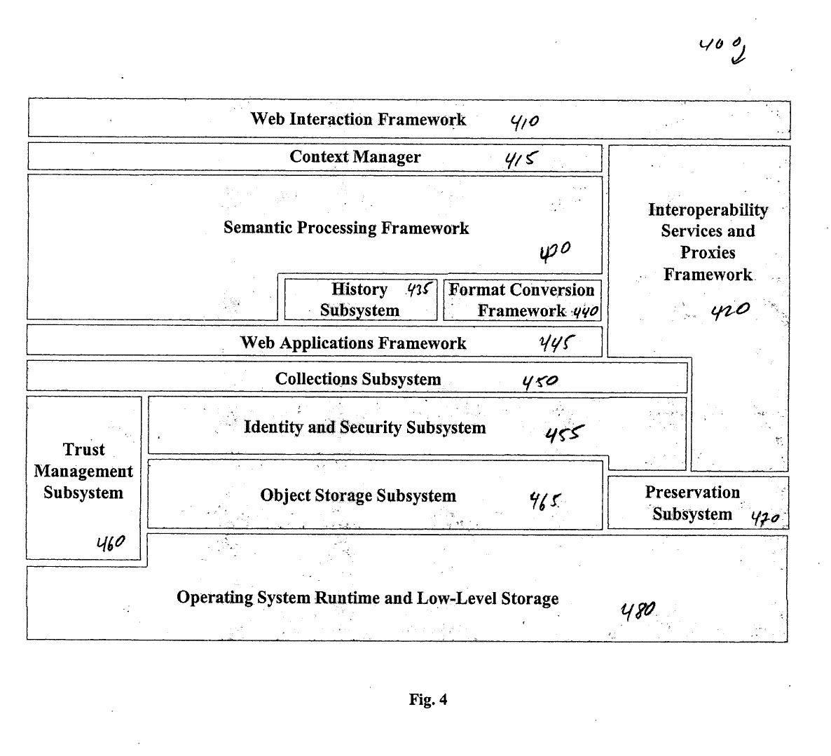

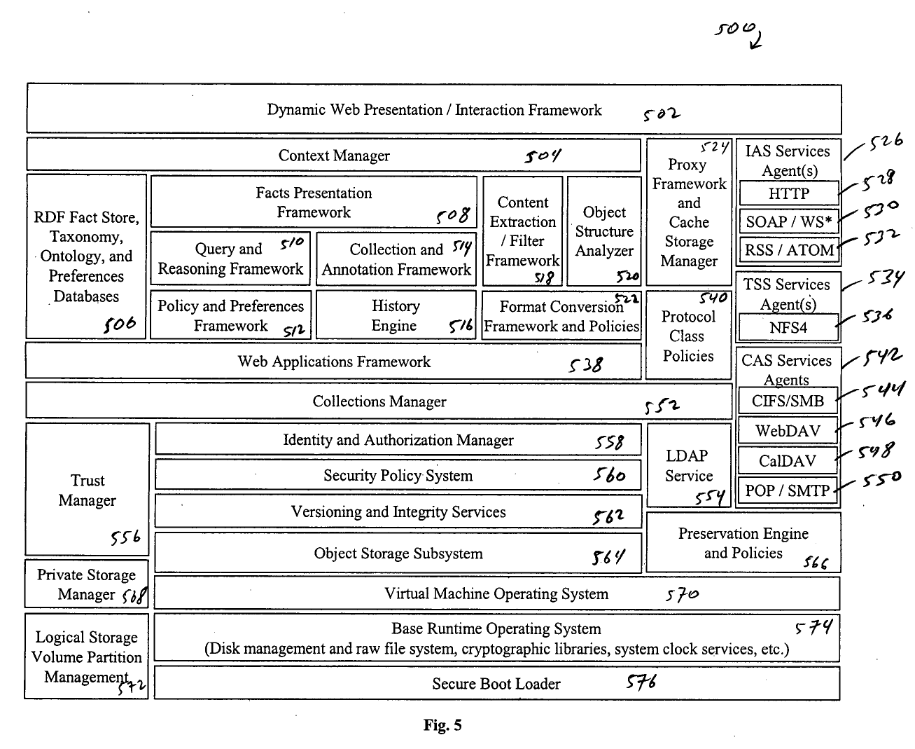

FIG. 4 illustrates the set of major functional areas that provide the DLS software architecture in an embodiment. FIG. 5 elaborates on FIG. 4 by providing a more detailed view of the subsystems underlying each of these functional areas in an embodiment.

DLS 400 includes a web interaction framework 410, context manager 415, semantic processing framework 430, history subsystem 435, format conversion framework 440, web applications framework 445, interoperability services and proxies framework 420, collections subsystem 450, identity and security subsystem 455, object storage subsystem 465, preservation subsystem 470, trust management subsystem 460 and an operating system 480.

DLS 500 includes a variety of supporting systems and subsystems, and represents one embodiment of a DLS such as DLS 400. DLS 500 includes web presentation/interaction framework 502 and context manager 504. Further included are databases 506, facts presentation framework 508, query/reasoning framework 510, collection/annotation framework 514, policy/preferences framework 512 and history engine 516. Also included are content extraction/filter framework 518, object structure analyzer 520 and format conversion 522. Additionally, proxy framework and cache storage manager 524 and protocol class policies 540 are included. Moreover, IAS service agents 526, such as HTTP agent 528, SOAP/WS* agent 530 and RSS/ATOM agent 532 are included along with TSS services agents 534 such as NFS4 agent 536 and CAS services agents 542 such as CIFS/SMB agent 544, WebDAV agent 546, CalDAV agent 548 and POP/SMTP agent 550.

Further included are web applications framework 538, collections manager 552, identity and authorization manager 558, security policy system 560, versioning and integrity services 562, and object storage subsystem 564. Additionally, trust manager 556, private storage manager 568 and logical storage volume partition management 572 are included. Moreover, LDAP service 554 and preservation engine and policies 566 are included. Also, virtual machine operating system 570, base operating system 574 and boot loader 576 are included.

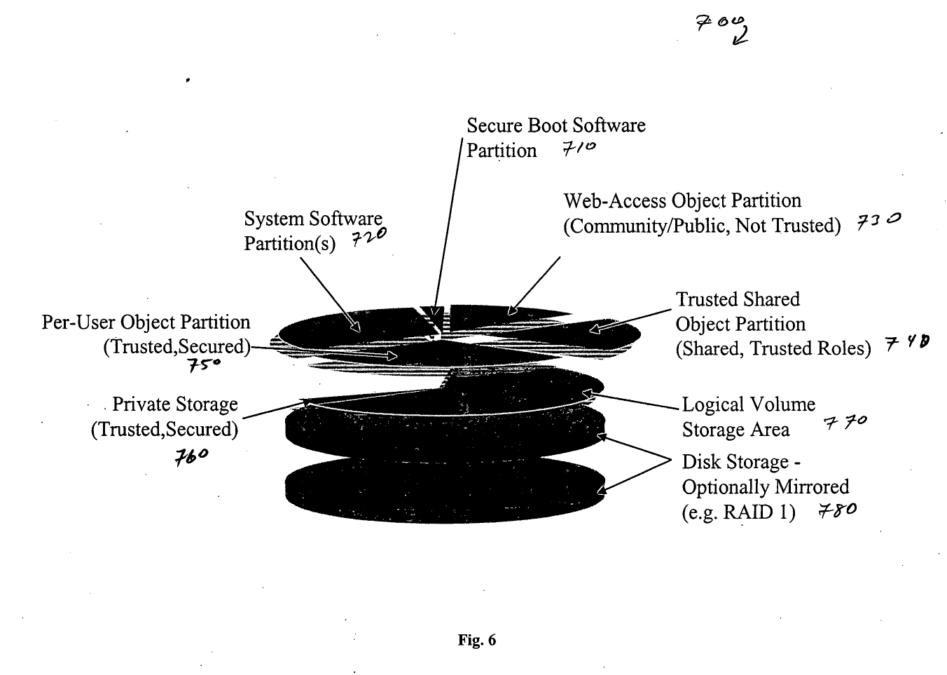

Further embodiments and features are described and illustrated in FIGS. 6, 7 and 8. FIG. 6 is an illustration of the volume partitioning and layout for secure storage areas on a DLS server appliance disk system in an embodiment. System 700 includes software, logical storage and physical storage levels. Boot partition 710 is a startup software sector/section. System partition embodies operating system software and related support software. Web-access partition 730 provides a scratch or storage space for data downloaded from the internet, for example. Shared-object partition 740 provides a trusted storage space for shared objects which come from verified sources or are otherwise trusted (e.g. due to third-party certification). Per-User Object Partition 750 provides a (essentially) private storage space for each user account. Private storage partition 760 provides actual private storage for long-term data for users. Logical volume storage area 770 provides a system addressable logical volume for storage of data. Disk storage 780 provides physical storage of data which maps to logical storage 770, and may be mirrored (such as through various RAID architectures, for example).

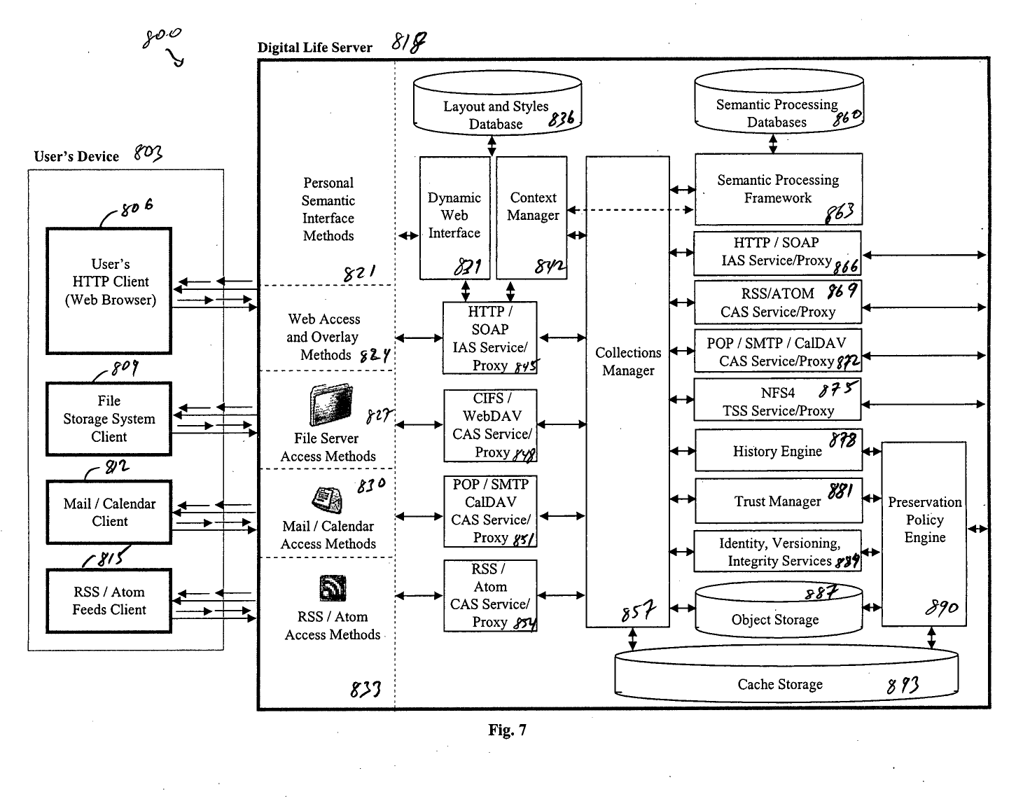

FIG. 7 is a diagram illustrating DLS subsystem relationships involved in configuration of the DLS server appliance in an embodiment. System 800 includes a DLS 818 and a user device 803 which interact through a network. User device 803 includes an HTTP client 806, a file storage system client 809, a mail/calendar client 812 and a RSS/Atom feeds client 815.

DLS 818 includes personal semantic interface 821, web access and overlay interface 824, file server interface 827, mail/calendar interface 830 and RSS/Atom interface 833. User device 803 interacts with DLS 818 through user client 806 (interacting with interfaces 821 and 824), through file system 809 (interacting with interface 827), through mail/calendar client 812 (interacting with interface 830) and through RSS/Atom feeds client 815 (interacting through interface 833).

Collections manager 857 interacts with context manager 842, HTTP/SOAP/IAS service proxy 845, CIFS/WebDAV/CAS service proxy 848, POP/SMTP proxy 851 and with RSS/Atom proxy 854. Web interface 839, HTTP/SOAP proxy 845, CIFS/WebDAV proxy 848, POP/SMTP proxy 851 and with RSS/Atom proxy 854 also interact with the interfaces (821, 824, 827, 830 and 833) and thus with user device 803. Collections manager 857 also interacts with HTTP/SOAP proxy 866, RSS/Atom proxy 869, POP/SMTP proxy 872 and NFS/TSS proxy 875 to interact with the internet, for example. Moreover, collections manager 857 interacts with history engine 878, trust manager 881, identity, versioning and integrity services 884 and object storage 887 to interact with a preservation policy engine 890. Preservation policy engine 890 interacts with an outside data source (e.g. the internet). Furthermore, engine 890 and collections manager 857 both interact with local cache storage 893. Collections manager 857 also interacts with semantic processing framework 863 and thus with semantic processing databases 860. Also, web interface 839 may interact with layout and styles database 836.

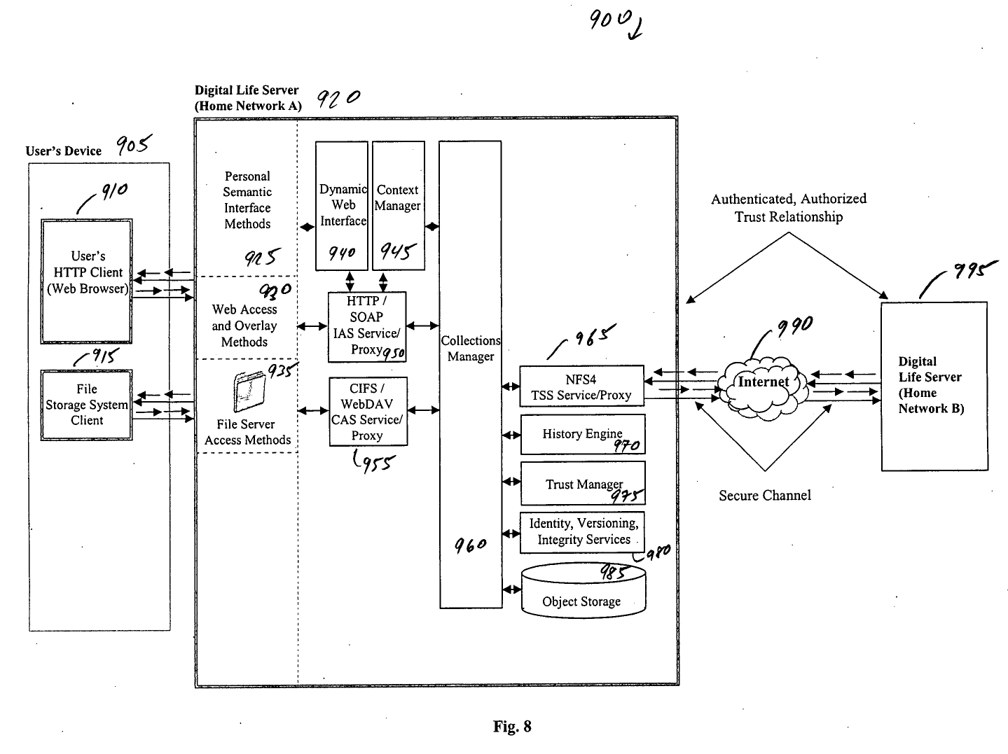

FIG. 8 is a diagram illustrating DLS subsystem relationships involved in configuration of the DLS server appliance in a trusted sharing services (TSS) embodiment between peer DLS systems. Trusted sharing services allow authorized DLS security principals to export access from one or more logical storage collections to a set of authorized security principals associated with a different DLS. System 900 includes DLS 920 within a home network, a user device 905 and another DLS 995 coupled through internet 990 to DLS 920. Thus, DLS 920 may provision authorization credentials with DLS 995 and vice versa, as well as exchange information.

DLS 920 includes personal semantic interface 925, web access and overlay interface 930 and file server interface 935. User device 905 interacts with DLS 920 through user client 910 (interacting with interfaces 925 and 930) for web access to data provided through the trusted sharing configuration, and through file system 915 (interacting with interface 935) for file-based access to data provided through the trusted sharing configuration. Collections manager 960 interacts with context manager 945 to configure applications and presentation attributes for web access to the trusted sharing data, and with HTTP/SOAP/IAS service proxy 950 and CIFS/WebDAV/CAS service proxy 955. Web interface 940 and HTTP/SOAP/IAS service proxy 950 provide the processing path for web-based data transfers, applications, and transactions, and the CIFS/WebDAV/CAS service proxy 955 provides access to file-based data through interaction with the interfaces (925, 930 and 935) and thus with user device 905. Collections manager 960 also interacts with NFS/TSS service/proxy 965 for access to data provided through the trusted sharing configuration between DLS 920 and DLS 995 or generally between two or more separate DLS instances. The NFS/TSS service/proxy interacts with internet 990 and similar peer services provided by DLS 995 for access to data provided through-the trusted sharing configuration. Moreover, collections manager 960 interacts with history engine 970 to resolve and/or update references to data involved in the trustred sharing configuration, trust manager 975 to retrieve and/or verify authorization credentials presented, identity, versioning and integrity services 980 and object storage 985 to access or store various data exchanged through the trusted sharing configuration.

This section provides an overview of each of the functional areas identified in the embodiment of FIG. 4. Subsequent sections of this specification provide detailed discussion of the subsystems illustrated in the embodiment of FIG. 5.

Operating System Runtime and Low-Level Storage Overview

Operating system runtime and low level storage provides functionality typical of most modern operating systems, including process scheduling, multi-threading, driver-based abstraction of hardware resources, uniform namespaces, discretionary access controls, and so on. The DLS architecture imposes additional functional requirements in some embodiments, as follows:
the operating system/runtime must support simultaneous execution of multiple separate instances of itself in order to provide an isolated virtual machine for each DLS security principal including individuals and role-based groups;
in addition to support for discretionary access controls (DAC), the operating system/runtime must support security labels and mandatory access enforcement (MAC) on process, memory, and storage resources within the DLS;
disk storage management functions provided by the operating system must be able to allocate and manage logically separate storage volumes for each DLS security principal from a reserved partition of the physical disk storage; and
logical storage volumes should be able to be mounted as distinct file systems, each with their own namespace root directory.

In addition to the above requirements, the DLS architecture, in some embodiments, specifies that the operating system and runtime be provided with a secure boot loader. The secure boot loader function must minimally ensure that: the code for the bootloader itself, and all subsequently loaded modules of the operating system and runtime up to the point that it has successfully completed loading can be verified 1) for integrity, and 2) for consistency with a specified configuration of the system.

The requirements of the DLS operating system runtime and low-level storage functional area in these embodiments can be satisfied with a variety of contemporary technologies, including for example recent versions of the Linux operating system such as SE Linux or user mode Linux (UML), kernel technologies such as the LVM3 storage management library, or TrustedBSD. Secure boot functionality may be provided by different combinations of firmware and hardware, and may be satisfied using technology specified by standards setting bodies such as the Trusted Computing Group (TCG). The secure boot requirement need not be included as an integral part of the DLS implementation if the DLS is realized as a virtualized server, or “soft appliance,” using hypervisor technology on a hardware and operating system host platform with equivalent functionality, or in other embodiments where it is not deemed necessary.

DLS requirements for strong isolation of processing and storage; secure boot authentication of the code included in the operating system and runtime; and labeled security with MAC enforcement, stem from the need to provide strong security for parties who rely on the DLS for long-term management of their data. Privacy sensitive functions performed by DLS such as creation and management of secret cryptographic keys used in identity and authorization routines, and symmetric keys used to the protect the individual's long term data, must have high-assurance guarantees against compromise. Similarly, DLS support for Trusted Sharing Services requires that exposure of any shared data objects be strictly isolated to the authorized storage areas and authorized security principals.

Object Storage Subsystem Overview

The object storage subsystem, as shown in the embodiment of FIG. 4, provides functionality central to operation of the DLS using services provided by the operating system runtime and low level storage. Primary functions provided by the object storage subsystem include:
provision of object-based storage management for Collections Objects, Data Storage Objects (DSOs), and DSO Datastreams either using an underlying disk file system or embedded in a virtual file system layer such as the Linux Filesystems in Userspace (FUSE) technology;
support for data integrity validation on all storage objects and transactions on them;
support of optional automatic versioning of all data storage objects;
support for enforcement of mandatory security labels on data objects or ranges of objects;
creation and management of indices on data objects to facilitate efficient history navigation;
creation and management of indices required for efficient tracking of preservation data sets (epochs);
abstraction of object data structures through exported programming interfaces (APIs); and
implementation of storage object consistency and recovery routines and garbage collection of stale or orphaned objects.

Functional APIs exported by the object storage subsystem are used by the preservation subsystem, history subsystem, and trust management subsystem.

Trust Management Subsystem Overview

Referring to FIG. 4 and FIG. 5, some embodiments of the trust management subsystem includes two major components: the trust manager, and private storage manager. Collectively, these embodiments of the trust management subsystem provide functionality including:
implementation, configuration, and management of all supported cryptographic routines used by DLS subsystems;
key generation and management;
identity certificate generation, signing, and verification;
authorization credential generation, signing, and verification;
reduction and evaluation of authorization credential chains;
support for credential caching in order to optimize performance of reduction and evaluation routines;
management of private storage for keys and cryptographic secrets; and
support for key management routines, including key wrapping/blinding functions in support of preservation operations.

The trust manager effectively encapsulates implementation of all cryptographic processing, and centralizes all certificate and credential operations in such embodiments. The benefits of this approach are several-fold:
sensitive trust proof and verifier functions are isolated from the rest of the system in one implementation so that the associated logic can be validated and more effectively maintained over time;
other DLS subsystems can effectively treat credentials as opaque objects, thus allowing updates to supported credentials with additional attributes or value types if required, and introduction of new credential types for purposes such as improved privacy characteristics without disturbing the rest of the system; and
configuration and protection of cryptographic algorithms and policies is centralized, and again, can be maintained more effectively in the presence of changes including introduction of additional algorithms, or deprecation and retirement of weak algorithms in the future.

As illustrated in FIG. 5, private storage manager routines for allocation and protection of physical storage and hardware support are effectively encapsulated by the trust manager.

Identity and Security Subsystem

Referring again to FIG. 4, some embodiments of the identity and security subsystem utilize services of the trust management subsystem, and support functionality including:
management of per-account data and identity attributes for each DLS security principal;
encapsulation of identity attribute data types and the ability to update or add new datatypes as required over time in support of DLS Interoperability Services;
encapsulation of identity attribute values and the ability for the individual to set policy options explicitly allowing or denying reuse of attribute values for different services and operations;
management of foreign system account data required for proxy access by the DLS on behalf of the security principal when accessing remote mail or other systems as configured by the them; and
management of system security policies, for example in support of associating authorization rules with role-based security principals for functions such as Trusted Sharing Services.

As illustrated in more detail in FIG. 5, some embodiments of the identity and security subsystem include an LDAP directory service. The LDAP directory provides a robust and flexible means for the DLS system to manage account information for individuals and role-based security principals. This functionality additionally supports management of canonical security policies and association of those policies with appropriate security principals. Finally, information for foreign system accounts required for DLS proxy operations on behalf of each individual security principal is managed by the identity and security subsystems using the LDAP directory, thus providing a secure and centralized means for managing this data. APIs exported by the identity and security subsystems functional area are used by the interoperability services and proxies framework; the collections subsystems, and preservation subsystems; and are available through exported APIs to the web applications framework.

Preservation Subsystem Overview

The preservation subsystem is illustrated in the embodiment of FIG. 4 and described in considerable detail in later sections of this specification. In brief summary, the preservation subsystem is a central component of the DLS, and provides:
policy-based secure archive functions for DLS data objects organized in time ranges, or epochs, for each unique security principal and all of their data;
policy-based secure archive functions for DLS system data organized in epochs;
secure online storage of epoch archive data in conjunction with an associated Online Preservation Service (OPS); and
support for managing DLS disk storage effectively as an “object cache” with the ability to off-load/restore epoch data on demand from the associated OPS.

The preservation subsystem utilizes services provided by the history subsystem to manage the archive status of all data storage objects in the DLS, and to periodically update the remote archives for each security principal's account on the designated OPS. The preservation and history subsystems in combination allow the DLS to be treated effectively as a large virtual object cache—thus allowing users of the DLS to effectively treat it as a network attached storage disk of unlimited capacity. The preservation subsystem further ensures that all volatile per-security principal data and account state is preserved along with data storage objects and content, in order to minimize data loss in the event of a catastrophic failure of the DLS.

Collections Subsystem Overview

The collections subsystem is central to the embodiments of the DLS architecture of FIGS. 4 and 5 and described in considerable detail later in this specification. As a brief summary, the collections subsystem:
supports management of all data created, stored, or referenced by services or applications in the DLS according to a uniform object model in conjunction with services provided by the Object Storage Subsystems;
supports comprehensive metadata and mapping abstractions allowing foreign interoperability services to interact with data on the DLS according to their native semantics;
supports the ability to maintain rich histories including multiple versions and representations of any datastream; and
supports DLS semantic processing applications with the ability to associate terms and predicate tagging with Collections Objects, and the ability to reuse data from web or local data sources in constructing rich personal applications,

The collections subsystem effectively integrates all functions for creation, annotation, references and referential integrity, manipulation, and management of all data storage objects in the DLS system. The collections object exports APIs for use by the interoperability services and proxies framework; the history subsystem; the preservation subsystem; the semantic processing framework; and through its API, can be invoked through the web applications framework.

FIG. 9 is a schematic diagram illustrating the data structure fields and layout of a collections object in an embodiment. Collections object 1000 may embody or store data related to any number of different types of events, documents, or other forms of data. Thus, a flexible and expansive data structure 1000 is provided—although other data structures may be suitable in various embodiments.

PSID 1002 is a persistent system identifier—such as a key for a data entry. Descriptive label 1004 provides a label, and may include a label substructure 1032 with a human readable name 1034 and a description 1036, for example. Owner 1006 provides an indication of a user associated with the data structure 1000, and may include a credential 1038 (e.g. a digital certificate, for example). Authorizations list 1008 provides an indication of what users have various access levels for structure 1000 and may include a list of credentials 1040, for example.

Creation timestamp 1010 provides a creation record of time and date, while modified timestamp 1012 provides a time and date of last modification. Access field 1014 provides an indication of when the structure 1000 was last accessed, and may include access record(s) 1042 for further information about a last access or chain of accesses. Privacy label 1016 provides a privacy substructure 1064, including a privacy classification 1066 and declassification policy 1068, for example. Version field 1018 provides revision status data for structure 1000 and may include change records 1044 for audit purposes, for example. Preservation label 1020 indicates how the data of structure 1000 should be maintained and may include retention policy 1046.

Context metadata 1022 provides context attributes 1048 as needed. Services index 1024 provides file systems data 1050, which may include substructure 1070, with a file system data entry 1072 and a file system index entry 1074. Services index 1024 may also provide mail folder 1052, calendar folder 1054 and feeds folder 1056. Mail folder 1052 may provide mail substructure 1076 which may include mail folder type data 1078 and mail folder index 1080. Similarly, calendar folder 1054 may include calendar structure 1082 which may further include calendar folder data type 1084 and calendar folder index 1086. Likewise, feeds folder 1056 may include feeds data structure 1088, which may include feeds folder type data 1090 and feeds folder index 1092.

MetaQuery index 1026 provides access to metaquery object 1058. Categories index 1028 may provide access to category object 1060. Similarly, data object index 1030 may provide access to zero or more DLS Data Storage Objects (DSO), for example. Object 1062 may incorporate by reference or by value data from file system structure 1070, mail folder structure 1076, calendar structure 1082, feeds structure 1088, metaquery object 1058, and category object 1060.

Interoperability Services and Proxies Framework Overview

The interoperability services and proxies framework provides essential services for all network communications between the DLS and external systems in the embodiment of FIG. 5. As illustrated in FIG. 5, this framework includes three categories of service agent components, providing:
interoperability with local network file system and application protocols—referred to as the common application service agents (CAS);
interoperability with standard web-based services and protocol formats—referred to as the internet application service agents (IAS); and
service protocols for trusted sharing between authorized DLS systems—referred to as the trusted sharing service agents (TSS).

A detailed description of policies and services provided by the interoperability services and proxies framework is provided in a subsequent section of this specification.

Referring again to FIG. 4, the history subsystem maintains indices over all collections and data storage objects in the DLS system, including both current and historical data. The history subsystem maintains these indices using the master index database which it logically encapsulates. Updates to the master index are maintained by the history subsystem through API calls and event notifications from the object storage subsystem, the preservation subsystem, and the collections subsystem. Updates provide the history manager with data required to maintain currency of the master index. The history manager exports an API which is used by the preservation subsystem, the semantic processing framework, and which is available to the web applications framework for navigating and retrieving references to data objects using temporal data and queries.

Web Applications Framework

The web applications framework, as illustrated in the embodiment of FIG. 4, supports development and deployment of native and third-party applications on the DLS. Examples of native DLS web applications include the personal semantic workspace and the semantic history navigator. In an embodiment, the selected framework implements support for Java language development using Java servlet programming based on Java Community Process JSR 154 (Servlet 2.4) and JSR 53 (Servlet 2.3) specifications. Additional programming languages and libraries may be supported.

Format Conversion Framework

The format conversion framework, as illustrated in the embodiment of FIG. 4, provides a uniform API for requesting conversions from a supported source content data format to a target content format. Conversions provided by the framework take a DLS data storage object (DSO), an identified datastream associated with the DSO, and the target MIME type for the conversion as input, and produce the output of the conversion as a new datastream without modification to the input source. The output datastream is associated with the original input DSO, thus allowing the DSO to consistently reference both the original and the converted datastreams.

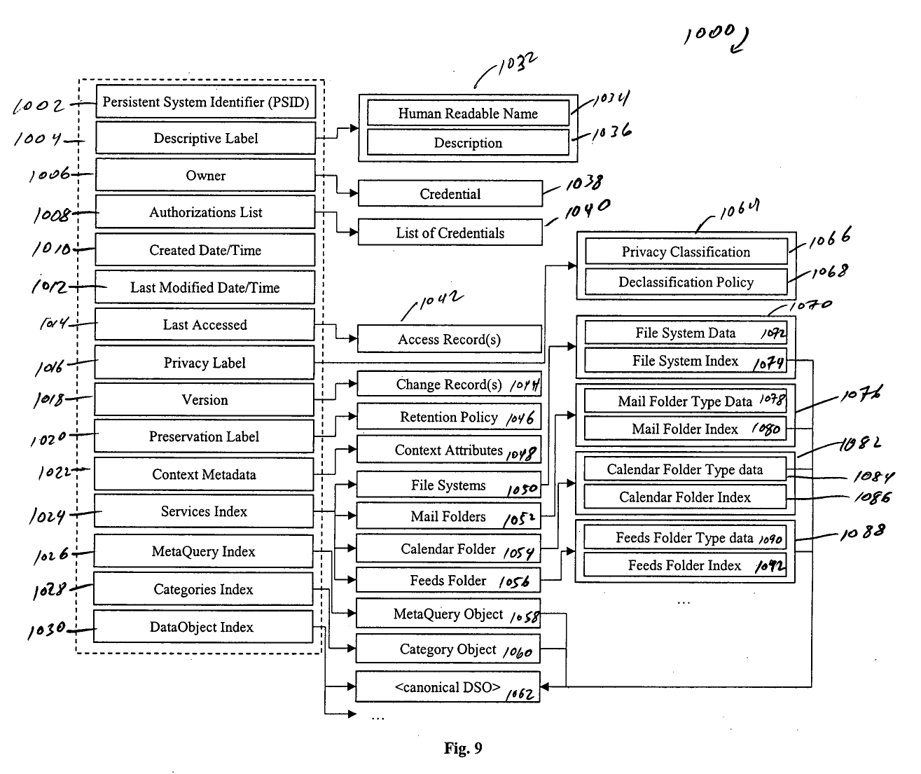

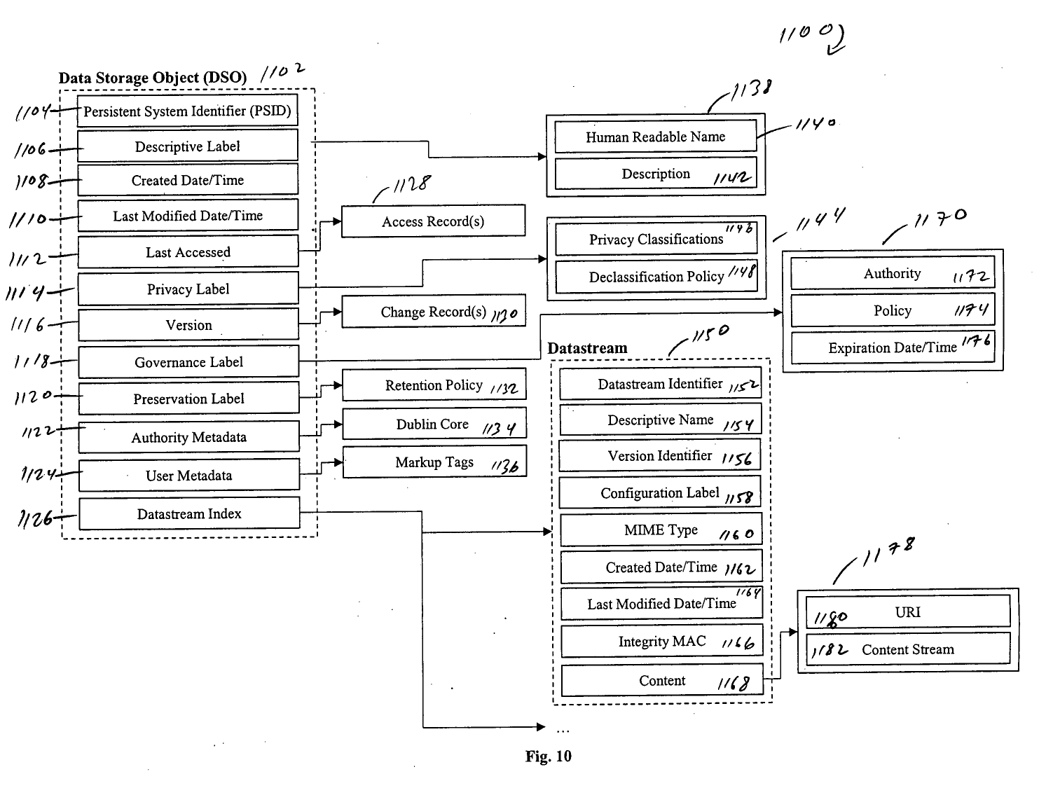

As illustrated in FIG. 10, the DSO object structure supports multiple datastreams, each with their own unique identifier and metadata. In more detail, the format conversion API consists of an upper API that is exported to callers of the framework, and a lower API, that is used by components, or “plug-ins,” that are registered with the framework for a particular set of conversions. The set of source/target conversions registered with the framework can be enumerated through the upper API.

Additionally, policies can be registered with the framework similar to conversion “plug-ins.” Policies are used by the framework to control availability of certain conversion options and/or to provide convenient aliases for certain preferred conversion settings. For example, a policy could be registered to alias a certain conversion target datatype as “default,” or “preferred” as way of directing calling applications to select a certain format from among possibly many options. As in the case of most DLS features and policies, the operational support services (OSS) provides the policies and conversion plug-ins to the format conversion framework as part of its update and maintenance services, thus assuring that the conversions are validated and known to be trusted for correct behavior. The format conversion framework is used by the collections manager, the semantic processing framework, and is available to the web applications framework.

Reference specifically to FIG. 10 may provide further understanding of this topic. FIG. 10 is a schematic diagram illustrating the data structure fields and layout of a canonical DLS storage object (DSO) in an embodiment. DSO 1100 includes top-level DSO fields 1102 and various sub-fields and structures. Persistent system ID 1104 may provide a key for the data structure 1100.

Descriptive label 1106 provides a label, and may include a label substructure 1138 with a human readable name 1140 and a description 1142, for example. Creation timestamp 1108 provides a creation record of time and date, while modified timestamp 1110 provides a time and date of last modification. Access field 1112 provides an indication of when the structure 1100 was last accessed, and may include access record(s) 1130 for further information about a last access or chain of accesses. Privacy label 1114 provides a privacy substructure 1144, including a privacy classification 1146 and declassification policy 1148, for example. Version field 1116 provides revision status data for structure 1100 and may include change records 1130 for audit purposes, for example. Governance label 1118 may be included, and may also include governance substructure 1170, including authority 1172, policy 1174 and expiration timestamp 1176. Preservation label 1120 indicates how the data of structure 1000 should be maintained and may include retention policy 1132.

Also included may be authority metadata 1122 which may include Dublin Core 1134 (for example). Additionally, user metadata 1124 may be included and may include markup tags 1136. Datastream index 1126 may point to datastream 1150 (and additional datastreams). Datastream 1150 may include an identifier 1152, name 1154, version 1156, configuration label 1158, MIME type 1160, creation timestamp 1162, modification timestamp 1164, integrity MAC 166 and content 1168. Content 1168 may include URI 1180 and content stream 1182, for example, as part of a content substructure 1178.

Semantic Processing Framework Overview

In some embodiments, the semantic processing framework of the embodiments of FIGS. 4 and 5 provides technologies for both user-directed and automated content analysis, facts and concepts extraction, classification, annotation, and reasoning on DLS data objects and/or web data flows. The framework technologies support creation of DLS applications that are able to operate both on data, as well as on explicit and inferred relationships across that data based on temporal, topical, task-based, or other predicate relationships. The functional area is identified in FIG. 4, and its subsystems are elaborated in FIG. 5; a detailed description is provided in a subsequent section of this specification. In brief summary, functionality provided by the semantic processing framework includes:
support for analyzing web and DLS data object structure information;
extensible filtering and content extraction routines for support of both user-directed and automated collection of facts, concepts, and relationships from both web and DLS data objects;
support for inspection and reasoning operations using user-populated and formally-provided semantic databases (taxonomy data, ontologies, and the individual's or small group's RDF Fact Store) in conjunction with DLS collections and data objects;
support for contextual search, or “recall,” using semantic databases in conjunction with DLS collections; and
support for contextual visualization of semantic data sets.

The semantic processing framework utilizes the W3C suite of RDF standards for representation and processing of semantic metadata; ontology data utilizes the W3C suite of OWL standards. Databases supporting RDF, OWL ontology data, and taxonomy data are logically encapsulated by the semantic processing framework

Context Manager

Referring to FIG. 4, an embodiment of the context manager is responsible for creating and managing named sets of attributes consisting of RDF statements and resources, and/or URI references to XML-structured settings for configuring DLS system-wide behaviors. Each set of attributes is referred to as a context, and each context has a name. The attribute data associated with each context is managed by the context manager using database functionality provided by the semantic processing framework. Functionality provided by the context manager:
allows loosely-coupled DLS subsystems such as Collections and the Semantic Processing Framework to effect consistent attribute settings and produce coordinated, predictable default behaviors;
provides a programming interface (API) for DLS subsystems and applications to select, create, enumerate, modify, and “forget” Context data;
allows DLS subsystems and applications to register for event-driven notification of changes to Context attributes and the currently selected Context; and
allows different subsystems to develop in a loosely-coupled fashion by coordinating their configuration settings to published versions of standard attributes and configuration specifications.

In more detail, the context manager API provides functions for creating and manipulating context attributes, and for creating named contexts including a selected set of attributes. The resulting contexts can then be enumerated, or selected and set using the API. Context attributes allow the web application framework components that dynamically create the views in each pane to select the matching collections and data storage objects, set application default parameters, and configure presentation characteristics such as graphical representations, selective presentation of certain data fields, fonts, and/or color settings using CSS templates identified by the context attributes.

The set of contexts supported by the DLS is configurable through an administrative interface. In an embodiment, the DLS includes five pre-defined context “classes,” provided as defaults for individual's to create and organize DLS collections and data, facts, and history related activities and interests, The pre-configured contexts are named:
Work,
Personal,
Family,
Friends, and
Public.

The names of the default contexts are designed to elicit an intuitive response from the individual when they first encounter the system. More technically, the pre-configured contexts also incorporate default attribute and configuration settings. The individual is able to reconfigure the names or default settings for any of the pre-defined contexts, and can create additional contexts.

Unlike common techniques such as application-specific configuration files or name/value pair attribute database registries, context attributes are modeled as named W3C RDF statements and resources. RDF statements are based on a subject, predicate, and object triple structure defined by the RDF standard. Modeling context attributes as RDF statements allows contexts to express directed graph relationships based on the predicates specified in the attributes, or nodes.

Context attributes are able to model concepts, such as application semantics involving dynamic behaviors based on changing time or role-based relationships. This potentially has particular importance in the DLS since time-based and role-based relationships may play a critical role in so many aspects of subsystem and related presentation behaviors in the DLS. Context attributes can be used to model concepts, such as relationships based on time, thereby supporting adaptive presentation of the underlying data types when their temporal relationships change using time-based navigation controls in this application. Presentation behaviors based on changes to conceptual relationships can also affect presentation settings across multiple components simultaneously, as for example in the case of the personal semantic workspace, thus again illustrating the system-wide benefits of the context manager in configuring and coordinating behaviors throughout the DLS system.

The context manager API additionally provides a function to “forget” a named context. The “forget” function does not immediately delete the context and its attributes, but instead marks them as available for possible deletion at a future point in time. This is important, since attributes may be reused in multiple contexts, and as along as they are referenced by any context they cannot be deleted. The context manager implements a mix of reference counting and a periodic sweep of the attributes to identify unreferenced attributes that can be garbage collected.

Web Interaction Framework

The web interaction framework, as illustrated in the embodiment of FIG. 4, supports dynamic construction and adaptation of web application interfaces for clients of the DLS. Web interaction framework functionality includes:
logic for detection of different browser and client characteristics;
script logic for incorporation in DLS-generated web applications, and associated DLS server-side processing, for retrieving and setting user-selected styles affecting layout, fonts, and colors on the browser client;
logic for selecting and configuring templates based on W3C standards such as CSS for adapting presentation and layout of different DLS-generated web applications to the detected characteristics of the client browser;
logic for selecting between different Javascript libraries and/or active content implementations for delivery to the different types and versions of the detected client browser; and
logic for handling localization and internationalization settings based on user preferences and characteristics of the client browser.

The web interaction framework APIs allow callers, such as web application framework programs, to set and configure different presentation styles and features, and to specify delivery of certain browser logic such as embedded script code (e.g. Javascript) or active content (e.g. Java applets, or Microsoft ActiveX™ controls) depending on the characteristics of the browser. By separating the specification of the script code or active content logic required by the DLS application or subsystem from the decision about which implementation to inject in the web page stream for the particular client browser, the web interaction framework allows the DLS to evolve support for a wider variety of different client browsers without having to couple the update and maintenance cycle to parts of the application that are unaffected by presentation.

Similar to techniques used in the context manager, the web interaction framework uses RDF and RDFS to model its configuration data, thus allowing specification of semantic relationships between parts of the configuration. This for example allows configurations to express relationships affecting selection of certain script code libraries by the web interaction framework based on relationships such as whether a certain script library should be included based on requirements of another library or the characteristics of the client browser. This functionality allows the web interaction framework to provide late-binding and adaptive results which are not as easily achieved using conventional techniques based on configuration files, name/value attribute registries, or programming language-specific techniques that merge application and presentation logic in a single structure, such as Java Server Pages. These benefits are particularly important to design of the DLS in support of enabling its operation with the broadest possible variety of current and future browsers and web-enabled devices, while minimizing effects of this support to parts of the system uninvolved in interfacing directly with presentation and interaction concerns arising from those various devices and their capabilities.

Digital Life Server (DLS) Appliance Runtime and Security Architecture

The DLS isolates the collective set of data associated with each individual's or small group's account in its own separate logical volume, and executes all account-specific processing in its own separate virtual machine instance in some embodiments. The logical volume structure establishes the root of the file system and the associated namespace uniquely with the account. Security policies enforced by the base runtime system ensure that users cannot navigate or manipulate the disk file system or structures outside of their volume namespace unless they can present the required cryptographic authorization credentials. The virtual machine architecture effectively ensures that all process execution on behalf each account occurs in an isolated process space within the DLS appliance.

Identity certificates for each account/virtual machine instance provide the basis for authenticating it as a unique security principal, including the base runtime instance of the DLS itself. Authorization credentials created for each security principal function effectively as capabilities, and are used to grant/obtain access to various processing and resources throughout the system. Each principal may have potentially many authorization credentials depending on the access they require to various services and resources.

Both hierarchical and web-of-trust (non-hierarchically rooted) trust chains can be constructed using the certificates and credentials mechanism; hierarchical trust chains are a trust chain with a single root. In an embodiment, identity certificates and authorization credentials are constructed and processed according IETF RFC2693, the Simple Public Key Infrastructure (SPKI). Alternative approaches are possible and likely, particularly on certain interoperability boundaries of the system where, for example, it may be necessary to also support X509v3 certificates as required by existing or legacy third-party services. In the interest of increased protection from traceability and inadvertent exposure private data, the DLS also supports secret key certificates on system boundaries where interoperation with other supporting services can be arranged. Due to the possible and likely need to support multiple representations, each set of trust chains is managed as a separate class of trust domain.

In addition to accounts for each individual, the system may be configured to support role-based accounts in support of shared access to certain authorized resources within a single DLS, or between multiple distributed DLS systems using Trusted Sharing Sevices. For example, different groups each with their own DLS instance may desire to establish shared access to photos and video content, academic materials, diaries and/or blogs, and so on. In such cases, a role-based account created or assigned as part of the basic DLS system for the purposes of sharing group-authorized resources executes and is responsible for managing the associated resources. Role-based accounts effectively function like per-individual accounts and are primarily distinguished by their associated certificates and authorization credentials.

In an embodiment, role-based accounts are configured with contexts to facilitate logical mappings between authorizations and information organized within a given context by the individual. The effect of this configuration technique provides a direct means for the individual to comprehend how associating a given collection with a given context may affect access to information in the collection. Continuing with the previous example of group-authorized sharing using role-based authorization, an embodiment provides five pre-configured default contexts in conjunction with the context manager, one of which is the public context. The public-authorized sharing role is configured as a public authorization on the public context. Consequently, when the individual creates a collection in the public context, the collection is automatically configured with the authorizations required for parties in the public-authorized sharing role.

Processing within each per-individual account virtual machine instance utilizes a mix of discretionary access controls (DAC), and mandatory access control (MAC) policies for process-local operations. MAC policies in the virtual machine are configured as part of the distributed DLS policy provided by the OSS platform configuration policy service and are primarily used to enforce principle of least privilege security for loadable third-party modules such as content filters, format converters, and other loadable framework modules. The base runtime system spawns the per-account virtual machine instances and provides shared services such as access to storage resources, shared cryptographic routines or hardware, and user authentication to the DLS system itself.

The base runtime primarily relies on MAC policies and enforcement. Security labels maintained on resources in the base runtime system in conjunction with MAC enforcement help to isolate sensitive administrative applications and services in the base runtime from manipulation that could subvert correct operation of the DLS appliance either inadvertently or through malicious intent. Authorizations required for normal operation of the virtual machine instances and their access to storage, authentication, and communication services in the base runtime are configured as part of the standard policies in an embodiment. Per-account virtual machines are spawned upon successful authentication by the base runtime of an individual for whom an account exists on the system. Communication between the base runtime and spawned virtual machine typically utilize inter-process communication techniques (e.g. native RPC, RMI, CORBA, or SOAP) thereafter until the virtual machine is terminated.

Trust management services typically run as a separate process in each distinct account process space, including the base runtime and each per-account virtual machine for account-specific key generation, key management, signing, certificate management, credential generation, and associated prover/verifier functions. Trust management services additionally implement and enforce equivalence class mappings between trust domains, if such mappings are required for cross-domain authorization, as might occur when combined access is required to services that rely on different identity certificate representations and trust roots. Execution of trust management services as a separate local process in each virtual machine instance and in the base runtime, as opposed to a system-wide shared process, helps to enforce strong isolation between different accounts and their respective privacy requirements. This is particularly important for ensuring protection of cryptographic materials used in both public key and secret key certificates, and zero-knowledge cryptographic proofs.

Keys are generated and managed by an instance of the trust manager running in each account, and manipulated strictly in that particular account's process address space and associated Private Storage area, thus significantly reducing the potential for inadvertent exposure of secret keys and improving the basis for utilizing strong key separation for different tasks. Credentials are generated and processed by the Trust Management services in each part of the system (account virtual machines or the base runtime) in conjunction with requests for service or access to resources owned by those respective parts of the system. The resulting functionality ensures that processing within an instance of the DLS occurs with the same principled privacy and isolation as if each individual's account was executing on its own dedicated, secure processor.

DLS Device Initialization and Trust Establishment

In many embodiments, certificates for each DLS account/virtual machine instance provide the basis for authenticating the account as a legitimate security principal, including the base runtime instance of the DLS itself. The ability for these security principals to mutually prove and verify trust in each other utilizes a bi-directional set of trust chains that effectively allow the base runtime instance to verify its trust in the account/virtual machine instances for which it generates certificates, and conversely, for the account/virtual machine instances to verify their trust in the base runtime instance, each using their separate and respective instances of the trust manager as previously described. This functionality is potentially of particular importance in support of the ability to move or regenerate DLS account/virtual machine instances on a different DLS, such as when a device needs to be replaced, or if the account virtual machine is moved to or from a virtualized server, or “soft appliance” implementation as previously described.

The runtime system must additionally be able to prove its trust in the DLS device itself. An important consideration in establishing this relationship is that it must be robust in the event of DLS device replacement scenarios. For example, using services of the preservation engine as subsequently described in this specification, it should be possible to retire the original DLS device where a set of accounts were established, install a new DLS device, and restore all of the data from the individual's or small group's OPS without a requirement for participation by a third party, and without any potential for key or identity compromise due to key escrow exposure.

In an embodiment, the DLS device identity is provided by use of a removable secure chip card consistent in design and functionality with the standard SIM Card commonly used in GSM and 3GPP mobile applications. The DLS device provides support for two cards for purposes of redundancy, which are configured effectively as duplicates and integrated using standard connectors on the device main circuit board.

Initialization of the original DLS device and the base runtime utilizes the certificates and identifiers provided in the SIM Card to create the trust relationship between the device and the base runtime. No data is written to the SIM Card, as its purpose is solely for verification of the trust relationship between the running DLS software and the device in which it is installed. Thereafter, all other trust relationships between the base runtime and subsequent creation of security principals occur as described in the previous paragraphs. Once the initialization is complete, the owner should remove one of the SIM Cards and retain it in a physically secure manner. Completely removing both SIM Cards renders the device effectively unusable.

Future replacement of the DLS device hardware simply requires installation of at least one of the original SIM Cards in the new device, after which recovery utilities can be used to connect to the owner's selected OPS for restoration of their DLS account data using functionality of the preservation engine as described later in this specification.

Advanced Trust and Account Management Semantics

Secure operation of the DLS system in most embodiments is designed to ensure strong privacy for every individual and their interests, with the ability to encode sufficient policy representations for dealing with normal desires and events encountered over the course of a lifetime. Security thus must be able to cope with replication, delegation of authorizations, and separation of certain portions of data sets according to events such as when a person achieves legal adult status, an individual marries and joins or shares certain portions of their data set with their spouse, if the individual and their spouse divorce and some data assets need to be divided or replicated between them, when an individual joins or later separates from a group or business relationship, and disposition of the collected data assets when the individual dies.

Similarly, sharing of some portions of an individual's data set with their relationships, must also be accommodated with predictable and natural semantics corresponding to those relationships. The trust management credentials, object storage, virtual machine process isolation mechanisms, and Trusted Sharing Services of the DLS system are designed in their collective operation to provide technically-enforced distinctions for individuals and small groups between what they perceive and can trust as private, versus what is trusted and shared, versus the public internet. As such, semantics related to privacy and trust must be as close to intuitive as possible based on flexible technically-specified policies that reflect commonsense reasoning, accompanied by strong cryptographic protections and enforcement. As previously described, the DLS per-individual and role-based account mechanisms and trust management functions provide the basis for this functionality.

DLS Network Connection and Services Interfaces

In many embodiments, services provided by the DLS are deployed in the form of a server appliance for use in an IP protocol-based network. Since the IP protocol can be effectively deployed in a standard manner over a wide variety of underlying datalink and media access protocol disciplines, there is effectively no constraint on how the DLS is connected to the network, including various wired or wireless technologies such as the IEEE 802.11x protocol suite, ultra-wideband (UWB), and so on.

The DLS, in such embodiments, is configured as a set of proxies between traffic internal to the network and outbound network connections to the external internet, typically through an existing broadband router or gateway device. Basic proxy configuration of the DLS and the router/gateway utilizes techniques commonly understood by practitioners skilled in the art, and may include automated configuration using services defined by the UPnP™ protocol suite, and/or manual configuration using a web-based administrative interface. In the case of manual configuration, the default administrative interface is provided on a default IP address configured on the DLS for access from a locally-connected computer. Once connected to the network, the DLS utilizes DHCP services typically provided by the gateway to configure standard IP addresses and network services such as DNS, and is able to access other common IP services such as Dynamic DNS, NNTP time services, and so on.

Individuals interact with DLS-provided services through three classes of protocols interfaces:
the common application services (CAS) protocols class,
the trusted sharing services (TSS) protocols class, and
the internet application services (IAS) protocols class.
   Each of the protocols classes are implemented as one or more service agents within the DLS architecture. Service agents conform to a set of functional requirements within the DLS architecture, as follows:
when service agent code is executed by the base runtime or virtual machine operating system, the resulting process(es) run in the identity of the base runtime, and/or the per-account virtual machine in which they are invoked, thus ensuring isolation of sensitive state and resources; each DLS security principal effectively has their own copy of the service agent running on their behalf for the associated functionality,
service agents optionally implement both client and server, or producer and consumer interfaces for the associated protocol suite, thus allowing them to function in a proxy configuration and allowing the DLS appliance to resemble a variety of servers or clients depending on the set of configured agents,
service agents interface to DLS-provided proxy functions for required identity certificates and/or authorization credentials,
service agents interface to DLS-provided proxy functions for required caching services which are managed on their behalf according to policies specified by the service agent and/or protocol class and presented to the DLS proxy functions, and
service agents interface to DLS-provided Collection Manager functions for interfaces to the object storage and preservation services provided by the DLS.

Organization of service agents into protocol classes allows them to be managed both in terms of particular DLS security guidelines for a particular set of service agents, and for policy-based configuration management by the supporting Operational Support Services (OSS). The CAS, TSS, and IAS protocol classes logically organize sets of functionality that are integrated within the DLS architecture for distinct purposes, including:
interoperation with personal computer or device operating system services and native applications within the home network, and application-level proxy functions with distributed services over the open internet as supported by service agents in the CAS protocols class,
trusted shared storage between distributed DLS systems in the open internet as supported by service agents in the TSS protocol class, and
web applications and services interoperation from within the home network or over the open internet, and proxy caching services, as supported by service agents in the IAS protocols class.

Protocol class policies are defined and distributed by the OSS and may be periodically configured and updated through interaction with the DLS' associated OSS provider. Service agents present their associated protocol class policies, and possibly additional service agent-specific policies to the proxy framework.

The common application services protocols class, or CAS, supports DLS access from applications on personal computers or devices primarily from within the home network. Functionality supported by these protocols enable access to DLS services typically in a client-server mode using widely deployed standard application protocols. DLS services supported by the CAS class of protocol service agents include:
file services, including protocols such as Microsoft CIFS™, Microsoft SMB™, the IETF WebDAV protocol suite, the IETF FTP protocol suite, and Apple AppleTalk File Services™,
electronic mail and messaging services, including IETF standard protocol suites supporting POP, SMTP, and IMAP,
calendar services, including IETF standard protocol suites supporting CalDAV, and
naming, service discovery, and directory services, including the IETF standard protocol suite for LDAP, Apple Rendezvous™, and UPnP™ SSDP discovery services.

The purpose of the CAS protocols class is to assemble the required set of application interoperability interfaces required for connection and data transfer with the DLS. The set of supported CAS protocols is exemplary and non-limiting with respect to the possible supported interoperability protocol suites, since selection is matter of commercial relevance and may be adapted over time according to market conditions. In particular, additional protocol service agents required for interoperation with DLS-provided file services; electronic mail and messaging services; calendar services; and/or naming, discovery, and directory services can be defined and implemented consistent with the service agent architecture, and managed using protocol class policies. Protocol class policies are used to define configuration settings and restrictions such as authorizations for administrative configuration and access, protocol-specific parameter settings, parameters for secure channel configuration, and so on.

The trusted sharing services protocols class, or TSS, supports inter-DLS data object sharing between authorized security principals. Trusted sharing services allow authorized DLS security principals to export access from one or more logical storage collections to a set of authorized security principals associated with a different DLS. As an example, a group may choose to publish a collection of digital photos and notes from a trip or event to other related groups who also have DLS systems. The TSS service agent(s) in each of the DLS systems implement the protocol operations required for authenticating and connecting the authorized set of storage collections, and also manage any associated protocol-specific state associated with the resulting communication session(s). TSS service agents allow each of the shared storage collections to appear effectively local on the distributed set of connected and authorized DLS systems.

Services provided by the DLS proxy framework are used the TSS service agent to request caching services according to the TSS agent's protocol class policy, thus allowing the agent to adjust quality of service for improved liveness and response for access to the exported collection storage and data objects. Security authorizations on the collections and their data objects are interpreted and enforced by other DLS subsystems such as the trust manager. More specifically, the TSS service agent is responsible for protocol security associated with authenticating, connecting, and maintaining the communications session(s) between the authorized DLS systems—all other authorization and access decisions on the shared collection storage and data objects are enforced in a completely uniform and consistent manner according the responsible DLS trust and security subsystems.

The internet application services protocol class, or IAS, supports web-based service access with the DLS. Protocols supported by IAS service agents are utilized by the DLS for a variety of functions, including:
common web browsing and syndicated feeds access using client browser applications from within the home network in the manner of a typical HTTP proxy/cache accelerator,
semantic browsing services for open web content and local collections both from within the home network, or over a secure remote connection to the DLS from outside the home network,
interaction with DLS semantic processing applications both from within the home network, or over a secure remote connection to the DLS from outside the home network,
access to DLS administrative functions including per-account configuration and preferences, and
access to low level administrative applications provided by the base runtime operating system.

IAS service agents are fully consistent with the DLS service agent architecture and protocol class policy mechanisms. Protocols supported by IAS service agents include:
the HTTP protocol suite as standardized by relevant IETF and W3C standards,
the SSL and TLS protocol suites as standardized by IETF,
RSS, ATOM, and related protocol suites as standardized by their respective authorities including IETF, and
web services protocol suites including the W3C SOAP and W3C WSDL specifications.

The purpose of the IAS protocols class is to assemble the required set of interfaces required for web-based interaction with the DLS. In particular, the set of supported IAS protocols for Web Services interoperation based on W3C SOAP and WSDL is exemplary and non-limiting with respect to the possible supported Web Services application protocol suites, since selection is matter of commercial relevance and may be adapted according to market conditions. Services provided by the DLS proxy framework are used the IAS service agent(s) to request caching services according to the IAS agent's protocol class policy, thus allowing the agent to adjust quality of service for improved liveness and response for access to various data objects.

DLS Collections

The DLS, in some embodiments, enables users to create, store, and organize information from their existing personal computers, devices, and familiar productivity and multimedia applications using the common application services (CAS) service agents. The DLS additionally operates as a transparent network proxy using the internet application service (IAS) protocol agents. IAS protocols and proxy functions allow the DLS' services to be invoked as part of the normal web browsing experience through any modern browser, inline with any web page, without additional software. Services invoked as part of the browsing experience make it possible for users to reference, save, annotate, link, and aggregate information encountered as part of their browsing experience according to their own self-defined organization. Regardless of whether the resulting organization is created through the CAS or IAS service agents, the DLS internally organizes and stores the resulting data as objects and references in organizations called collections objects.

Collections can be navigated topically or historically, expanded or annotated with additional information from potentially multiple applications, and selectively shared according to defined trust relationships with other DLS security principals (either individuals or role-based accounts, both within the same home network or in a different location).

Collections are created and managed by the DLS collections manager. Collections logically resemble the familiar concept of file system directories, but offer significant additional innovations beyond these previous structures, as follows:
1. the Collections Object data structure supports mappings from multiple different native service and application data objects into a uniform data model,
2. the Collections Object supports referential integrity for unique service views and semantics on the data objects in the collection,
3. the Collections Object provides metadata support for contextual tagging (taxonomic annotations) to assist semantic processing applications in processing data in the collection or for automating indexing and update of the collection,
4. the Collections Object provides native support for versioning on itself and data objects referenced by it,
5. the Collections Object supports privacy labels for MAC-enforced security authorizations, and
6. the Collections Object supports preservation services by providing an explicit per-collection retention policy.

Collections are the native structure for organizing all data objects managed and processed by the DLS in some embodiments, and must therefore behave polymorphically in the presence of different access methods and applications. While a variety of technologies such as network operating systems and file servers have previously developed techniques for mapping different types of file services on a common native file store (e.g. the ability to support NFS and CIFS file systems and semantics over a common storage model with fidelity for naming and native ACLs), the challenges addressed by the collection manager are broader.

Since the DLS is designed to function as a system for managing all data objects for an individual or small group over long periods of time, the collections manager must deal with file system semantics, but also semantics of other data objects including mail and messaging applications, syndication feeds, calendar and event data, and various application data. As identified in item one of the above list, the collections object supports mappings from multiple services and applications into its uniform object-based data model. As identified in item two, these mappings provide referential integrity between the different service and application views of the data, or semantics, and the internal representations of the data objects as managed by the collection.

In more detail, the collection manager provides an interface to CAS and IAS service agents that allows collection objects to be accessed using semantics and datatypes that are native to the specific type of service agent. The interface allows service agents to create and maintain a consistent view of the data they create and manage, including their security settings and metadata. The collections manager uses the collections object services index field and its array of data and index structure objects to record and manipulate this information. The collections manager provides an API that allows service agents to create a data and index object for their specific agent type; one instance of the data and index object is created for each CAS or IAS agent type that uses the collection. The data section of the object is used to record information about the types of data structures that the service agent requires for its operation, and the index section records the service agent-specific per-object data for each data object (e.g. “file”) that the agent creates or manipulates in the collection. The data and index fields are polymorphic data types that service agent specializes to map the specific semantics and data that it manipulates. The collections object can also provide additional functionality for native DLS applications to create and manage per-application views on a collection in a manner similar to support provided for per-service type views and semantics provided to CAS and IAS service agents.

While each service agent only sees its view of the data it has stored in the collection, different views on the collection object provided by DLS native semantic processing applications can access and dynamically organize the data in more flexible ways. As identified in item three in the above list, the collections object supports contextual tagging. Contextual tagging allows an individual or other DLS automated semantic processing applications to associate terms and predicates with the collection that can enhance processing of its data. For example, an individual who is a chef might create a recipes collection to manage all their mail with various friends or groups on topics related to food, recipe documents, web clippings, references to culinary web sites, and so on.

The collections manager is capable of uniformly representing all of these different data types as part of the recipes collection, and with contextual tagging, the individual can additionally associate terms and/or predicates that allow DLS applications to perform semantic processing and customized presentation of the related data. Continuing with the example, the individual might create predicate tags associating the term “healthy” with preferred types of food groups that appeal to them. Later, the DLS contextual search application can use the “recipes collection” contextual predicate tags to optimize its results so that a search on the phrase “healthy recipes” returns results prioritized to the individual's preferred food group associations with the term “healthy,” as opposed to an unprioritized list of results simply matching the basic search terms. Unlike search techniques based on lexical analysis, the DLS contextual search integrates predicate tags provided by the individual that capture personal preferences, interpretations, and knowledge as part of the search process.

Metaquery support is a related feature to contextual tagging that allows the collection object to index and retain pre-configured queries on various local and distributed data sources. For example, semantic processing features of the DLS can be configured to support optional inference engine and knowledge bases. MetaQuery support allows the collection object to maintain a set of logically related topical queries with the collection data for the purpose of synthetically generating data results in the collection using services from the classifier/inference framework. MetaQuery objects are self-typed objects managed by the Collection Object and referenced through its MetaQuery Index field. The W3C SPARQL language is one example of a MetaQuery object type. Contextual tags may be referenced in MetaQuery objects, and thus returning to our example, the individual might add a MetaQuery object that uses the “healthy” context tag that looks for results satisfying a query for all of the foods that the user has associated with the predicate “healthy,” and which are referenced in recipes published in the last month by a list of their preferred web syndication feeds. The results of the MetaQuery are dynamically generated and may be viewed when the collection object is accessed through the DLS' personal semantic workspace.

As indicated in item 4, the collections object natively supports versioning, thus allowing for changes to the collection to be tracked and, if desired, reverted to a previous version. The collections manager uses services of the DLS' versioning and integrity services to snapshot and maintain versioning information.

Item five in the above list relates to collections object support for security functions provided by the DLS. Privacy labels on each collections object allow the individual to set controls on the collection that restrict its visibility strictly to security principals holding the correct credentials. Returning to our previous example, the individual may set a privacy label indicating that only security principals holding a valid credential for the privacy label “Friends Read Only” granted by the local DLS' trust manager may access their “recipes collection.” The individual may then share their collection using the Trusted Sharing Services, and when access is attempted by another party, that person will only be able to view the “recipes collection” if they have a valid credential with the correct “Friends Read Only” privacy label. The collection object privacy label additionally supports specification of a “Declassification Policy.” The declassification policy allows the individual to indicate the conditions under which the privacy label should become nonrestrictive. For example, the individual may indicate that the label expires at a given time in the future.

Item six in the above list relates to preservation services provided by the DLS and collection object support for retention policies. The retention policy allows the individual to stipulate the frequency at which they want the collection to be written to the configured preservation system, how many versions should be retained in the system at any time, and the duration of the history that the system should preserve. Returning again to the example, the individual may find it acceptable to retain only the current version of any of the data in the collection for a period of two years, and to record it to the OPS no more frequently than once per month. This may be adequate if the data in the collection is relatively stable and the individual has no interest in navigating back over their accumulated history in the recipes collection for more than two previous years. Alternatively, the individual may frequently update their collection and have a particular interest in wanting to be able to navigate back through their history for as long as they've been accumulating it. In this second example, the retention policy could be set to maintain two versions of all updates on data in the collection, to record the collection to the OPS no less than once per week, and to maintain the history indefinitely.

Unlike conventional file systems or databases, the DLS collections object design provides unique, integrated features for treating data created or acquired from both current personal computer applications and devices as well as through online services and normal web browsing, uniformly, across long periods of time, with consistent security semantics.

The DLS collections object design point further expects that even if the original services and applications that were used to create various objects in the collection cease to exist at some point in the future, the individual will still desire to retain access to the data and, more subtlety, any knowledge they've developed as a result of linking, annotating, aggregating, and cross-referencing the various data they've acquired. The collections object and DLS storage object structures are capable of directly capturing, representing, and preserving this type of knowledge.

Data managed by collection object structures is organized in the form of DLS storage objects (DSO). A DSO shares many of the same metadata, privacy, and preservation semantics as the Collection Object, and may inherit data for the same shared fields. For example, DSOs will commonly inherit settings for their retention policy from their associated collection object.

In addition to semantics shared with the collections object, the DSO supports a variety of additional semantics particular to their per-data object relationships, as follows:
the DSO supports provenance metadata which is capable of allowing its source and heritage to be captured including when and by whom it was created and/or modified,
the DSO supports multiple Datastream objects including an explicit per-object indelible identifier, name, data type, integrity, versioning metadata, and configuration label that can be used to establish the set of software modules and versions used to create it, and
the DSO supports a Governance Label which is used to capture information about restrictions or conditions on use of the data associated with the DSO.

DSO support for multiple datastream objects allows services provided by the DLS to create and manage multiple variant renditions of the same data under one set of identifier, name, and metadata attributes. For example, it may be critical to retain an original and unaltered version of a document that was generated in a particular word processor format that has fallen out of wide-spread commercial support because it was cryptographically signed and has commercial or legal value. Yet, at the same time it may also be desirable to generate an easily processed and viewable rendition of the same document using services provided by the DLS format conversion framework for convenient viewing and reference in the future. DSO support for multiple datastreams and rich provenance metadata supports the ability to maintain both the original and the converted datastreams, and sufficient metadata to distinguish and trace the heritage of both versions.

The DSO datastream object structure additionally supports a configuration label attribute. The configuration label allows the collection manager to tag the DSO datastream structure with an operational support services (OSS)-provided configuration label for the version of software running on the DLS at the time of creation. As presented later during discussion of the OSS, the OSS creates a label for each software configuration it provides to DLS systems. This allows subsystems in the DLS that may need to take particular care for tracking actions associated with a particular version of software components to associate a checkpoint label with the sensitive data. The label may be used at a later point in time with cooperation of the OSS' DLS software configuration service to resolve which version of an application was used, and may be particularly helpful for specifying a specific source type to the format conversion framework if a DSO datastream must be converted for rendering in the future.

Additionally, DSO datastreams may be managed either as URI references (i.e. “by-reference” data), or actual data copies (i.e. “by-value” data). This feature of multiple datastreams support allows DSOs to support web “clippings” features of the memory task semantic application, thus allowing the created DSO to optionally retain only a reference to the original source, or a copy and a reference to the original source.

DSO support for governance labels allows each object to retain any specified conditions or restrictions associated with the original data reference, along with information about the authority and the expiration date of the label. The policy element of a governance label is an object that encapsulates a reference to data typically specified by a third party. As an example, Creative Commons Licenses are one class of governance labels currently in widespread use in the internet. Other examples of governance labels may come into use over time based on standards from groups such as ISO MPEG-21. Governance labels are an informative part of the DSO record and, if processable, are enforced by applications outside of the DLS.

Preservation Functions

Support for long-term data preservation builds on various embodiments of the DLS' storage design which effectively treats the local disk storage system as an “object cache.” Integrated metadata, versioning, and data security features supported by the collections object and DLS storage object structures, as previously described, enable secure third-party online storage and redundancy (virtualization) for remote copies of the individual's aggregate set of collections. If multiple individuals share a single DLS as in the case of a family or small group, each individual's collections are individually managed.

The DLS preservation engine and policies subsystem is responsible for managing data preservation functions. The preservation engine runs as a local process in the respective base runtime or per-account virtual machine, and implements per-account processing based on retention policies or historical navigation over collections and storage objects in the account's associated storage volume. Support for preservation functions is provided in conjunction with an associated online preservation service (OPS). The OPS is responsible for account management and backend policy management of mass storage systems for high-availability and reliability of all preserved data.

In the normal case of various embodiments, the preservation engine is invoked periodically according to the current policy settings in order to checkpoint and record both per-account collections, account information, and system data. Policies may be global (system-wide) or local (DLS-specific) in nature. Global policies are periodically supplied to the preservation engine by the OPS as a function of its administrative and maintenance services. OPS-provided global policies provide data for the frequency, versioning, and retention policy for all basic system and account data in the DLS. Local policies are derived from the per-collection retention policies. Local per-collection retention policies override the global default values supplied by the OPS, and may indicate more or less aggressive preservation strategies depending on the settings selected by the individual.

The structure of the data transacted by the preservation manager during interaction with the OPS is organized as a set of “blocks” or stream components. The data structures are referred to as an “epoch Archive Data Record Structure,” or arcdata. The arcdata structure is designed for real-time processing both during reading and writing operations, and is effectively processed in “streaming” mode. A specific instance of an arcdata structure covering preservation of data objects over a specific time period is referred to as an epoch.

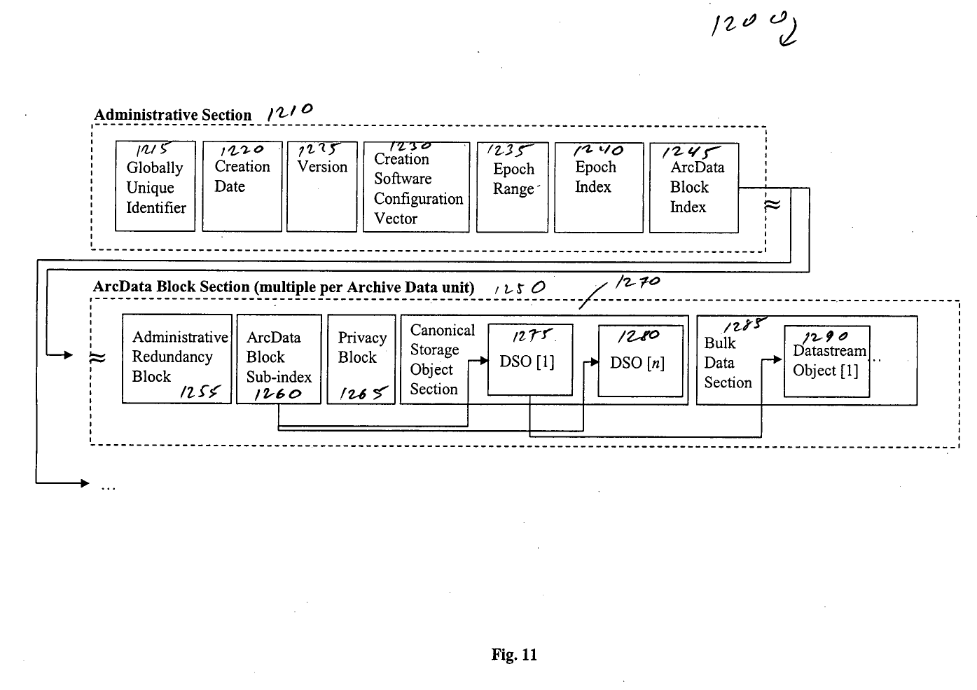

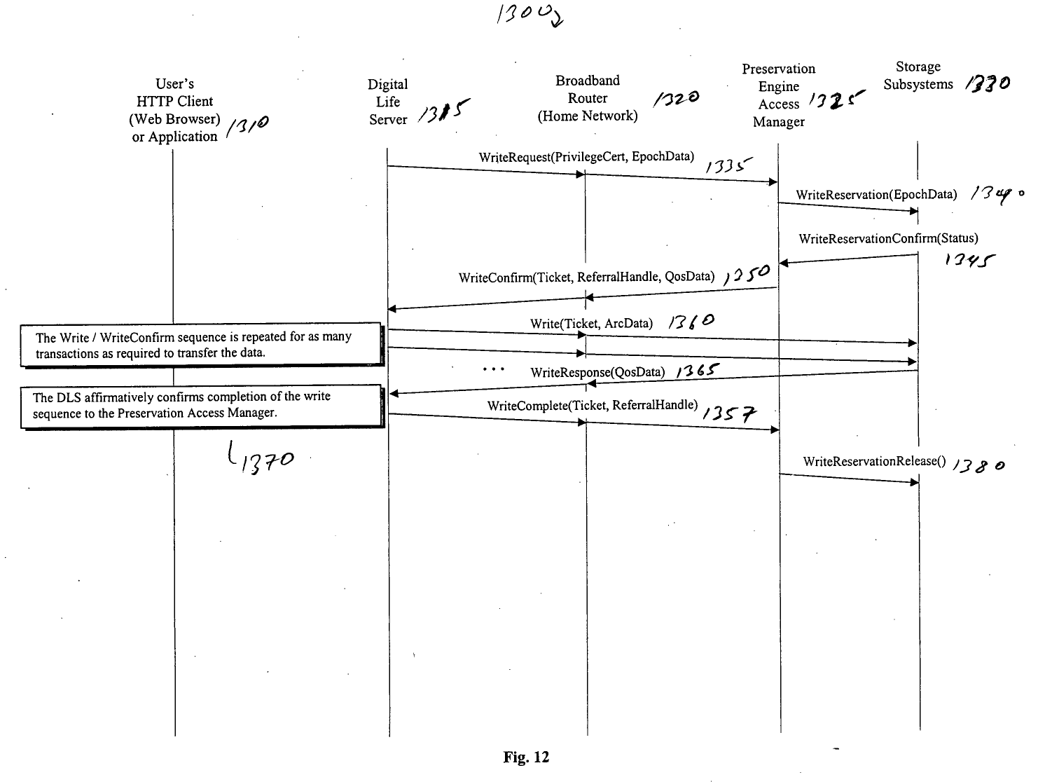

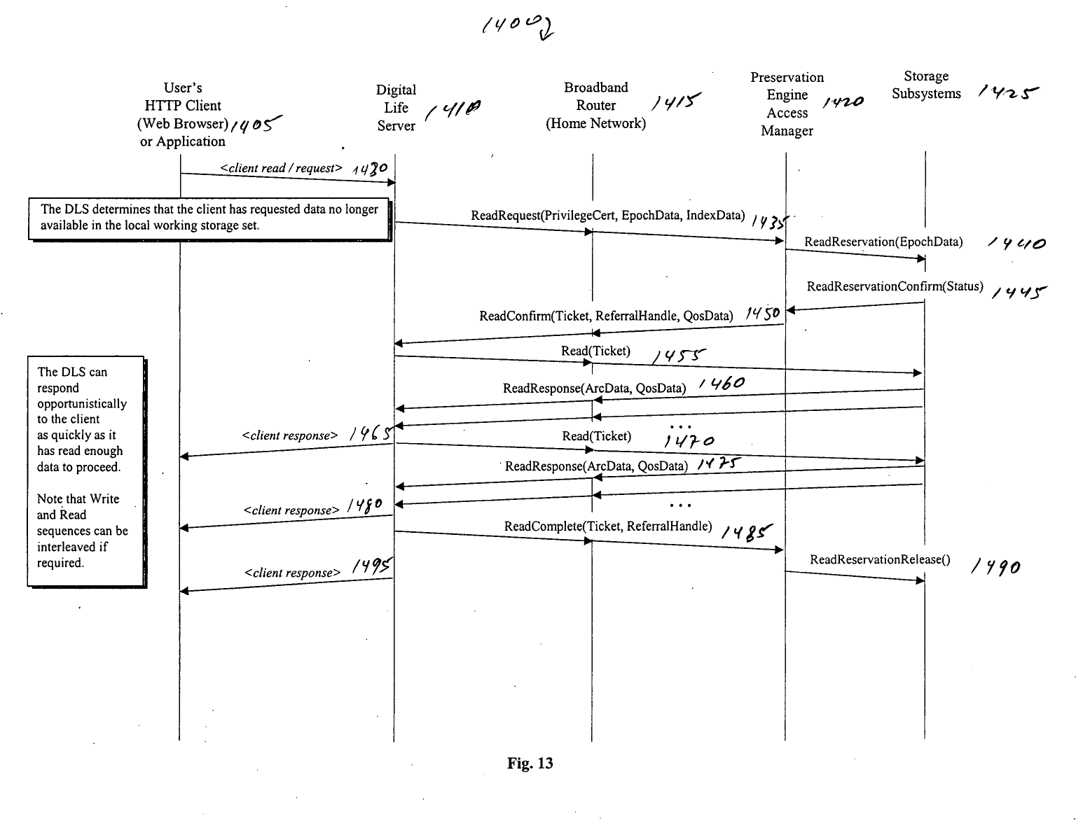

Reference specifically to FIGS. 12 and 13 may provide further details here. FIG. 11 is a schematic diagram illustrating the data structure fields and layout of a preservation services epoch archive data record (arcdata) structure in an embodiment. Arcdata structure 1200 includes an administrative section 1210 (e.g. a header) and one or more arcdata block sections 1250. Administrative section 1210 includes a globally unique identifier 1215, a creation date 1220, a version 1225, a creation software configuration vector 1230 (e.g. information about how the data structure was created), epoch range 1235, epoch index 1240, and an arcdata block index 1245 (which may index into arcdata blocks 1250).

The arcdata block 1250, in turn, includes an administrative redundancy block 1255, an arcdata block sub-index 1260, a privacy section 1265, a canonical storage object section 1270 and a bulk data section 1285. Canonical storage object section 1270 may store a set of DSOs (e.g. DSO[1] 1275 and DSO[n] 1280). DSOs may then point to data stream objects such as object 1290 of bulk data section 1285. Block sub-index 1260 may point to a chain of DSOs or provide a set of pointers to a set of DSOs, for example.

FIG. 12 is a schematic diagram illustrating the protocol data flows and relationships for writing preservation arcdata from the DLS server appliance to an online preservation service (OPS) system in an embodiment. Data flows between a user client 1310, a DLS 1315, a router 1320, a preservation engine access manager 1325 and storage subsystems 1330 within a preservation system 1300. Initially to write data, DLS 1315 makes a write request 1335 to manager 1325. Manager 1325 then reserves a write access 1340 with storage subsystem 1340. Subsystem 1330 confirms 1345 the write reservation, and then manager 1325 confirms the write to DLS 1315. Data is then written 1360 through from DLS 1315 to storage subsystems 1330. This may be repeated as necessary.

Storage subsystems 1333 confirms 1365 the writes were executed. Responsive to this confirmation 1365, the DLS confirms the write 1370, and completes the write request 1375. The write reservation is then released 1380, allowing for other access.

More specifically, when the preservation manager is writing data from the DLS to the OPS service, it creates an authenticated connection with the OPS service indicating the epoch that it wants to write. If the authentication materials are approved by the OPS, the OPS allocates a reservation with the storage system for the requested transfer and returns an authorization, or “ticket,” and an opaque referral “handle” to the DLS' preservation manager. The preservation manager uses the ticket and referral handle to identify the authorized reservation when it's ready to start writing data to the storage system. The preservation engine creates the arcdata record for transfer dynamically and sends the blocks incrementally as it works its way through the data selected for the archive set according to the current policies. The arcdata is cryptographically protected for confidentiality and integrity as it is transferred, using keying materials generated by the local process' trust manager. Cryptographic processing is applied at the granularity of stream blocks (except for the administrative block, which is only processed for integrity).

When the preservation manager is reading data to the DLS from the OPS service, it creates an authenticated connection with the OPS service identifying the epoch it wants to retrieve (possibly at the sub-epoch block level), and then reads the data in streaming mode from the remote storage system and processes it immediately to restore the collections and objects in the record. Similar to the writing process, decryption and integrity verification is performed dynamically as the data is received.

In more detail, when the preservation engine commences a writing sequence, it requests the DLS' history manager to determine the starting date of the epoch it should create. The starting date of the epoch is not simply the date following the last recorded checkpoint, but may instead include a sparse matrix of data from an earlier time period that has already been recorded if the data from the earlier period was modified, for example as determined from the collection object or DSO versioning metadata. The preservation engine uses the information from the history manager to process the set of collections and objects for the archive set and creates an index for the epoch that identifies all of the objects contained in it. The epoch index is then retained for the arcdata administrative block and a copy is provided to the history engine. The history engine merges the epoch index with its local master index of every collection and data object that has existed in the system. The history engine's master index is periodically recorded to the OPS as well, according to the OPS-specified retention policy.

During history navigation, such as when the individual is using the DLS' semantic history navigator, the individual may scroll to a historical point for which there is no data in the local DLS object storage for processing. The history engine services navigation requests and can determine using its master index the epoch in which a certain object exists and its dependencies (in case these might span multiple epochs). Failure to locate the requested object in local storage causes the history manager to raise a notification to the preservation engine with the epoch data it needs to retrieve. The preservation engine invokes the read process with the OPS and retrieves the associated arcdata blocks as previously described.

OPS-provided global policies for the preservation manager include information about cache management strategies, including conditions that might exist in the DLS when it is optimal for the preservation engine and history manager to perform anticipated reads if the user is operating on data that is close to an epoch for which data is no longer available on the local DLS. OPS-provided global policies also provide direction to the preservation manager and history engine for when it may be optimal to purge certain epoch data. In both cases, the OPS only provides policy data and is not involved in execution or enforcement of the policies by the DLS.

The advantage of having the OPS provide the cache management policies for the DLS preservation manager is that it is able to monitor a wide variety of access behaviors and performance metrics across aggregate workloads and generations of DLS systems as well as its own quality of service (QOS) performance. The aggregate monitoring data allows the OPS to model quality attributes systematically across its overall operations, allowing it to adjust policy for improvements to overall availability, transfer speed, liveness, effects of different block size policies on overall performance, default outstanding block transfer window settings, and possibly other conditions. The data available to the OPS for performing this monitoring is strictly aggregate and neither relies on, or contains, any DLS-specific or sensitive information.

Special Issues for Preservation of Cryptographic Materials and Account Information

The DLS, in some embodiments, requires that an individual's or small group's account must be able to survive and evolve according to consistent privacy and authorization semantics over very long periods of time, yet also implement best practices for refreshing and renewing all cryptographic materials underlying the representation, evaluation, and enforcement of those semantics. It is predictable that the set of supported key strengths and cryptographic algorithms will change, perhaps very significantly, over time, and yet over time different sets or configurations of cryptographic infrastructure will have been employed to process data or establish authorizations and trust relationships during any particular period. In support of these evolving requirements, it is therefore critical to establish a set of storage and processing mechanisms that take a virtualized approach to creating and managing all resources and data in the user's environment, such that aspects of the required infrastructure can be restored and executed when or if required, and that the history of any associated security semantics is explicit and inspectable.

The DLS is designed to automatically and securely preserve credentials, certificates and associated resources that have durable value in conjunction with the evaluation or verification of specific data objects as part of the preservation engine function, thus allowing the individual to navigate to a point in their historical timeline, and access and inspect durable parts of their record. This functionality specifically does not apply to protocols or functional aspects of communications supported by the system which must correctly enforce techniques such as perfect forward secrecy, and it is explicitly not a form of key escrow. Rather, the history engine, collections manager, and preservation engine work together to ensure that necessary resources that must exist in order to cryptographically process or verify a given item, typically a DSO datastream, are retained and can be restored when required. Techniques for ensuring protection of cryptographically-sensitive keying materials include cryptographic wrapping and binding of the materials with the associated DLS account in such a manner as to ensure that they cannot be easily copied, reused, and/or subverted for malicious purposes if inadvertently exposed. Such wrapping and binding functionality may be accomplished in a variety of ways using a reliable and sufficiently strong key or token that is uniquely associated with the DLS account. In general, preservation of cryptographic materials is managed like other collections and DSO objects using the protected arcdata streaming mechanisms as previously described. The primary difference is that preservation of sensitive cryptographic materials is transacted with the trust manager, and the trust manager is responsible for any processing that must be applied to protect the materials prior to making them available for preservation.

The DLS' preservation engine, history engine, and arcdata processing functions are able to represent the necessary information and support the ability to restore or configure processing in the virtual machine in a manner that allows associated data from a referenced epoch to be processed according to the mechanisms and policies of the system and the data as recorded. DLS processing of historical data and authorizations, for example involving digitally signed and hashed data, should be able to arrange availability of the necessary cryptographic materials from the relevant epoch in order to verify the signature and report on the integrity of the data as captured. This must be done in conjunction with the current processing configuration and policies, and it may raise an exception if certain policies have changed or expired due to the passage of time. For example, the certificate for the required signature verification key may indicate that it is no longer legally valid. Irrespective of a policy exception arising from this type of time-based condition failure, the DLS processing is able to answer questions about validity of the data within the epoch that it was originally recorded, in which case the exception can be evaluated relative to its implications as a condition arising from the different timeframe and context of interpretation.

Notice that historical processing addresses a different set of issues than processing to refresh or update a digital signature on a given DSO Datastream. In the case of refreshing the signature on an historical object, the object is retrieved if required using the standard functions of the preservation engine, and is then made available to an application either hosted by the DLS or a different system, as required. The refreshed object can then be stored as a new DSO datastream with the original DSO, or handled as a new DSO and associated datastream. The choice of the correct approach is specific to the semantics of the application or authoritative legal jurisdiction. Regardless, the DLS provides for both cases, and the resulting effects can be correctly preserved and navigated historically based on the metadata associated with the objects.

Semantic Processing Framework

Some embodiments of the semantic processing framework (SPF) provide functionality for consistent application of a set of data processing techniques for acquisition and organization of facts, queries, and reasoning over content acquired dynamically through web protocol transactions and from DLS data storage object (DSO) datastreams. Semantic processing in the DLS system provides functionality including:
acquisition of facts from metadata and content in documents and datastreams of interest to the individual;
annotation and creation of facts, including concept relationships between facts, using individually-defined terms, formal taxonomies, and/or formal ontologies;
management of collected facts and annotations using W3C RDF standard representations; and
organization and processing of facts for simple queries and more advanced inference operations using DLS Contexts.

Functionality supported by the framework enables creation of DLS applications that can assist users in identifying and stating knowledge about the documents, media, events, topical information, and references they value, as well as explicit and/or inferred relationships based on temporal, topical, task-based, or other predicate relationships described through standard W3C RDF statements managed by the individual's RDF fact store.

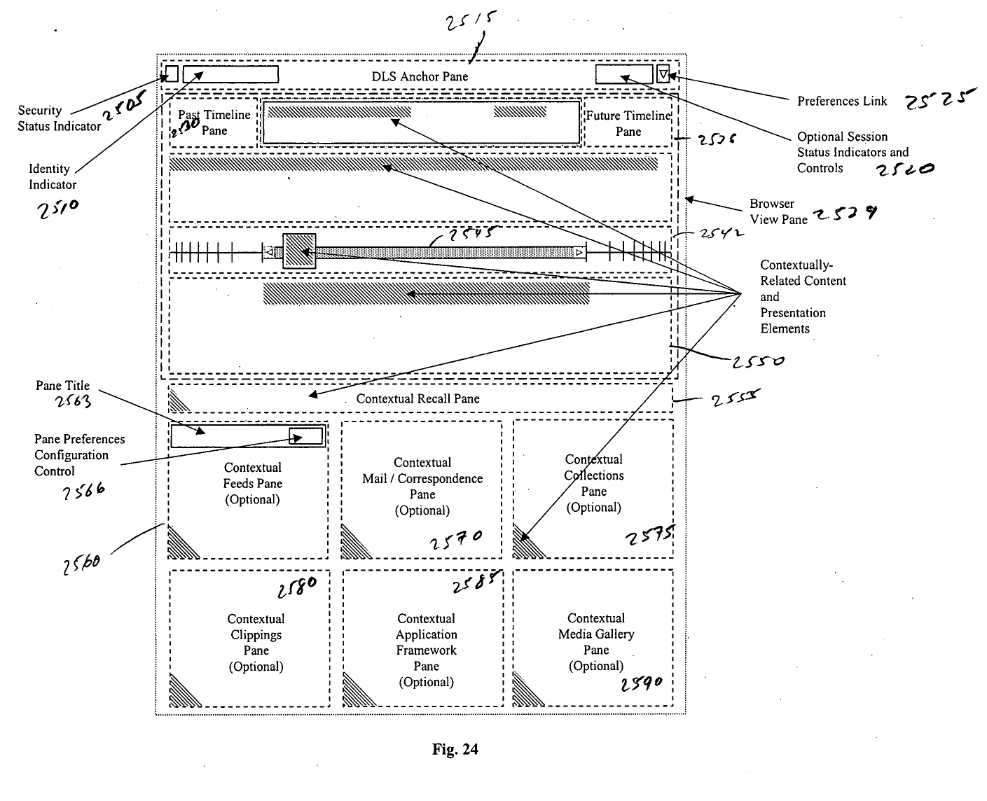

The personal semantic workspace application, as illustrated in FIG. 24, is an example of a DLS application that utilizes SPF services and techniques for multiple content types including:
standard web page structures and references based on the suite of W3C XML and DHTML standards, etc.;
syndicated web feed datatypes such as RSS, IETF ATOM, etc.;
e-mail and messaging datatypes;
multi-media datatypes such as JPEG, the suite of MPEG standards, etc; and
DSO Datastreams which can convey of any of the above datatypes as well as an effectively unlimited variety of word processing spreadsheet, presentation document, and other application formats.

Functionality provided by the SPF includes:
routines for analyzing web and DSO Datastream structure information for the purpose of identifying content data and metadata elements in the web page or DSO Datastream;
content filtering and extraction routines for collecting facts from web and DSO Datastreams;
annotation of structural information and extracted content using both formal and user-defined taxonomies;
inspection and reasoning operations using the individual's RDF Fact Store, as well as formal taxonomy, concept, and/or ontology databases;
support for persisting, preserving, restoring, and managing the individual's RDF Fact Store along with supporting ontology and taxonomy databases required for functioning of the framework;
contextual search, or “recall,” using SPF services in conjunction with DLS Contexts; and
selection and contextual presentation of semantic data sets using advanced RDF processing languages.

SPF subsystems and their use in various DLS application scenarios is illustrated in FIG. 5, and described in the following paragraphs.

Referring first to FIG. 5, there are six subsystems and a set of databases that comprise the semantic processing framework. While aspects of the following subsystem descriptions may explain some processing as sequentially ordered operations, practitioners skilled in the art will recognize that a variety of multi-threaded and concurrent programming techniques can be used to optimize execution of SPF processing including event-driven processing, dynamic pipeline processing, blackboard/message-based processing techniques, and potentially combinations of these in order to achieve loosely-coupled, concurrent multi-threaded execution whenever and wherever possible within the framework. For example, descriptions involving document structure processing, dereferencing and retrieval of resources from remote systems, and context extraction involve multiple subsystems whose functions can be executed concurrently based on synchronization around status and availability of resources consumed or produced by each subsystem.

It is additionally important to understand how SPF subsystems handle references and identifiers. As previously introduced, the SPF supports processing on any supported datatype, where the set of possible supported datatypes is extensible and can evolve over time. It is therefore desirable for SPF processing to utilize a self-identifying type of object reference, and in the case of the DLS this datatype is referred to as the conformable object reference (COR).

The COR is an extensible object structure for passing different types of references as self-identifying datatypes in a uniform manner. The COR additionally provides a means for specifying certain policy options, and if required, attachment of authorization credentials, to a specific reference. COR policy settings enable the application that creates the COR to specify requirements for SPF subsystems, such as whether it is permissible for an SPF subsystem to autonomously invoke processing by the Format Conversion Framework in order to request translation of a source datastream datatype. As another example, policy settings can be used to convey the depth and scope of traversal that the SPF subsystem should pursue in dereferencing the associated reference, for example to ensure no more than a single depth traversal on a remote URL reference, or multi-level traversal but not beyond the specific target host. As another example, policy can be specified in the COR to restrict or prohibit processing of script code or active content associated with the object reference by the SPF. COR support for attachment of authorization credentials allow the application creating the COR to effectively delegate authorization to the SPF subsystem in the event that the SPF subsystem requires specific authorizations to access the referenced datastream.

The COR structure supports a variety of different reference/identifier syntaxes including standard IETF URI schemes such as a URL; a DLS local identifier based for example on a DSO Datastream Identifier (see FIG. 10); or any of a number of other standard identifiers such as a DOI (Distinguished Object Identifier), etc.. The possible range of reference/identifier datatypes that can be represented by the COR is dependent on the range of support available in the DLS' set of configured service agents that can handle processing and retrieving the type of reference. For example, COR objects constructed with references that are URL datatypes can be passed to the Proxy Framework and Cache Storage Manager, where they will be dereferenced and retrieved by the configured IAS service agent as previously described. COR references that are DSO Datastream Identifier types are handled by the Collection Manager.

The COR is created by the application program that invokes SPF processing and is ultimately released or destroyed by the application when the requested SPF processing is completed. References carried by the COR which may need to be persisted by SPF subsystems during processing, for example as the subject or object of an RDF statement, or fact, are copied as the native reference or restated as a fresh URI, or possibly even cast as a distinct fact by the SPF subsystem as part of its internal operation. Credentials attached to the COR are never persisted and, regardless of this fact, should as a matter of practice be issued with a limited validity period consistent with the amount time required to complete the operation.

The primary advantage of the COR is that it provides a programming language-neutral, polymorphic approach to dealing with references throughout the SPF and its subsystems. Additionally, unlike common approaches such as simple self-typed opaque identifier references, the COR allows DLS applications to express conformable behaviors to SPF subsystems using explicit policy and trust semantics for delegation of authority (thus the moniker “Conformable Object Reference”). Finally, the particular utility of this strategy in conjunction with SPF subsystems is to allow loose coupling while achieving expressive trust and policy semantics at per-reference granularity for how DLS applications request processing and how SPF subsystems fulfill those requests.

Referring again to FIG. 5, the SPF object structure analyzer (OSA) provides functions for retrieving and parsing a source datastream's structural information and identifying content data elements and metadata within the structure. OSA structure processing uses a document/content tree structure based on the suite of W3C XML standards.

The OSA is invoked with a COR object and DLS Context reference by the requesting DLS application. The DLS application receives an object reference from the OSA in response, and the OSA continues its work asynchronously. The object reference returned by the OSA allows the DLS application to:
access OSA processing results;
register for asynchronous notifications and exceptions during processing;
test and set status during processing, including the ability to cancel all associated SPF processing;
invoke processing by other SPF subsystems on the OSA document/content tree; and
indicate when the DLS application is done with the services of the OSA and other SPF subsystems so that allocated memory and processing resources can be released and garbage collected as appropriate.
   Using information provided in the COR, the OSA performs the following functions:
if the type of the object reference in the COR is a DSO Datastream, the OSA requests access and retrieves the datastream using services of DLS Collection Manager possibly using credentials provided to it in the COR if required, otherwise the reference is given to the Proxy Framework for processing and retrieval using IAS, TSS, or CAS service agents, as appropriate;
if the datastream is retrieved using services of the Proxy Framework, an object reference is created by the Proxy Framework and returned to the OSA for asynchronous access to the retrieved data; the correct service agent is invoked by the framework to retrieve the datastream; and the resulting datastream object(s) are cached by the Proxy Framework for subsequent access by the OSA and potentially other SPF subsystems;
using the object reference returned by the DLS Collection Manager or Proxy Framework (as appropriate), the OSA parses the datastream objects to construct an internal representation of the document's structure as a standard XML DOM document/content tree, and notifies the SPF framework subsystems that there is a document for them to process along with the DLS Context reference that was passed to the OSA when it was invoked by the DLS application;
if the OSA cannot process the datastream and the policy provided in the COR is non-restrictive, the OSA may request conversion of the source datastream to a target format that it can process using services of the Format Conversion Framework, otherwise other SPF subsystems are never notified about processing and the OSA returns a processing exception to the original calling DLS application indicating that it could not process the datastream;
as part of its processing, the OSA may encounter references in the datastream to other remote resources including W3C RDF and RSS/IETF ATOM data that could be retrieved and processed in conjunction with the DOM currently under construction; the OSA uses services of the DLS Collection Manager or the Proxy Framework as appropriate to retrieve the additional resources for processing consistent with policy restrictions specified in the original COR concerning scope and depth of traversal;
as part of its processing, the OSA may encounter embedded Javascript/ECMAscript code in the datastream that, if executed, may affect the DOM tree; the OSA first consults policy provided by the COR to determine if script processing is allowed, and if not specified, also consults the SPF Policy and Preferences Framework; if the processing is allowed, the OSA may execute the script and apply any results to the document/content tree; and
the process continues until all structure processing is complete.

The OSA effectively encapsulates all processing required to internalize the structure, metadata, and content nodes provided by the datastream in the XML DOM-based document/content tree. Practitioners skilled in the art will recognize that a variety of technologies are available for XML DOM processing consistent with the W3C specification, and which can be used to implement generic DOM processing within the broader set of OSA functionality as described.

The content extraction and filter framework, as illustrated in FIG. 5, provides functions to parse content and metadata associated with the datastream and 1) identify and extract W3C RDF data for facts supplied with or referenced by the datastream, and 2) apply any filter tasks for identifying, extracting, and synthesizing facts from the content. Content extraction applies filter routines by operating on the OSA document/content tree, providing functionality including:
document node filter patterns for selecting one or more content nodes within the document/content tree identifiable as a particular type of higher-level semantic element, such as an article, a recipe, instructions, treatment, a well-defined form or table structure, a multi-page article, etc.;
content filter patterns for extracting facts from the document/content tree conforming to well-defined schema such as the Dublin Core, Friend-of-a-friend (FOAF), W3C RDF Calendar format, and/or potentially many other ad-hoc, micro-format, and standardized specifications;
filter patterns for eliminating certain document/content nodes such as advertisements; and
filter patterns for retrieving embedded references within content nodes; etc.

Filter patterns are self-identifying objects that are typically written using either the W3C Extensible Stylesheet Language Transformation (XSLT) XML language, or possibly using Javascript/ECMAscript, depending on how they can be composed and where they can be applied by the framework. Filter patterns are created to detect and match the most narrowly defined datatype, and are composed using processing defined by the context extraction and filter framework to operate on larger structures such as a complete OSA document/content tree. Composed sets of filters can be named and reused. In the interests of maximum reusability and composability, filter patterns should be designed to operate on discrete datatypes or structure patterns as in the case of a particular microformat such as FOAF, as opposed to complete documents or web pages, and thus should be as stable as the datatypes they are capable of processing. Other techniques for content extraction may also be appropriate in various embodiments.

Unlike single-pass page-level or document scraping techniques that are structure-specific and selected using URL pattern matching, the SPF content extraction and filter framework utilizes dynamic datatype and node-type matching techniques. The discrete filters are composed using framework processing techniques for traversing the document/content tree that include support for backtracking or multi-pass analysis, thus allowing the framework to adapt the application of filters based on what is learned from matches and/or failures during processing. Whereas single-pass page or document level scrapers tend to be very sensitive to changes in the content or matching URL structure, which is a particular problem in processing highly irregular or frequently changing web-based content, the SPF approach provides a more adaptable technique for best-effort detection and extraction.

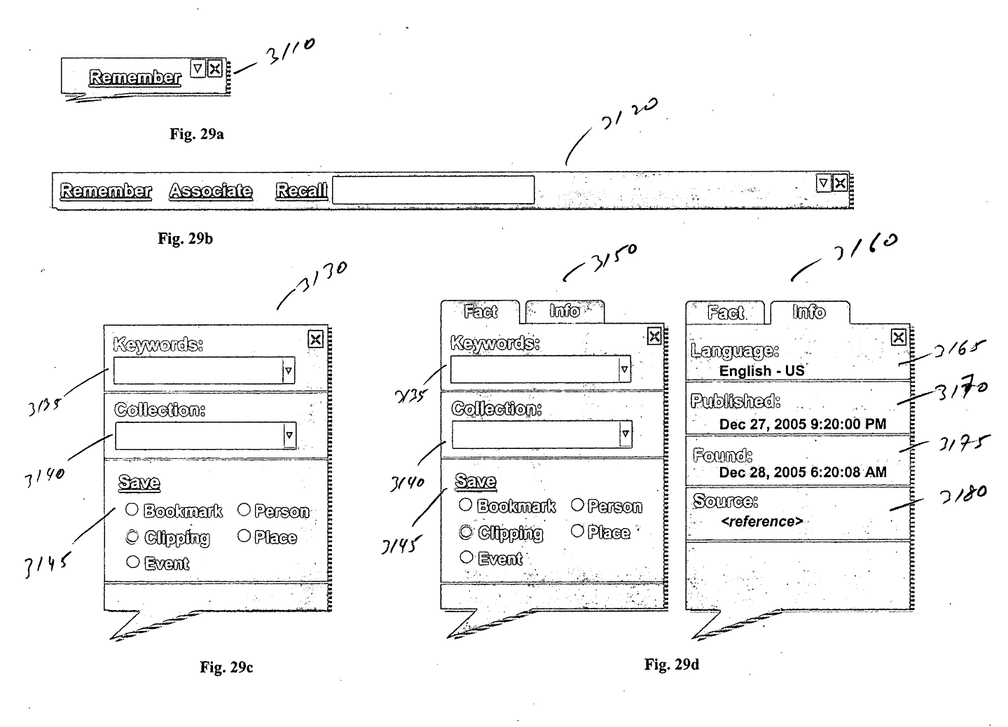

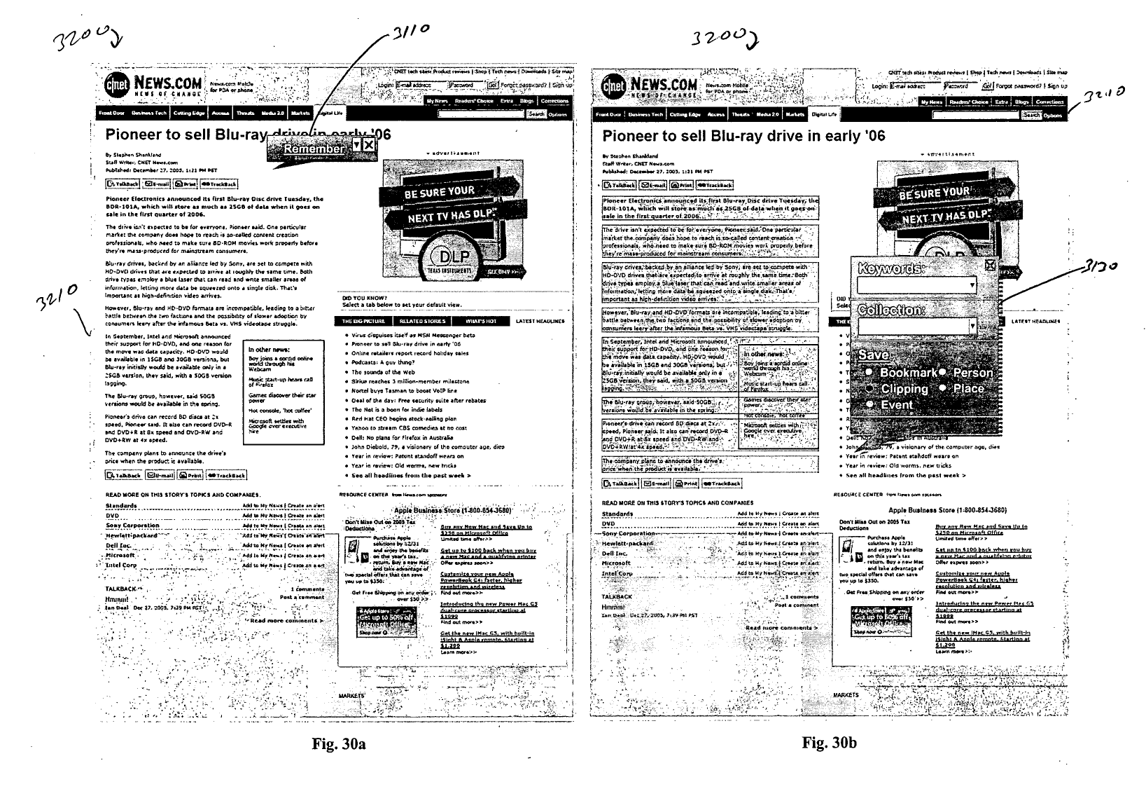

The collection and annotation framework provides functionality for identifying and extracting facts and content from web dataflow in conjunction with proxy-based browsing activity. The collection and annotation framework uses services provided by the object structure analyzer, content extraction and filter framework, SPF database services, and the SPF policy and preferences framework. The collection and annotation framework can be driven both by APIs provided to the web applications framework, as well as through event-driven automation in conjunction with the Proxy Framework in conjunction with normal web browsing. General operation of the collection and annotation framework in some embodiments works as follows:
either through its API or by event notification from the Proxy Framework, the Collection and Annotation framework is invoked and provided with a COR that contains a URL type reference and policies, if any;
if the framework was invoked by the Proxy Framework due to an HTTP Request from a remote browser connection, it also receives an object reference from the Proxy Framework for access to datastream objects cached by the proxy in conjunction with the HTTP Response; the Proxy Framework concurrently invokes the ISA service agent with the URL and proceeds with caching the HTTP response data;
the framework determines from the SPF Policy and Preferences subsystem whether the URL type reference in the COR matches the individual's preferences for sites that should receive a Memory Task overlay object; if the reference does not match, then the process terminates;
if the COR URL type reference does match, the framework directs the Web Interaction Framework to inject the appropriate script code for the Memory Task overlay into the HTTP response datastream to the browser;
the Web Interaction Framework coordinates with the Proxy Framework to inject the overlay into the response data and the response is returned to the browser similar to normal proxy cache functions;
the Collection and Annotation framework invokes the Object Structure Analyzer (OSA) similar to the previous description using an SPF-internal API that allows it to pass the COR and the Proxy Framework object reference, and the OSA processes the datastream in the normal manner to create a document/content tree;
the OSA posts a notification to the SPF that a document is available for processing, and the Collection and Annotation Framework proceeds with its processing on the available document/content tree as previously described;
if the individual desires to “Remember” the web page by clicking on the Memory Task overlay link (FIG. 29a, or 29b, depending on which interface was injected according the individual's preferences; see also 32a), the local Memory Task script uses an XMLHttpRequest/XMLHttpRequest Callback sequence to retrieve a list of Collections and recently used keyword terms from the Collection and Annotation framework;
the Memory Task script code changes the overlay to the Fact Collection Task (FIG. 29c, or FIG. 29d, depending on the individual's preferences);
if the individual changes their mind, they can simply terminate the overlay task using the upper right corner interface control to dismiss the window, in which case the overlay script uses an XMLHttpRequest to indicate to the Collection and Annotation Framework that the activity was aborted;
if the individual decides to complete the annotation task, they select the desired Collection from the overlay drop-down and set the desired keyword terms using the overlay interface (e.g. FIG. 29d, FIG. 30b); optionally, the individual may also indicate whether the reference should be treated as a bookmark, a person, a place, an event, or a clipping;
the individual may additionally select text in the browser interface that they would like to associate with the annotation;
the individual then selects the “Save” link in the Fact Collection Task overlay (FIG. 29a, FIG. 29b); the script code uses an XMLHttpRequest to provide the Collection and Annotation Task with the keyword terms, the selected Collection, the type indicator (e.g. person, clipping, bookmark, event, place), and if the user made any selections in the browser window, a vector of DOM node identifiers for the selection;
the Collection and Annotation Framework uses the values returned from the Fact Collection Task as well as data from Content Extraction and Filter Framework processing to construct a set of fact records for the individual's RDF Fact Store database; additionally:
   if the individual selected any content, a DSO is also created in the indicated Collection along with a Datastream for the selected content;
   if the individual selected the “clipping” option in the Fact Collection Task interface then the selection is retained “by value,” in which case the selected part of the document/content tree is copied under control of the Collection and Annotation Framework to the datastream from the indicated range of DOM nodes;
   if the individual selected the “bookmark” option in the Fact Collection Task interface then the selection is retained “by reference,” and only the URL reference is recorded;
once all processing is completed, the Collection and Annotation Framework uses the object handle from the OSA to indicate that the memory and processing resources can be released and garbage collected; resources held by the Context Extraction and Filter Framework are similarly released; the Proxy Framework manages the remaining cached data according to its currently configured caching policy.

Important benefits to observe about the design of the collection and annotation framework that distinguish it from other similar systems in some embodiments, are as follows:
the processing architecture is designed to eliminate the need for installation of additional resident code on the individual's client browser—the system can work with any contemporary browser on any device, and browser navigation works in the normal manner;
perceptual response for the initial page load at the client browser is minimally impacted since the Proxy Framework effectively forks semantic “fact” processing tasks from execution of the HTTP Request and caching of the response data; heavyweight processing is performed asynchronously on the DLS while the HTTP response data is immediately returned to the client browser, thus improving perceptual performance at the browser and allowing the tasks to perform in a browser-neutral manner;
injection of the Memory Task overlay code is conditionally controlled by user preferences, thereby allowing individuals to see this only for categories of websites of their choosing;
data transfer between the Memory Task script in the client browser, and the Collection and Annotation Framework functions running on the DLS are minimal and can be optimized through local caching improvements as background tasks as optimizations to the described protocol flow—for example, Collection and tag data for the Memory Task Annotation overlay can be requested and transferred in the background before the individual makes their selection at the client browser;
resulting fact data and the related Collection reference are connected along with any persisted clipping, person, event, or place data;
unlike techniques based on copying portions of the browser's page image, the SPF Content Extraction and Filter function in conjunction with the Object Structure Analyzer can programmatically produce the set of desired content nodes using filter processing to remove any undesired overlapping content such as advertisements, “clear pixel” tracking images (also known as “web bugs”), etc.; and
Content Extraction and Filter Processing functionality can be configured using the SPF Policies and Preferences Framework, to acquire and populate metadata for DSO provenance-related attributes (e.g. authority metadata, creation, and modification times) and, if applicable, governance labels (e.g. Creative Commons licenses, etc.), for retained content such as clippings, thus ensuring durability of this metadata along with the associated datastream (FIG. 10).

Separating heavy-weight and content-sensitive fact collection processing functions under the collection and annotation framework from browser-hosted UI elements allows the SPF processing framework to adaptively improve processing features through ongoing updates to filters and policy without requiring updates to client code. This further allows feedback from users of the system to direct improvements to policy and filter components in the SPF, in particular affecting the content extraction and filter framework, providing a relatively transparent experience that can be incrementally improved through updates to the DLS with improved or new filters and policies from the operational support services (OSS) provider.

Returning to FIG. 4, the SPF query and reasoning framework (QRF) provides programmatic interfaces for composing queries over the individual's RDF fact store, along with any additional formal ontology, concepts, and/or taxonomy databases as appropriate. Whereas the collection and annotation framework is primarily focused on collection of facts in conjunction with the individual's web page browsing activities, the QRF provides a set of programmatic interfaces (API) for submitting and processing queries over the collected facts.

As previously mentioned, the semantic processing framework supports multiple databases, the most fundamental of which is the individual's RDF fact store. The fact store consists of the RDF statements collected both using automated functions of the object structure analyzer and content extraction and filter framework, as well as through user-directed processing using the memory/fact collection task application in conjunction with the SPF collection and annotation framework as previously described. Additional third-party databases can also exist for formal representations of taxonomies, ontology data using W3C OWL language descriptions, and concept databases based on W3C RDF or possibly other formats.

Functionality provided by the QRF supports queries and reasoning operations over the individual's RDF fact store, and potentially other compatible knowledge databases configured with the SPF, using the W3C standard SPARQL QL language. Practitioners skilled in the art will recognize that there are multiple available SPARQL database and library technologies, and any of these are potentially useful for implementation of the QRF. The QRF API allows the framework to augment queries from DLS applications using context and policy settings from the SPF policies and preferences framework and DLS context manager. Specifically, the QRF API allows calling DLS applications to indicate to the QRF whether it should augment submitted queries with attributes from the current context. This functionality allows calling DLS applications to allow the QRF to incorporate facts from the current context that may effect results of the query, such the historical time frame as currently established by updates from the semantic history navigator to the context manager. The QRF may additionally use policy settings from the SPF policy and preferences framework to configure or limit security sensitive queries in conjunction with the SPARQL library.

Building on Trusted Sharing Services functionality provided by the DLS (described earlier), it is additionally possible, if configured and authorized by a set of individuals using appropriate trust manager provided credentials, for QRF queries to access RDF stores across different accounts and DLS systems. Support for such a configuration requires the DLS application to construct the references to the shared RDF stores, and may require additional credentials for access to results that reference DLS collections, data storage objects (DSO), or DSO datastreams if they are not available within the Trusted Sharing Service shared storage volume.

The SPF facts presentation framework (FPF), as illustrated in FIG. 4, provides a set of programming interfaces for selecting and delivering representations of RDF facts according to the selection criteria and presentation styles specified by different DLS applications. Functionality provided by the FPF is based on the W3C Fresnel standard. The W3C Fresnel standard consists of two parts: the display vocabulary for RDF, and the Fresnel Selector Language (FSL) for RDF. Fresnel provides a browser-independent approach for specifying how to display an RDF model using the concepts of “lens,” “format,” and selector.” A W3C Fresnel lens is used to define which properties of an RDF resource to display and their ordering. A “format” is used to define how the selected RDF resource properties are rendered. Finally, “selectors” are used to specify which lenses and formats apply to which sets of RDF facts.

Similar to the architecture of the QRF framework, the FPF effectively hosts access to a standards-conformant W3C Fresnel library implementation through a higher-level FPF API. Practitioners skilled in the art will recognize that there are multiple library technologies for the W3C suite of Fresnel standards, and any of these are potentially useful for implementation of the FPF. In more detail, the FPF provides functional integration of the W3C Fresnel standard concepts of lens, format, and selector, as follows:
lens data is provided by the DLS application in the form of a reference to an XML resource (file); the DLS application manages one or more lens specifications as local application resources, which it provides in API calls to the FPF according to its specific needs;
the FPF supports the W3C Fresnel concept of “format” using settings from the current Context and the DLS application; for example, the DLS application provides a CSS style sheet corresponding to the selected lens as input, and additional styles are provided by the FPF based on settings from the current Context; and
the FPF supports the W3C Fresnel SPARQL QL selector format using services of the QRF.

DLS Semantic Applications

Digital life server (DLS) supports a user's long-term information needs through a variety of services and applications which may be implemented collectively or separately in various embodiments. For example, configured on a network with compatible CAS service agents, the DLS can interoperate with existing personal computer systems using standard file service protocols in the form of a commodity network-attached storage device. However, even in this relatively simple configuration, the DLS functions as a storage device with high availability and effectively unlimited capacity, with added ability to securely navigate file versions and history in a dynamic manner over long periods of time. Similarly, the DLS can be configured as a proxy server for electronic mail (POP/SMTP/IMAP) or syndicated feeds (e.g. RSS, IETF ATOM), allowing it to effectively aggregate and provide a secure single point of management for all user identities and accounts in conjunction with existing personal computer desktop and device application configurations. In all cases, Preservation functions of the DLS ensure efficient long-term navigation and recovery of data across all of these applications and data.

The DLS further incorporates support for a flexible set of fact acquisition and reasoning functions as provided by the semantic processing framework (SPF), thus supporting creation of applications capable of representing and manipulating both explicit and inferred relationships between data regardless of its origin, either from the web, or by means of objects managed the DLS using contexts, collections, data storage objects (DSO), and DSO datastreams. Web applications provided with the DLS that utilize the collective functionality of the SPF and other DLS, subsystems for rich personal information services are referred to as the DLS semantic applications.

OSS and OPS Services

Operational Support Services

The DLS system should be capable of significant technical evolution over long periods of time in some embodiments. Economical construction and operation of DLS appliances is expected to utilize low-cost commodity microprocessor, networking, power, and disk components in some embodiments. Depending on environmental conditions, such systems may have a replacement lifecycle of five to seven years, and therefore hardware itself can be expected to fail or require replacement several times during an individual's lifetime. Additionally, improvements in networking technology, physical disk capacity, hardware security, or processor capabilities naturally lead to demand for generational upgrade of systems over time. Durability of the individual's data and continuity of their experience in the presence of these replacement lifecycle conditions therefore requires robust design of the DLS software, its upgrade, maintenance, and configuration management mechanisms.

The operational support services (OSS) are designed to meet the long term robustness, continuity, privacy, and lifecycle maintenance requirements for adoption and use of DLS systems by individuals in large scale deployments.

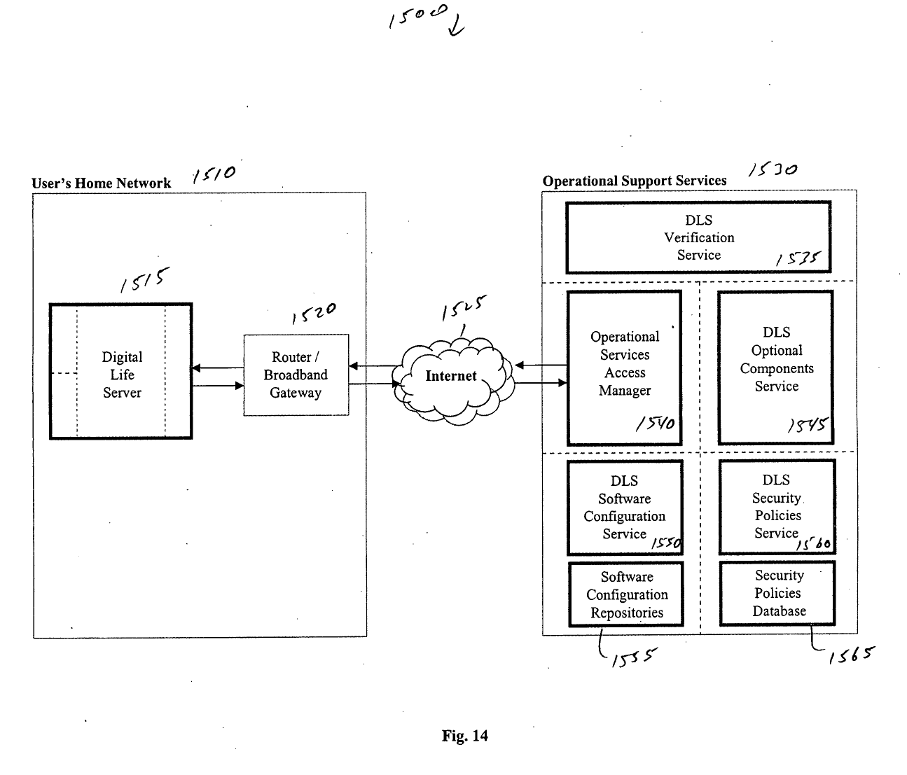

Referring to FIG. 14, DLS systems interact with OSS systems over standard internet IP infrastructure using W3C and IETF application protocols. All communications between a DLS and its associated OSS are over a protected transport session, which in an embodiment is based on the IETF TLS protocol with mutual authentication. OSS application services optionally utilize either W3C SOAP and WSDL web services protocols, or a combination of HTTP and structured XML messages in the representational state transfer (REST) programming style, for example.

System 1500 of FIG. 14 illustrates the OSS 1530 and its various components as related to a home network 1510 and DLS 1515. OSS 1530 includes a DLS verification service 1535, OSAM (Operational services access manager) 1540, DLS optional components service 1545, DLS software configuration module 1550 and configuration repository 1555, and a DLS security policy service 1560 and security policy repository 1565. The OSAM 1540 may communicate over the internet 1525 and through a router 1520 with the DLS 1515. DLS verification 1535 may verify authenticity of certificates and related transactions. DLS 1515 may be provisioned or updated in part through use of DLS software configuration module 1550 and DLS security policies service 1560, accessing related data from repositories 1555 and 1565, respectively. Other services may be provided through DLS optional components service 1545. Further discussion of these type of components as they may be implemented in some embodiments follows below.

Communication between the DLS and an OSS site are managed by the OSS operational services access manager. The operational services access manager verifies the secure transport session mutual authentication and then connects the DLS system to the requested OSS service.

Services provided by the OSS include:
the DLS Software Configuration Service, which is responsible for managing and labeling approved software configurations for distribution to DLS systems, and for answering requests from a verified DLS system for software matching a specified configuration label;
the DLS Security Policies Service, which is functionally responsible for developing and distributing security policy updates to the DLS population;
the DLS Optional Components Service, which is responsible for managing and publishing information about authorized optional or feature components for DLS systems, and for delivering them in response to requests from DLS systems; and
the DLS Verification Service, which is responsible for detecting anomalies in the behavior of systems in the DLS population and existence of possible bad participants.

The DLS verification service works in conjunction with the OSS operational services access manager to develop and maintain reputation statistics for known DLS devices in the supported population. The DLS verification service requires no information about accounts, identities, and/or any associated cryptographic credentials or keys for any given DLS system, and thus is designed to provide strong privacy assurance for users of the system.

The DLS verification process operates by building a reputation for each known DLS system based on its access patterns with the verification service's operational services access manager. DLS systems access their configured OSS periodically as they transact for updates, policies, and new configurations, and importantly, they do this every time they are restarted. Over time, it should strongly be the case that DLS systems exhibit uniform access patterns due to the relatively fixed nature of how they are deployed, thus making it possible to statistically detect anomalies in behavior that could provide early indication of a possible problem, including:
theft of a DLS device as evidenced by changes in the IP address or OSS access pattern;
compromise of the device due to abnormal access patterns with the OSS; and
potential malfunction of the device due to abnormal access patterns with the OSS.

The verification service utilizes the collected statistical information to maintain a record, or reputation, of known stable and well-behaving DLS systems. The reputation must be maintained by the verification service as a highly efficient structure both to store and evaluate. In an embodiment, the reputation is a vector of hashes computed over data easily obtained from the DLS IP transport stream connection as reported by the OSS operational services access manager. This is referred to as the “basis data.” Reputation vectors of basis data hashes may themselves then be hashed, to compress known good vector sequences for a given time periods, thus providing the means for allowing historical good behavior to be checkpointed efficiently in a compact structure supporting efficient trend analysis.

The reputation for each DLS device is correlated with it nominally based on the device's MAC address as openly communicated and trivially observed in common IP traffic. Trusted boot functions of the DLS device make it particularly difficult for the MAC to be altered without causing the device to fail, thus providing confidence in this most basic information as an always in the clear identifier for each unique device. This confidence is further reinforced using mutual authentication of the protected transport session as a means to reduce potential attacks on the communications channel. It is explicitly not necessary for the verification service to obtain account or personally identifying information in order for the system to work.

As a separate business service, the OSS may offer a risk prevention or anti-theft service to DLS owners, offering them the opportunity to register for notification if anomalies are detected on their device by the OSS verification service. If an owner decides to participate in the service, they opt-in by associating their DLS with their contact information using the MAC address of the device. The optional opt-in business service allows the owner to be contacted in the event that abnormal behavior is detected from the registered device.

Regardless of whether owners opt-in for an optional verification and reporting business service, reputation statistics for anonymous and unregistered systems still provide important telemetry for threat and vulnerability monitoring in support of the OSS security policies and emergency response services.

The DLS security policies service is supported by threat and vulnerability monitoring business activities conducted by the operator of the OSS. Consistent with DLS privacy guarantees, threat and vulnerability monitoring operates by using a combination of anonymous data from the DLS verification service, environmental monitoring for detection of efforts to attack or disrupt operation of the DLS population at large, and vulnerability analysis based tracking of implementation or logic defects in the DLS software base. Some of these functions are provided by business resources of the OSS, whereas others such as statistical trend analysis is automated. Collectively, the threat monitoring and closely related vulnerabilities analysis can lead to software configuration updates. However, some threats may be able to be countered without resorting to deployment of new software and can be addressed by successfully updating configurable DLS policies, for example by forcing a change in the duration of credentials, configuration of cryptographic routines, or other locally-enforced DLS operating system and runtime policies. In such cases, policy updates can be pushed to DLS systems using the DLS security and policies service.

The DLS software configuration service supports automated distribution of software updates and configuration labels. The service pushes notifications of available configuration updates to the OSS' DLS population and supports retrieval/distribution using proven techniques understood by practitioners skilled in the art. The service additionally supports requests for labeled configurations from verified DLS systems with good reputations. Requests by a DLS device for components from an historical, labeled configuration may, for example, occur in the event that an older version of a component is required in order to process data from an epoch that has a dependency on an earlier version of a DLS application. Verification of the requesting device's reputation is an automated risk management behavior of the system designed to minimize arbitrary probing of historical system software for reverse engineering efforts by rogue or malicious parties.

The DLS optional components service is similar to the DLS software configuration service in that it provides a means for delivering authorized software to verified DLS devices. The optional components service is distinguished by the fact that its offerings are not included as mandatory components in labeled system configurations managed by the software configuration service. The OSS may offer access to the optional components services as a separate business feature.

Online Preservation Service

In some embodiments, the online preservation service (OPS) provides the distributed services interface to online mass storage for preservation of DLS users' data sets. In an embodiment, the DLS is operated with a configured OPS service. Distributed OPS systems provide functionality including:
OPS account authentication;
preservation services including transaction authorization and session management;
management and administration of per-account policies; and
management and administration of mass storage system policies.

There can be multiple OPS service instances and they can be operated by a variety of different commercial operators/providers.

Functionality of the OPS services as presented to the DLS are discussed in detail in the earlier portion of this specification that describes DLS preservation functions.

As an additional topic to those services of the OPS as previously described, it is desirable to allow for parties who choose at some point to withdraw from the DLS, OSS, OPS environment to extract their data assets from the system in a usable form without any ongoing reliance on the system infrastructure. Business policies for withdrawing from the system are established by OSS and OPS entities. Nominally, a request is made to the OSS service in order to provision the application tools for the user to automate history navigation over the period recorded in the their OPS account, and to export the data in a set of well-defined structures. The automated process uses functionality of the preservation engine, history manager, trust manager, and OPS services as previously described in conjunction with the preservation service read flow sequence; see also FIG. 13. File-based application content such as documents, photos, video content, etc., entail no remarkable processing except to copy the original data from the object store to the target export file system.

By way of further explanation, FIG. 13 is a schematic diagram illustrating the protocol data flows and relationships for reading preservation arcdata to the DLS server appliance from an OPS system in an embodiment. Data flows between a user client 1405, a DLS 1410, a router 1415, a preservation engine access manager 1420 and storage subsystems 1425 within a preservation system 1400. Initially, a DLS 1410 determines that data in a client read/request 1430 is not currently available. DLS 1410 then requests read access 1435 from the preservation engine 1420. Preservation engine 1420 makes a read reservation 1440 and receives a read confirmation 1445 from storage subsystem 1425. The read request 1435 is then confirmed 1450 to DLS 1410.

DLS 1410 then reads 1455 from storage subsystem 1425 and receives a read response 1460. This response 1460 is relayed as a client response 1465, and a further read 1470 may occur. A corresponding response 1475 is received and relayed as a client response 1480. Read complete 1485 is signaled to storage subsystem 1425 and preservation engine 1420, and a reservation release 1490 is transmitted to storage subsystem 1425. A final client response 1495 is also transmitted to client 1405 to indicate the read process is complete.

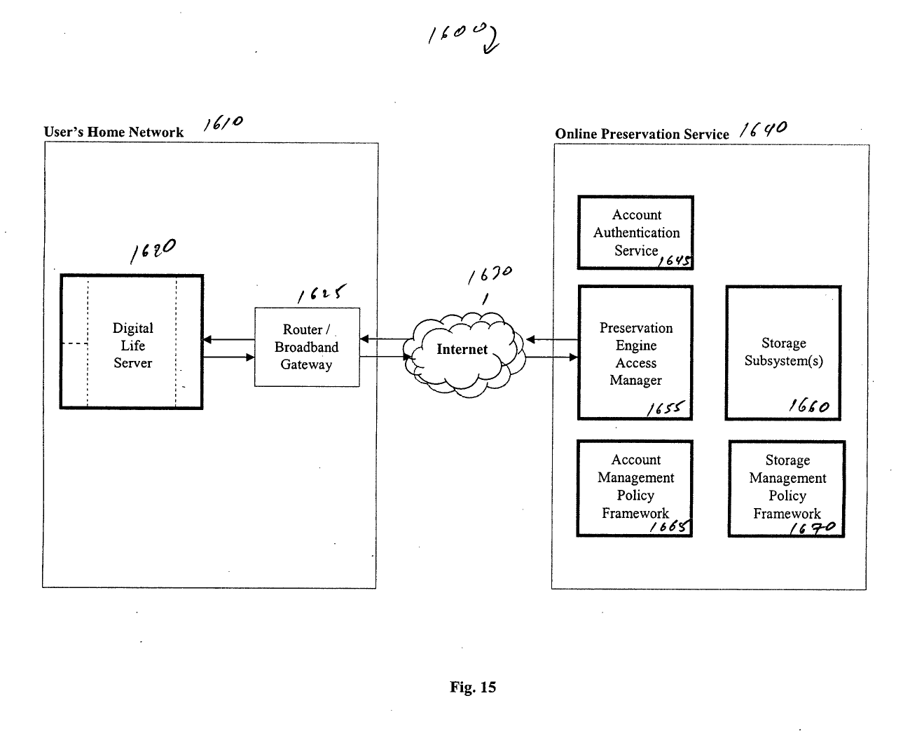

The actual OPS may be further understood with reference to FIG. 15. FIG. 15 is a schematic diagram illustrating the logical components of an online preservation service (OPS) system and the relationship with a DLS server appliance in an embodiment. System 1600 includes a home network 1610 with a DLS 1620 and a router 1625. Also included is an OPS (online preservation service) 1640 which is coupled through the internet 1630 to network 1610. OPS 1640 includes an account authentication service 1645, a preservation engine access manager 1655, a storage subsystem 1660, an account management policy framework 1665 and a storage management policy framework 1670. Preservation engine 1655 may communicate or interface with the internet 1630. Authentication service 1645 may authenticate transactions. Frameworks 1665 and 1670 may provide rules to determine how data is stored and how accounts may access data (and thus how users may access or store data).

The following provides a specific set of applications and related software which may be used with various DLS implementations and embodiments. This description is intended to be illustrative, providing an example of how the system may be implemented with a software and user interface. Alternative implementations or embodiments may be used to provide similar functionality or different functionality presented to a user which takes advantage of the capabilities and features of a DLS.

Semantic History Navigator Application

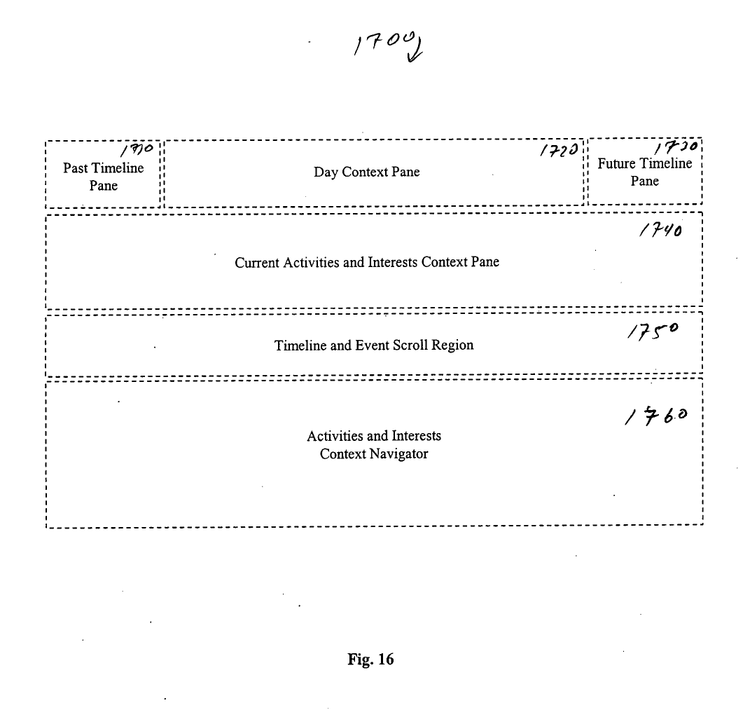

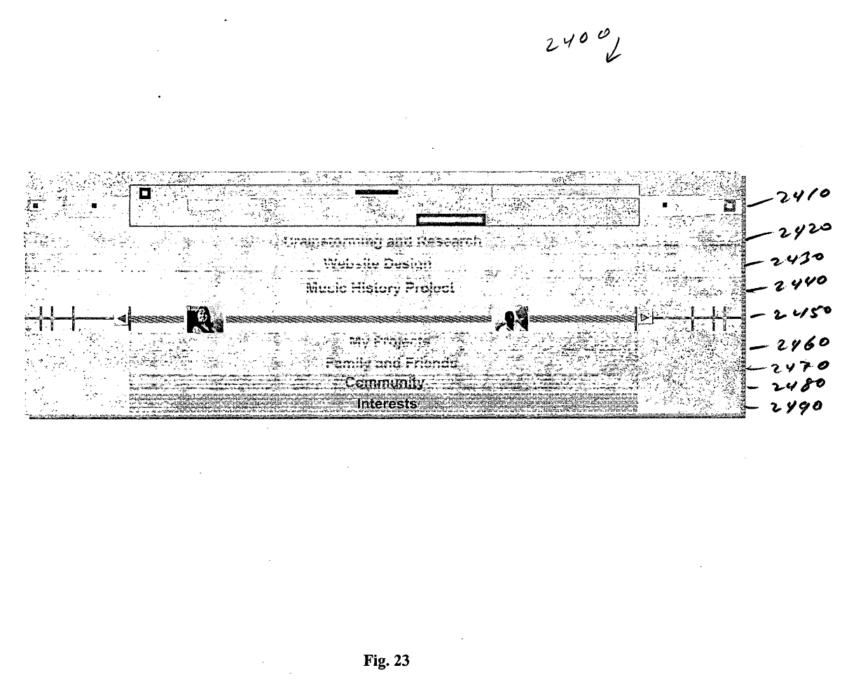

In an embodiment, the Semantic History Navigator (SHN) is implemented using the Web Applications Framework, the Dynamic Web Interaction Framework, and other DLS subsystems as a client-server web application. FIG. 16 provides a schematic view of the SHN application components in their default organization for display as a web page; FIG. 23 provides a graphical illustration of how the same components might appear when rendered on a web browser.

The SHN client-server application provides an interactive interface for quickly visualizing and navigating the organization and history of an individual's information assets as managed by the DLS. In more detail, the SHN application provides a browser-based web interface for interaction with remote DLS services in the form of a distributed client-server application using standard web (e.g. HTTP, SOAP) protocols. In such an embodiment, client side application functionality and interactivity is provided in part through script code (e.g. Javascript, ECMAscript) uploaded to the browser using services of the Dynamic Web Interaction Framework (as previously explained); functionality is also provided by standard W3C CSS stylesheets, and may use other resources including GIF and JPEG image files. The browser client script code is hereafter referred to as the “SHN Client.” In the case of this embodiment, server side functionality is provided by the Web Application Framework in the form of a standard Java JSR 154 Servlet. The DLS Web Application Framework servlet for the SHN application is hereafter referred to as the “SHN Servlet.” Communication between the SHN Client and SHN Servlet is conducted using a set of application-specific XML messages over the standard XMLHttpRequest protocol request/callback pattern.

Referring to FIG. 16, the SHN application includes six components, or “panes,” which in their default configuration are organized in four rows as follows:
the top row includes three panes which provide feedback on events, activities, and interests that intersect the current day (the middle pane, or “Day Context View”), the recent past (the left pane, or “Past Timeline Pane”), and the near-term future (the right pane, or “Future Timeline Pane”); information in this set of panes is derived from event data and prioritized activities or interests across all of the individual's Contexts;
the second row is named the “Current Activities and Interests Context Pane,” or more simply, the “Current Context Pane;” this component/pane provides visualization of activities and interests in the current Context as timelines centered to the current day;
the third row is named the “Timeline and Event Scroll Region;” this component/pane provides controls and visualization for temporal navigation forwards and backwards across the individual's recorded history; and
the fourth and bottom row is named the “Activities and Interests Context Navigator,” or more simply, the “Context Navigator;” this component/pane provides a tabular list of the individual's Contexts.

FIG. 16 may be further understood with reference to its various components. Interface 1700 provides past, present and future timeline information, along with current activities, a timeline scroll region, and an activities and interests navigator. Past timeline pane 1710 and future timeline pane 1730 provide indications of events chronologically near the present. Day context pane 1720 provides information about the present day. Current activities and interests context pane 1740 provides information about current activities and interests—thus providing context to the specific day in terms of scheduling and current projects. Timeline scroll region 1750 provides an area where a user may scroll along a timeline to view recent history or upcoming events. Activities and interests navigator 1760 allows a user to move to specific information about an activity or interest of the user, and may adapt to some degree based on the current date and time and based on events as they happen.

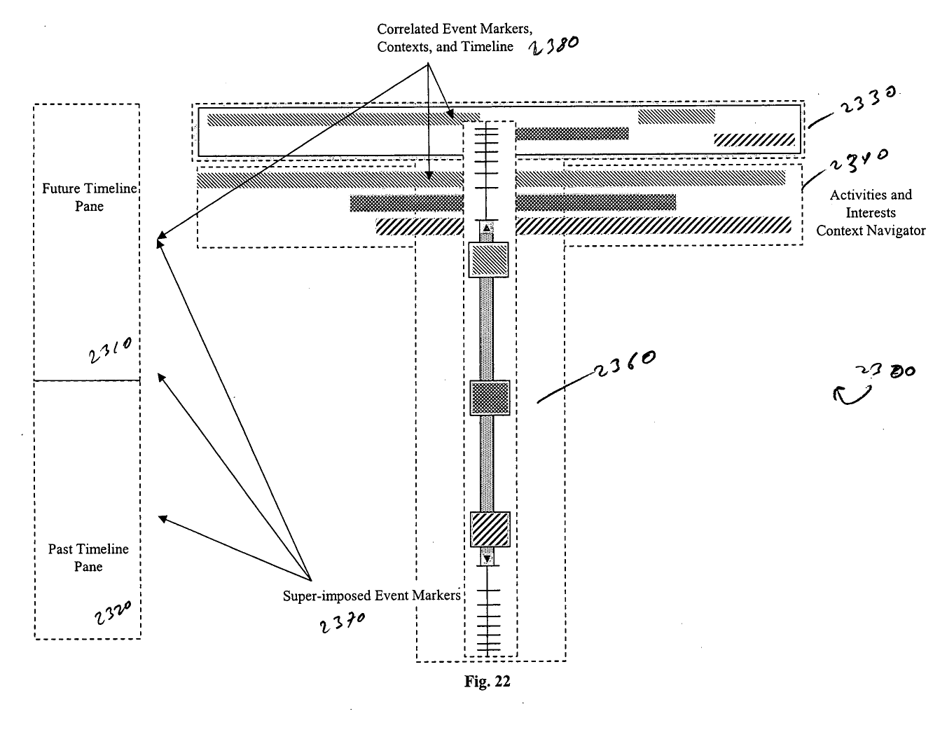

As illustrated in FIG. 22, the horizontal row-ordered layout of FIG. 16 represents only one example of how to arrange the SHN application components/panes. The components can be individually addressed through their styles information and accordingly rearranged for different page layouts. One desirable technique for rearranging the SHN components/panes is through use of W3C Cascading Style Sheet (CSS) settings. Regardless of changes to their style information or layout arrangement, the SHN components maintain and exhibit consistent behavior as provided by the SHN Client and SHN Servlet application.

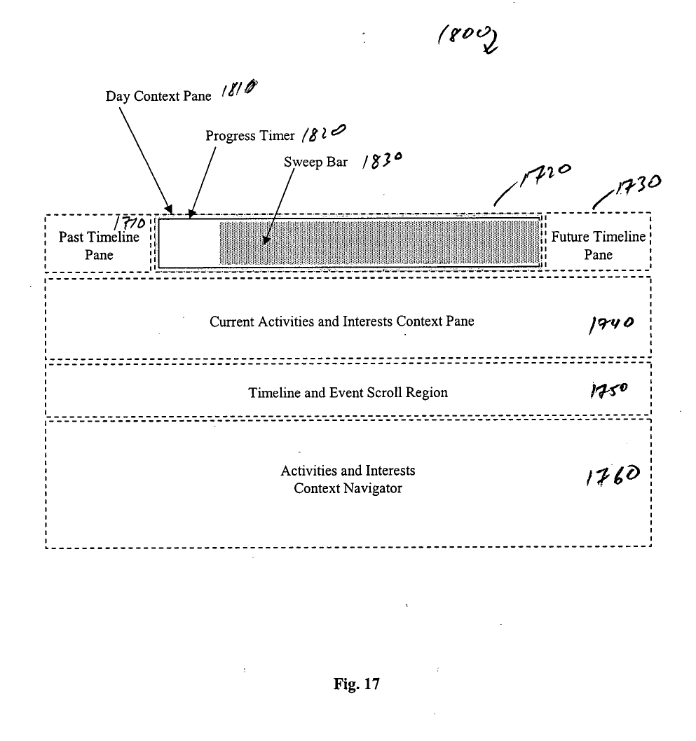

Continuing in more detail with FIG. 17, the Day Context Pane provides feedback to the user about the passage of time through the current day. Elapsed time is indicated by periodically changing the background color of the Day Context Pane through the motion of a graphical “Sweep Bar.” In one configuration, the day time progresses from left to right, although this can be changed through individual user preferences maintained by the DLS to progress from right to left. Movement action of the sweep bar is relative to the duration of the “day” begin/start times as set by individual user preferences maintained by the DLS. Execution of the sweep action is effected by application script code in the client browser; settings are retrieved from the DLS Servlet

FIG. 17 further illustrates how a day context pane may be implemented. Day context pane 1720 is implemented using a sweep bar 1830 as part of a progress timer 1820. Thus, progress timer 1820 can show how much of a day has passed, and how much is to come. Alternatively, progress timer 1820 may be set to show how much of a days tasks have been checked off as accomplished, for example. Sweep bar 1830 can then show a remaining part of a day or of tasks to be completed, for example.

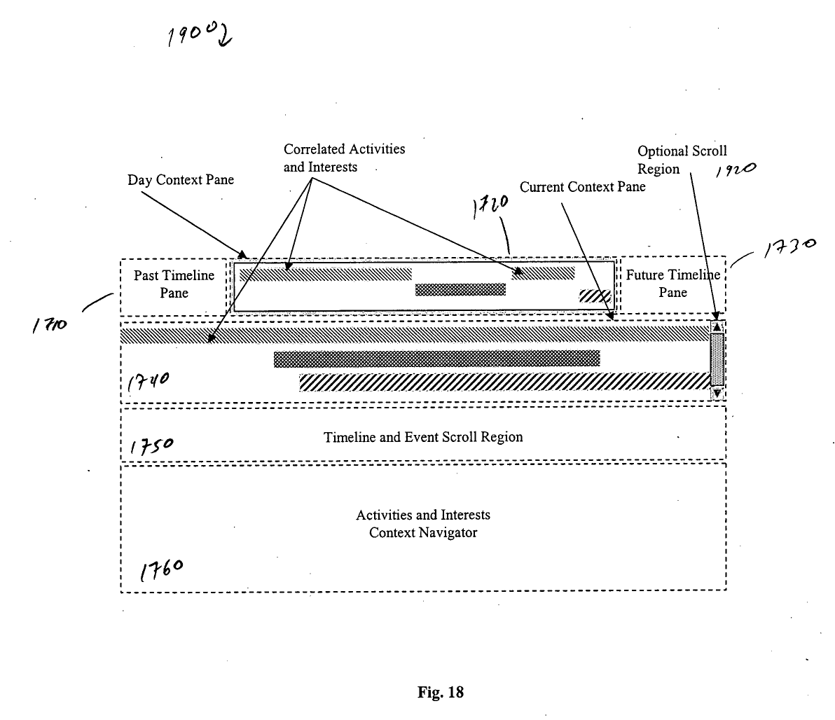

Visualization of activities and interests relative to the current day and their correlated representation in the Day Context Pane and Current Context Pane is illustrated in FIG. 18. As will be seen throughout this and all subsequent descriptions of the SHN application, and in subsequent descriptions of the Personal Semantic Workspace (PSW) application, DLS semantic applications can support correlating and maintaining information state relative to a selected Context even across loosely-coupled components. FIG. 18 illustrates how, relative to the current Context, three different activities or interests map onto the Current Context Pane and how events associated with them map into the Day Context Pane.

In more detail, the Current Context Pane provides a single day view and is always centered to display elements from the current Content that intersect with the current day, which in the case of this example consists of three activities or interests (recall from preceding discussion that in this context, activities have a fixed start and completion date/time, whereas interests are ongoing and have no beginning or ending date/time). The current day is set by the movement in the Timeline and Event Scroll Region component/pane, and so moving either forward or backward in time using the scroll region changes the current day and updates the component/panes accordingly. Timeline scroll region movements also update the SHN Servlet through XMLHttpRequest/callback protocol messages invoked by the SHN client, thus causing the SHN Servlet to set the corresponding attribute for the “current day” on the DLS side of the application as well. Time navigation also causes the SHN Client to request updates from the SHN Servlet for the minimal and necessary set of information required to update and maintain correlation between visualizations in the components/panes, thus providing the information to populate events in the Day Context Pane, and the Current Context Pane, as illustrated in FIG. 18.

FIG. 18 may be further understood with reference to its components. The interface 1900 derives from the interface 1700 of FIG. 16, providing a specific day context pane 1720 in some embodiments. Day context pane 1720 includes regions corresponding to activities and interests. Thus, activities and interests regions 1910 correlate to activities and interests displayed in activities and interests pane 1740, providing a graphical representation of when activities or interests are scheduled during the present day. This may be based on a combination of rules for scheduling and specifically scheduled events, for example. Thus, a certain interest may always be given unscheduled hours during a day, or a minimum number of hours per day, which are fit in between appointments, for example.

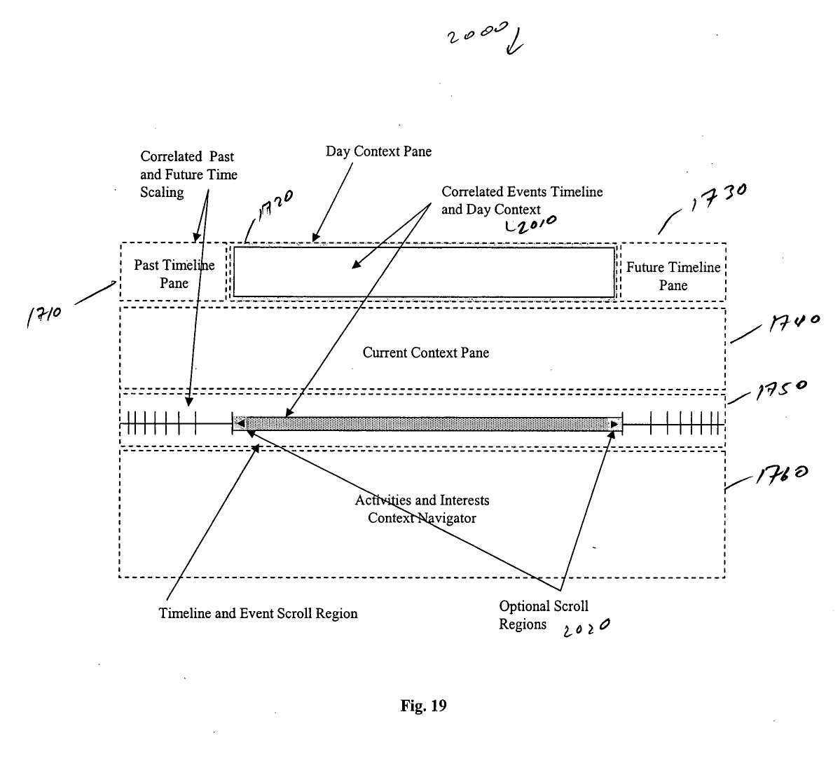

FIG. 19 illustrates the timeline navigation behaviors just discussed, and additionally illustrates that movement either backward or forward in time also updates the Past Timeline and Future Timeline components/panes. Thus, day context pane 1720 may include correlated events 2010 which correlate to scrolling of a scroll bar 2020 in timeline scroll region 1750. Similarly, past timeline pane 1710 and future timeline pane 1730 may update to reflect the past and future with respect to a date scrolled to in scroll region 1740.

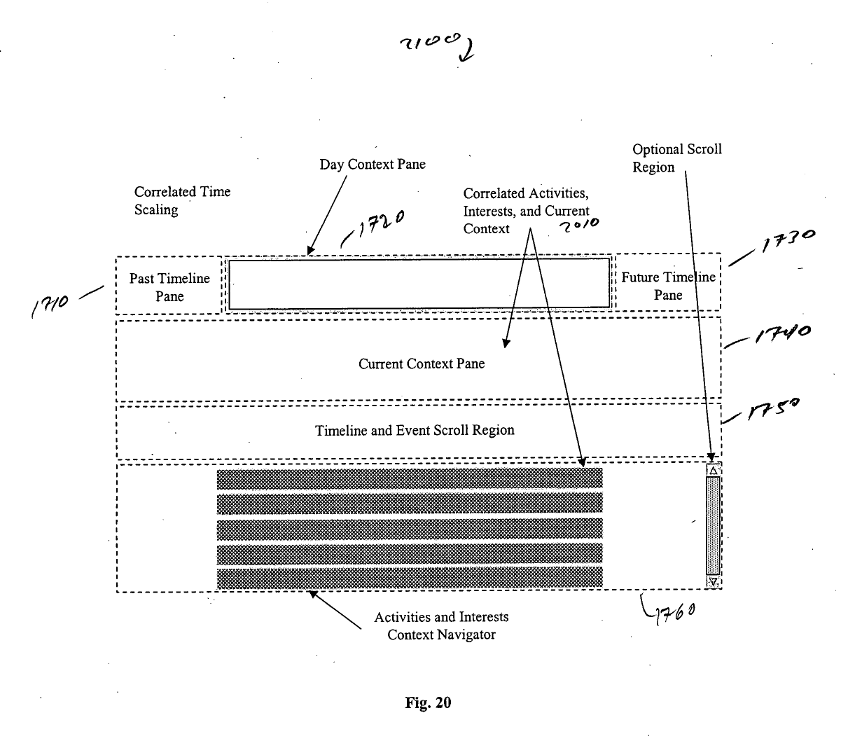

As previously mentioned, in some embodiments, changes to the selected Context result in correlated updates to data in other components/panes. FIG. 20 illustrates that selection of different Contexts in the Context Navigator component/pane result in correlated changes to data displayed in the Current Content and Day Context components/panes. As previously described, selections at the local browser client are handled by the SHN Client script. The SHN Client is programmed to determine what if any changes it can handle using local cached data, and as required uses the XMLHttpRequest/callback protocol message pattern to both update the SHN Servlet and to request updates from it.

FIG. 20 further illustrates in user interface 2100 how activities and interests 2010 may also be correlated between a current context pane 1740 and an activities and interests navigator 1760. Navigator 1760 allows for content access, and may transform to reflect changing interests or upcoming activities. Scrollbar 2020 allows for scrolling in the event that more activities and interests are available for navigation than space reasonably permits for display.

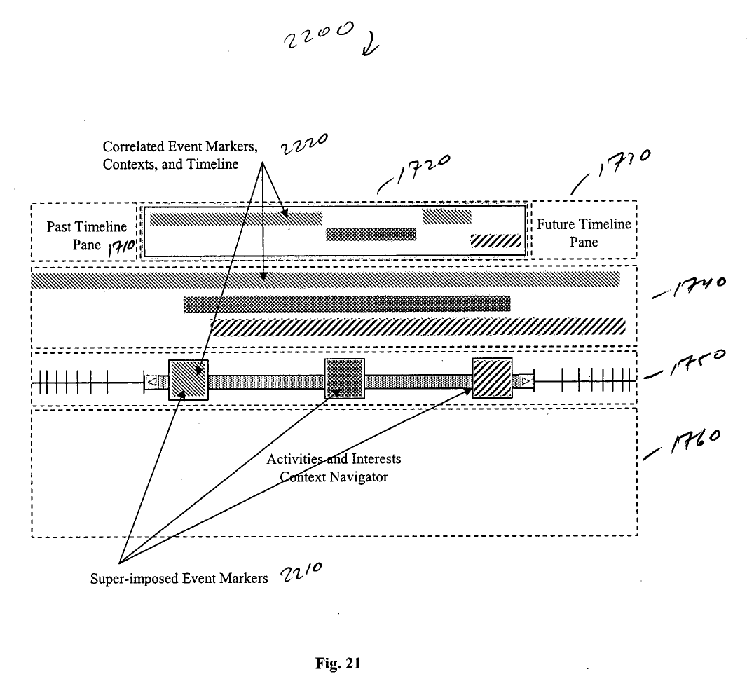

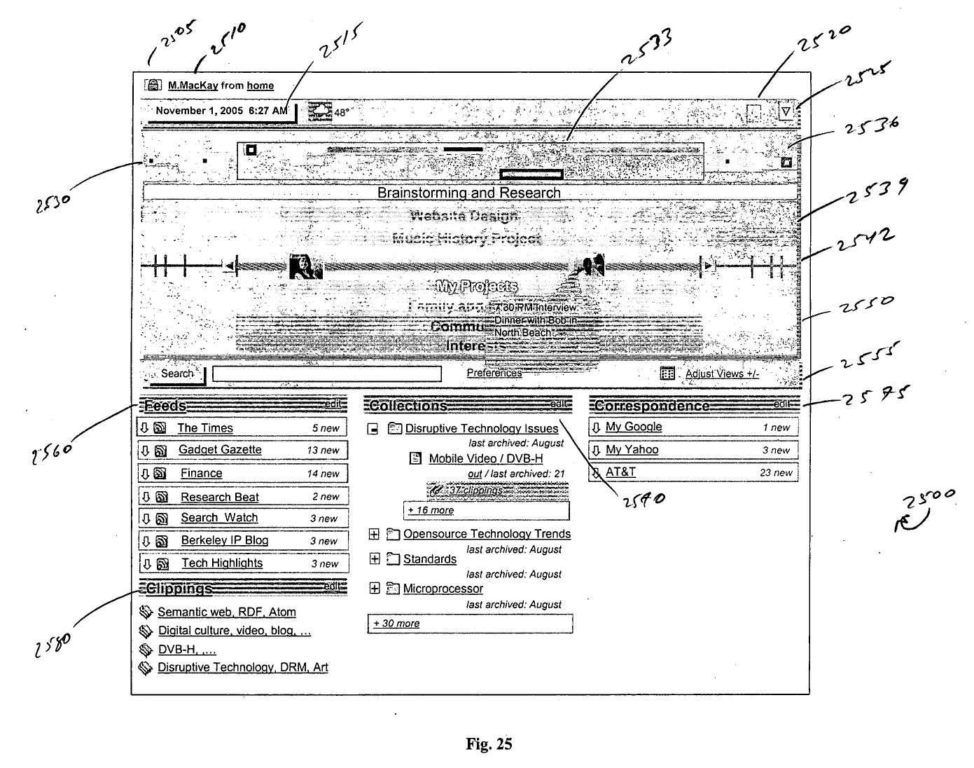

Continuing with FIG. 21, events are also correlated between the Day Context, Current Context, and Timeline and Event Scroll Region components/panes. Event data is retrieved in conjunction with activities, interests, and Context data from the SHN Servlet using the SHN Client-invoked XMLHttpRequest/callback pattern. As illustrated in FIG. 21, event data is handled by the Timeline and Event Scroll Region component/pane as a special type of SHN Client application feature called Event Markers. A graphical example of Event Markers is illustrated in FIG. 23. Event Markers are potenitally a dense representation for event information composed by the SHN Client to provide quick reference to all the data associated with an event. As further illustrated in FIG. 25, Event Markers use local script programming techniques to provide detail information associated with an event using “roll-over” and “information bubble” techniques. Techniques for creating roll-over and “information bubble” effects using Javascript or ECMAscript programming are well understood by practitioners skilled in the art.

FIG. 21 further illustrates interrelationships between panes in user interface 2200, with super-imposed event markers 2210 on the scroll region 1750 corresponding to event markers 2220 of the present day context 1720 and activities and interests context 1740. Alternatively, a different user interface may be implemented. FIGS. 23 and 24 provide an illustration of an alternative embodiment of a user interface. FIG. 22 illustrates user interface 2300. Included are past and future timeline panes, a present context pane, an activities and interests context pane and a timeline/scroll pane.

Past timeline pane 2320 and future timeline pane 2310 provide information about past and future events. Present context pane 2330 provides information about a current day, including activities and interests as scheduled. Context information for such activities and interests is provided in activities and interests context pane 2340. Timeline/scroll region 2360 provides a scroll-bar like timeline correlated to the data of panes 2330 and 2340. Markers within each of the panes of interface 2300 are also correlated, such as event markers 2370 and related markers 2380 in panes 2330 and 2340.

FIG. 23 illustrates another embodiment of a user interface 2400. Pane 2410 provides day context information. Activities and interests are illustrated as first activity 2420, second activity 2430 and third activity 2440. Scroll region and timeline 2450 provides a timeline display of correlated activities and interests. Content navigators are also provided. Thus, a first content navigator 2460 displays data on projects, a second content navigator 2470 displays data on family and friends. A third content navigator 2480 displays data on community information and a fourth content navigator 2490 displays data on interests.

Finally, throughout all the described SHN Client and SHN Servlet interactions, it is important to restate that all event, activities, interests, and Context data is derived by the SHN Servlet through use of programming interfaces provided by the Collections Manager, the History Manager, and the Context Manager using functionality as previously described.

Personal Semantic Workspace Application

An embodiment of the Personal Semantic Workspace (PSW) is implemented in an embodiment of an overall system using the Web Applications Framework, the Dynamic Web Interaction Framework, and other DLS subsystems as a client-server web application. FIG. 24 provides a schematic view of the PSW components in their default organization for display as a web page; FIG. 25 provides a graphical illustration of how the same components might appear when rendered on a web browser.

The PSW client-server application provides an interactive interface for using the Semantic History Navigator (SHN) in conjunction with a set of content-specific “panes” or contextual information “facets” for visualizing, creating, editing, storing, and generally manipulating information assets as managed by the DLS. In more detail, the PSW application provides a browser-based web interface for interaction with remote DLS services in the form of a distributed client-server application using standard web (e.g. HTTP, SOAP) protocols. Client side application functionality and interactivity are provided in part through script code (e.g. Javascript, ECMAscript) uploaded to the browser using services of the Dynamic Web Interaction Framework (as previously explained); functionality is also provided by standard W3C CSS stylesheets, and possibly other resources including GIF and JPEG image files. The browser client script code is hereafter referred to as the “PSW Client.” In the case of this embodiment, server side functionality is provided by the Web Application Framework in the form a standard Java JSR 154 Servlet. The DLS Web Application Framework servlet for the PSW application is hereafter referred to as the “PSW Servlet.” Communication between the PSW Client and PSW Servlet is conducted using a set of application-specific XML messages over the standard XMLHttpRequest protocol request/callback pattern.

Referring to FIG. 24, the PSW application incorporates the whole of the Semantic History Navigator (SHN) application, and additionally includes:
a “DLS Anchor Pane” component/pane, as illustrated at the top of the diagram; the DLS Anchor Pane provides feedback on the individual's account identity and feedback indicators for security status of the application session (redundant to the HTTP browser application's SSL “lock” indication as an additional security measure maintained by the PSW Client and PSW Server), and links for quick access to the individual's preferences;
a “Contextual Recall Pane” component/pane as illustrated in the middle of the diagram; the Contextual Recall Pane provides an interface for invoking Context and history-sensitive search over Collections and/or SPF RDF Facts associated with the current Context using functionality provided by the PSW Servlet; and
six types of optional “Contextual Panes,” as illustrated in the lower half of the diagram.

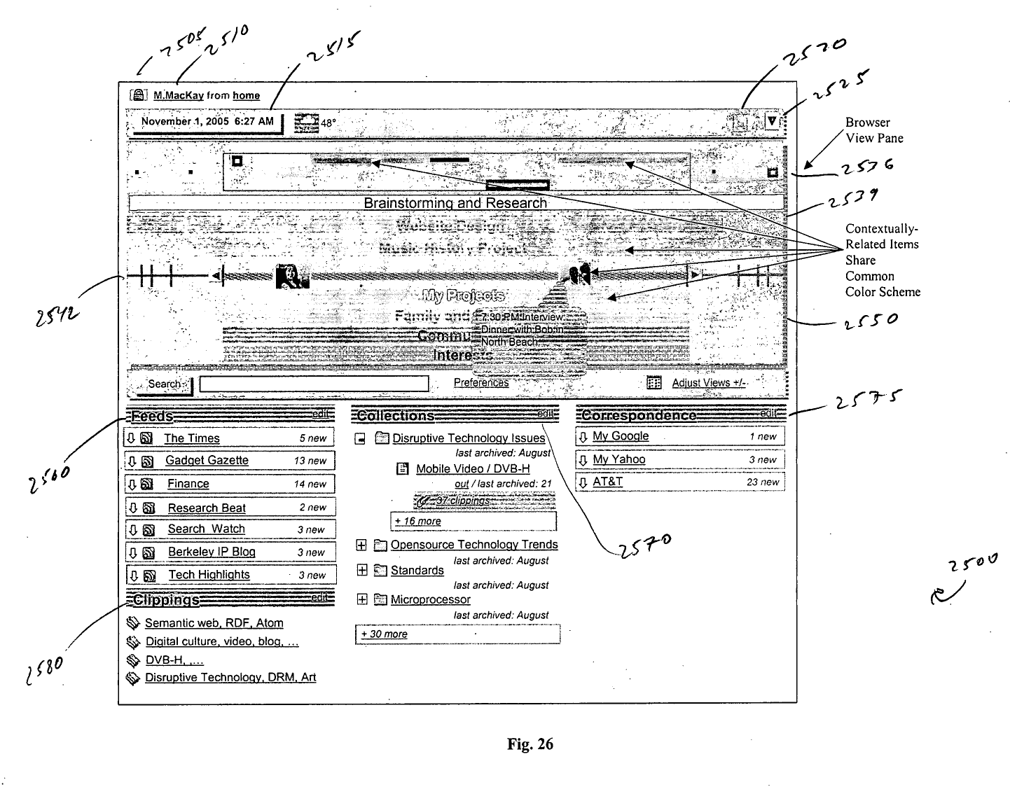

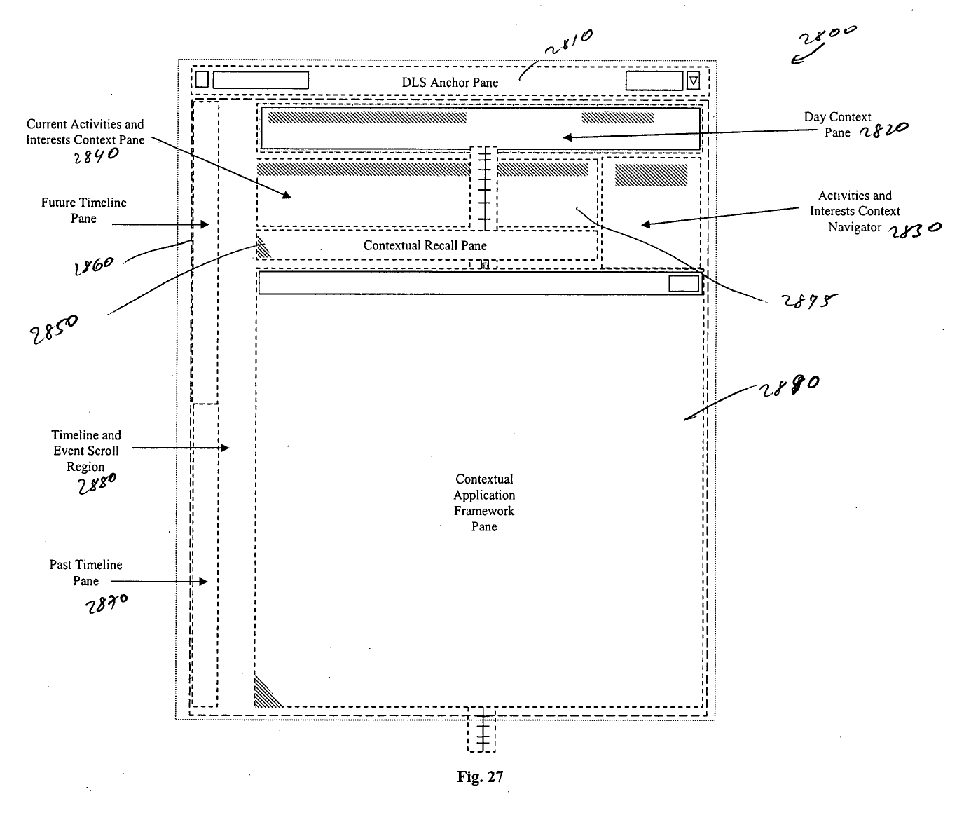

FIGS. 25, 26 and 27 may be further understood with reference to various components. FIG. 24 illustrates user interface 2500 in a browser 2539 in block diagram form. FIGS. 26 and 27 provide alternate illustrations of user interface 2500.

An anchor pane 2515 is provided with a status indicator 2505 and an identity indicator 2510, along with additional status/session indicators 2520 and a preferences link 2525. Timeline panes include past (2530), present (2528) and future (2536). Activities and interests context panes 2533 and 2550 are also provided, along with a context recall pane 2555. Scrollbar 2545 is provided as part of timeline 2542. Individual content panes 2560, 2570, 2575, 2580, 2585 and 2590 provide content navigation for activities and interests, and each may be provided with a preference control 2566 and a pane title 2563.

As illustrated in FIG. 27, the layout of FIG. 24 represents only one example of how to arrange the PSW application components/panes. The components can be individually addressed through their styles information and accordingly rearranged for different page layouts. One desirable technique for rearranging the PSW components/panes is through use of W3C Cascading Style Sheet (CSS) settings. Regardless of changes to their style information or layout arrangement, the PSW and incorporated SHN components maintain and exhibit consistent behavior as provided by the SHN Client and SHN Servlet, and PSW Client and PSW Servlet applications.

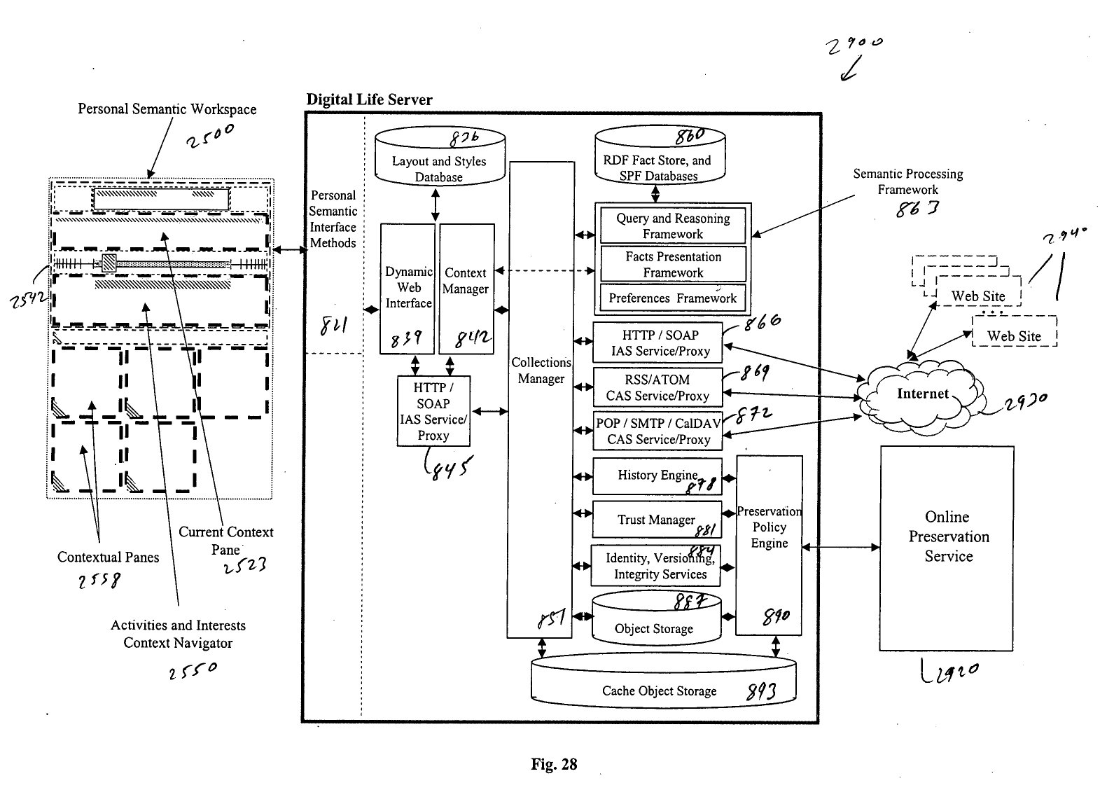

In more detail, the SHN application is incorporated in whole by the PSW application and functions as previously described. Significant efficiencies accrue from this technique, in particular because the same behaviors result in selection of Contexts, temporal navigation, and data correlation apply and operate consistently throughout the rest of the PSW components/panes as previously described for the SHN components/panes. Referring to FIG. 28, SHN functions for Context selection update both the SHN components as well as the PSW Contextual components/panes.

As previously introduced in the description of the SHN, Context selections are first processed locally by the SHN Client, and in the case of the PSW application, the PSW Client. If the updates can be handled from locally cached data, the updates occur completely within the local browser environment, otherwise the PSW Client uses the XMLHttpRequest/callback message protocol sequence to update the PSW Servlet and retrieve the data required for the required updates. As further illustrated in FIG. 28, the PSW Servlet uses the functions of the DLS including the Context Manager, the Collections Manager, the History Manager, Semantic Processing Framework functionality in particular including the Fact Presentation Framework, and may potentially invoke remote communications with other services using IAS and CAS service agents in order to satisfy the PSW Client request. All of the functioning by each of these DLS subsystem occurs as previously described, with emphasis on particularly important services provided by the Context Manager for configuration of shared context attributes across all of the DLS services, and Collections Manager abstractions for uniform treatment of all datatypes associated with a Collection.

In somewhat more detail, FIG. 28 illustrates an important aspect of how temporal navigation using the SHN Client's Timeline and Event Scroll Region component/pane can affect virtual storage management services provided by DLS' Preservation Engine and History Manager. In particular, recall from the previous description of the Preservation Engine that history navigation can lead to a condition that requires data from an Epoch that is no longer available on local DLS Object Storage. As illustrated in FIG. 28 and previously described, this condition can require the Preservation Engine to contact the Online Preservation Service in order to satisfy the request, in which case the Epoch is retrieved and required data is provided to the PSW Servlet, and then ultimately to the PSW client as quickly as it becomes available (see also FIG. 13).

FIGS. 27 and 28 may be further understood with reference to various components. FIG. 27 illustrates user interface 2800 in block diagram form. FIG. 28 provides illustrations of user interface 2800 interacting with a DLS.

An anchor pane 2810 is provided with a status and identity information. Timeline panes include past (2870) and future (2860), along with day context pane 2820. Activities and interests context panes 2840 and 2895 are also provided, along with a context recall pane 2850. An activities and interests context navigator 2830 is also included, as is a timeline and event region scrollbar 2880. Contextual application framework pane 2890 provides application support related to current activities and interests. In FIG. 28 it can be seen that a DLS of system 2900 allows for user interface 2800 to interact with internet 2930, OPS 2920 (described below) and web sites 2940, for example.

Referring again to FIG. 24, the PSW application may be configured with a set of “Contextual Panes.” Contextual Panes are effectively information “facets” composed from DLS data assets, primarily using services of the Collections Manager and the Facts Presentation Framework. Collections Panes may be implemented as effectively separate Servlets using the DLS Web Applications Framework, in which case the PSW Servlet composes data from each of the separate Collections Pane servlets into a coherent web page as illustrated in the PSW Application. As illustrated, there are six optional Collections Panes, including:
the Contextual Feeds component/pane, which organizes and presents summaries of syndicated RSS and IETF ATOM feeds associated with the current Context and Collection;
the Mail/Correspondence component/pane, which organizes and presents links to mail from potentially multiple accounts as filtered or selected to correspond with the current Context and Collection;
the Contextual Collections component/pane, which provides file-oriented browsing over Data Storage Objects (DSO) corresponding to the current Context and Collection;
the Contextual Clippings component/pane, which provides a list facet view of Memory Task application clippings corresponding to the current Context using results provided by the Fact Presentation Framework;
the Contextual Media Gallery component/view, which provides an image matrix or listing of multimedia content corresponding to the current Context and Collection; and
the Contextual Application Framework component/view, which provides a programming abstraction for integrating additional processing such as personal blog or wiki functionality with the PSW application and supporting DLS services.

Contextual Pane components receive and process Context and temporal settings just like all other SHN and PSW application components/panes. Contextual Pane components may incorporate additional client browser and Web Application Framework functionality using either XMLHttpRequest/callback protocol message patterns, or SOAP-based processing, depending on the sophistication and nature of their processing needs.

Finally, FIG. 25 provides a graphical example of the PSW application with a configured set of Contextual Panes, and FIG. 26 illustrates the use of color as a supported technique for correlating Context across data and panes.

Memory/Fact Collection Task Overlay Application

The Memory Task overlay application utilizes client-server style processing over standard W3C HTTP and related protocols between an individual's browser and the DLS to annotate and remember information valuable to the individual as part of their web browsing experience. FIGS. 29a-29d provide illustrations of the graphical interface; colors, fonts, and other styling characteristics may vary between implementations. The primary observations regarding the interface design are as follows:
the task user interface(s) and browser client application are provided by means of script code (e.g. Javascript, ECMAscript) injected inline with delivery of the target web page by the DLS in proxied HTTP response data; the result of the injected processing produces and interface similar to FIG. 30a;
execution of the application is represented to the browser client user through two modal interfaces: the Memory Task (e.g. FIG. 29a, FIG. 29b, and FIG. 30a), and the Fact Collection Task (FIG. 29c, FIG. 29d, and FIG. 30b); and
the client-server style of operation is conducted between the script code in the browser client and processing on the DLS using the standard XMLHttpRequest pattern.

A detailed functional description of the Memory/Fact Collection Task overlay application is described in the preceding section on the SPF Collection and Annotation Framework subsystem.

FIG. 29a illustrates a memory reminder dialog box 3110. FIG. 29b illustrates a memory overlay bar 3120, which provides controls allowing one to remember an item or associate an item with other data, for example, and to recall items. FIG. 29c provides a basic fact collection dialog box 3130, with keyword 3135, collection selection 3140 and type selection 3145 controls. FIG. 29d provides a similar fact collection dialog box 3150 with tabs for additional functionality. Box 3160 illustrates the info tab of box 3150, with language 3165, publication date 3170, found date 3175 and source data 3180 provided.

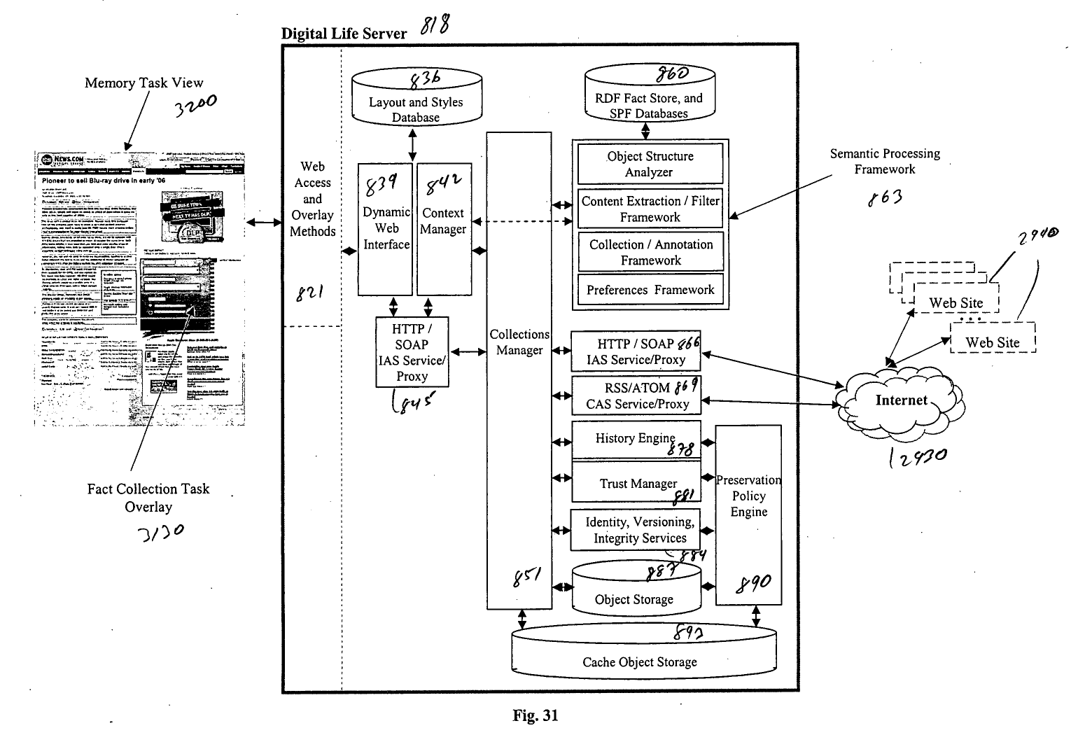

FIG. 30 illustrates uses of the boxes of FIG. 29. In FIG. 30a, browser 3200 shows webpage 3210. Remember box 3110 is overlaid, allowing a user to remember the webpage 3120. In FIG. 30b, the user has chosen to remember webpage 3210 and dialog box 3130 is displayed to allow a user to annotate webpage 3210 for archival and retrieval purposes. FIG. 31 illustrates interaction between the collection boxes of FIG. 29 and an embodiment of the DLS of FIG. 7. The DLS 818 has been previously described, as have the memory task view 3200 and the fact collection task overlay 3130. As is apparent, the data from the fact collection task overlay 3130 is transferred to DLS 818 through interface 824.

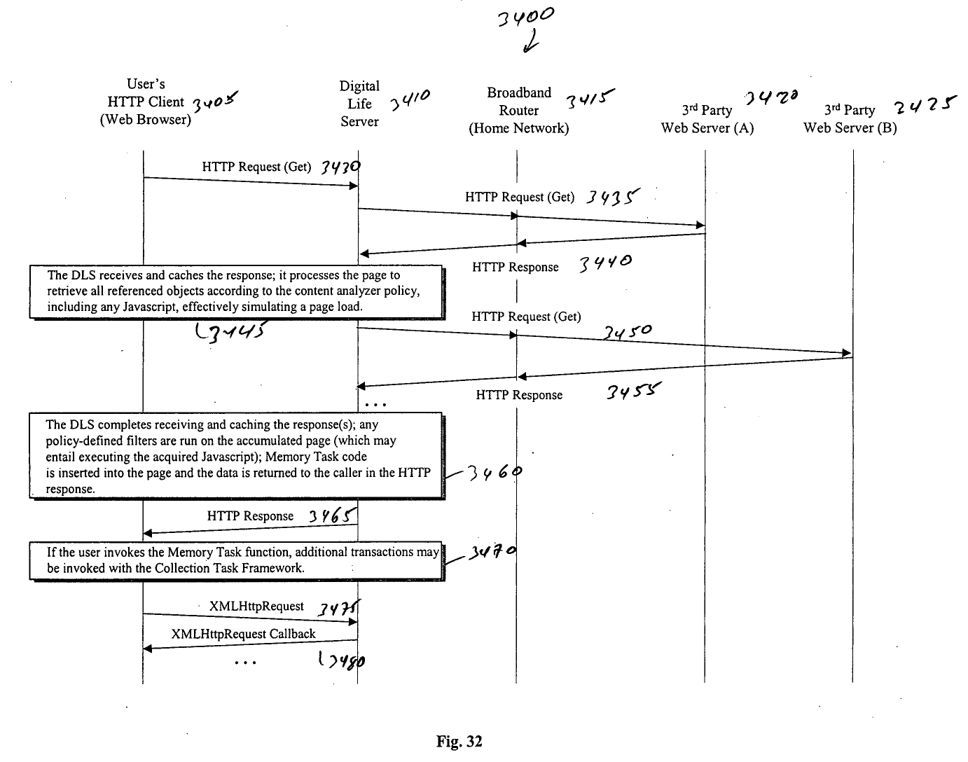

FIG. 32 is a schematic diagram illustrating the protocol data flows and relationships for processing and delivering a memory task overlay application from the DLS server appliance in an embodiment. Data flows between a user client 3405, a DLS 3410, a router 3415, a first third party web server 3420 and a second third party web server 3425 within a system 3400. Initially, data is requested 3430 by the client 3405 from the DLS 3410. This results in a request 3435 from DLS 3410 to a web server 3420 as DLS 3410 does not have all information needed to satisfy the request 3430. Response 3440 returns data to DLS 3410, where the data is processed 3445. If necessary, a request 3450 is sent to another web server 3425, and another response 3455 is received by DLS 3410. The DLS 3410 then processes 3460 the received data with memory information from the DLS 3410, and provides a response 3465. Response 3465 includes the data of responses 3440 and 3455, along with additional associated memory information from DLS 3410. If the user chooses to record the data of the webpage in some form of memory, memory recordation 3470 may be invoked with DLS 3410. Additionally, a request 3475 from client 3405 may come to DLS 3410 which may be serviced by DLS 3410, in which case the simple response 3480 with appropriate data from DLS 3410 is sent back to client 3405.

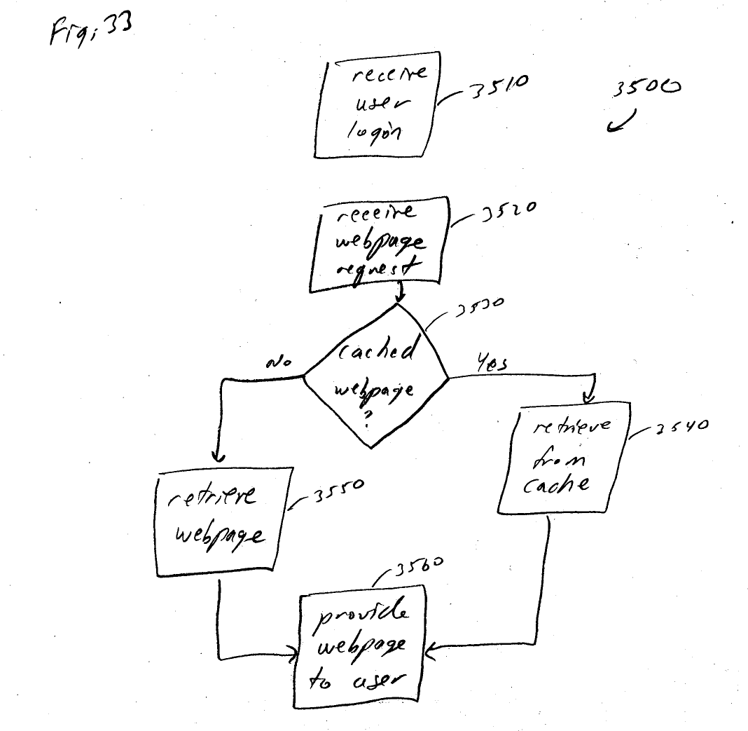

FIG. 33 is a flow diagram illustrating an embodiment of a webpage access process using a DLS. Process 3500 includes receiving a user logon, receiving a webpage request, determining if the webpage is cached, retrieving the webpage from the cache, or retrieving the webpage from the web, and displaying the webpage. Process 3500 and other processes of this document are implemented as a set of modules, which may be process modules or operations, software modules with associated functions or effects, hardware modules designed to fulfill the process operations, or some combination of the various types of modules, for example. The modules of process 3500 and other processes described herein may be rearranged, such as in a parallel or serial fashion, and may be reordered, combined, or subdivided in various embodiments.

Process 3500 initiates with receipt of a user logon at module 3510. At module 3520, a webpage request is received. At module 3530, a determination is made as to whether the webpage contents are cached in a local cache (such as in a DLS, for example). If so, then the webpage is retrieved from the cache at module 3540. If not, then the webpage is retrieved from the web via the internet at module 3550. The retrieved webpage is provided to a user (such as through a client) at module 3560, and the process may then repeat in whole or in part.

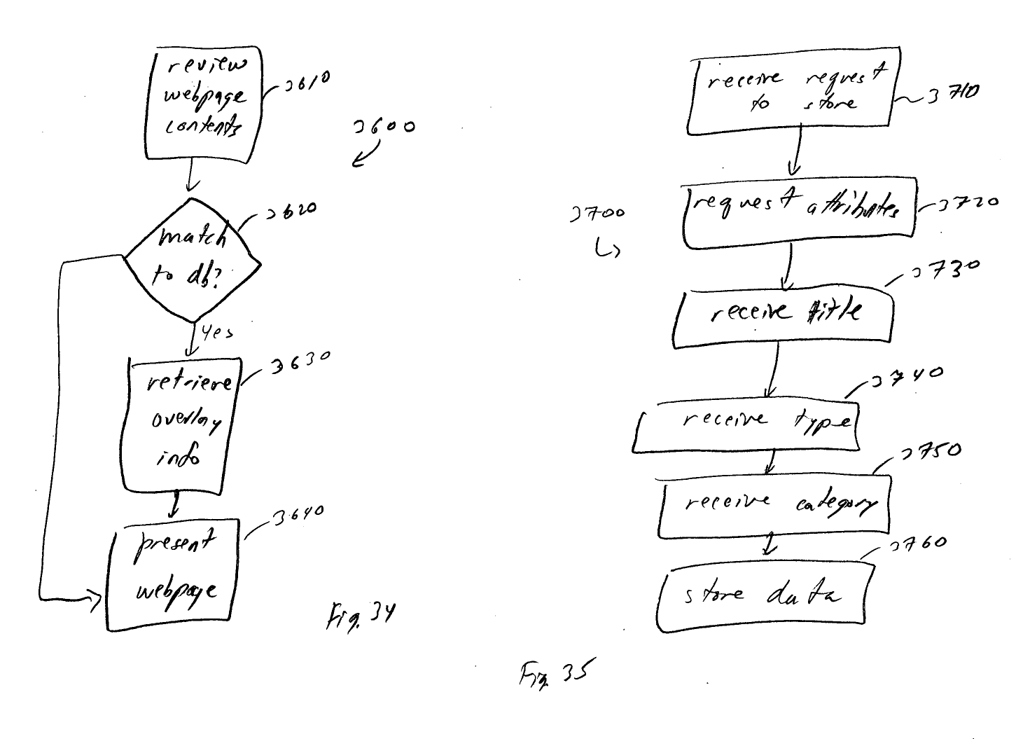

While simply retrieving a webpage may be appropriate in some situations, information may be overlaid on other webpages. FIG. 34 is a flow diagram illustrating an embodiment of a webpage overlay process using a DLS. Process 3600 includes reviewing webpage contents, matching the contents to a database, retrieving overlay information if appropriate, and presenting the webpage.

Process 3600 initiates with receipt of a webpage which is reviewed at module 3610. At module 3620, the webpage contents are checked for a match with a database. If a match is found, overlay information for the webpage is retrieved at module 3630 (and may be added to the webpage). Regardless of whether a match is found, the webpage is presented at module 3640. However, if overlay information has been added at module 3630, this may be part of what is presented, and may be indistinguishable from the rest of the webpage in some embodiments.

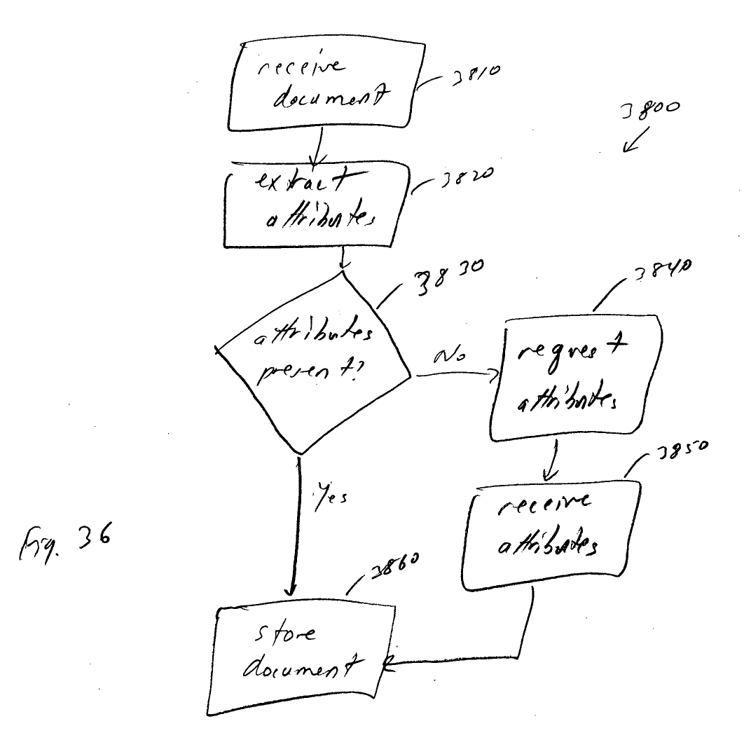

Overlay information for webpages, and other information may also be stored in a DLS. FIG. 35 is a flow diagram illustrating an embodiment of a process of storing data using a DLS. Process 3700 includes receiving a request to store information, requesting attributes of the information, receiving such attributes and storing the data.

Process 3700 initiates with receipt of a request to store information at module 3710. The information may be an overlay for a webpage, for example. At module 3720, attributes of the information to be stored are requested, such as through a user client. At module 3730, a title for the information to be stored is received. Similarly, at module 3740, a type of information to be stored is received. Also, at module 3750, a category for such information is received. The attributes of modules 3730, 3740 and 3750, along with the information itself are stored at module 3760. Note that other attributes may be requested and supplied in other embodiments, and the attributes of such information may take on various different forms, for example.

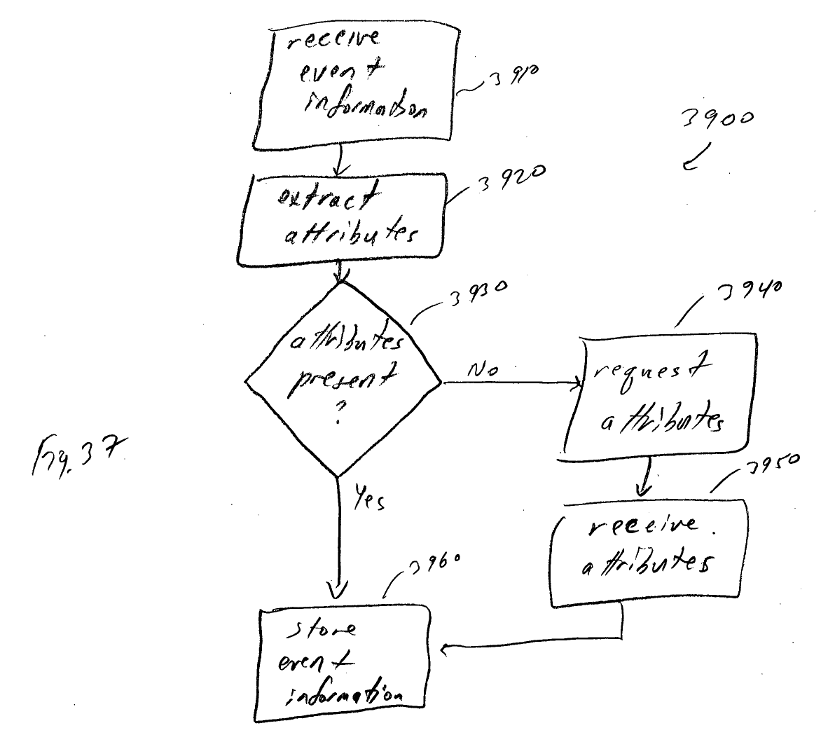

Storing a document may involve a different process. FIG. 36 is a flow diagram illustrating an embodiment of a process of storing a document using a DLS. Process 3800 includes receiving a document, extracting available attributes, determining if attributes are present, requesting and receiving attributes if necessary, and storing the document.

Thus, a document is received at module 3810. At module 3820, attributes of the document are extracted, such as from metadata or a scan of data of the document. At module 3830, a determination is made as to whether attributes needed for storage are present. If not, attributes are requested at module 3840, such as through a user client. Such attributes are then received at module 3850. Whether the attributes need to be requested or not, the document and associated attributes are stored at module 3860.

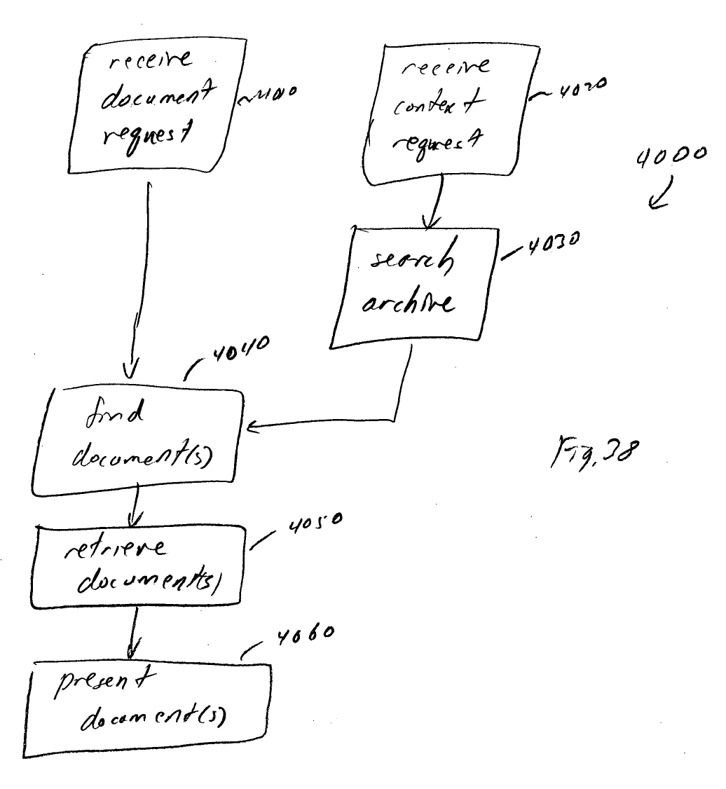

While documents or basic information may be stored routinely, event information may also be stored with a DLS. FIG. 37 is a flow diagram illustrating an embodiment of a process of storing event information using a DLS. Process 3900 includes receiving event information, extracting event attributes, determining if needed attributes are present, requesting and receiving attributes if necessary, and storing the event information.

Event information is received at module 3910. At module 3920, attributes of the event are extracted from the information if possible. For example, a calendar entry may include information about who attended an event or what the topic was, along with time and date. At module 3930, a determination is made if attributes needed for storage are present. If not, attributes are requested at module 3940, such as through a user browser or client. The attributes are then received at module 3950. Whether the attributes need to be requested or not, event information and associated attributes are stored at module 3960.

With information stored, retrieving that information becomes important. FIG. 38 is a flow diagram illustrating an embodiment of a process of retrieving stored information from a DLS. A specific document or a query related to a document may be sought, for example. Thus, process 4000 includes receiving a document request or receiving a context request and searching through an archive for a matching document. With a document identified, process 4000 includes finding the document, retrieving the document and presenting the document.

If a document is specified, this is received as a request at module 4010. If other parameters (e.g. title or date, for example) are specified, a context request is received at module 4020. At module 4030, the context request is used to search the archive for a matching document. Any identified documents (regardless of type of request) are found at module 4040. At module 4050, the found document(s) are retrieved, and at module 4060, the retrieved document(s) are presented to a user, such as through a user client for example.

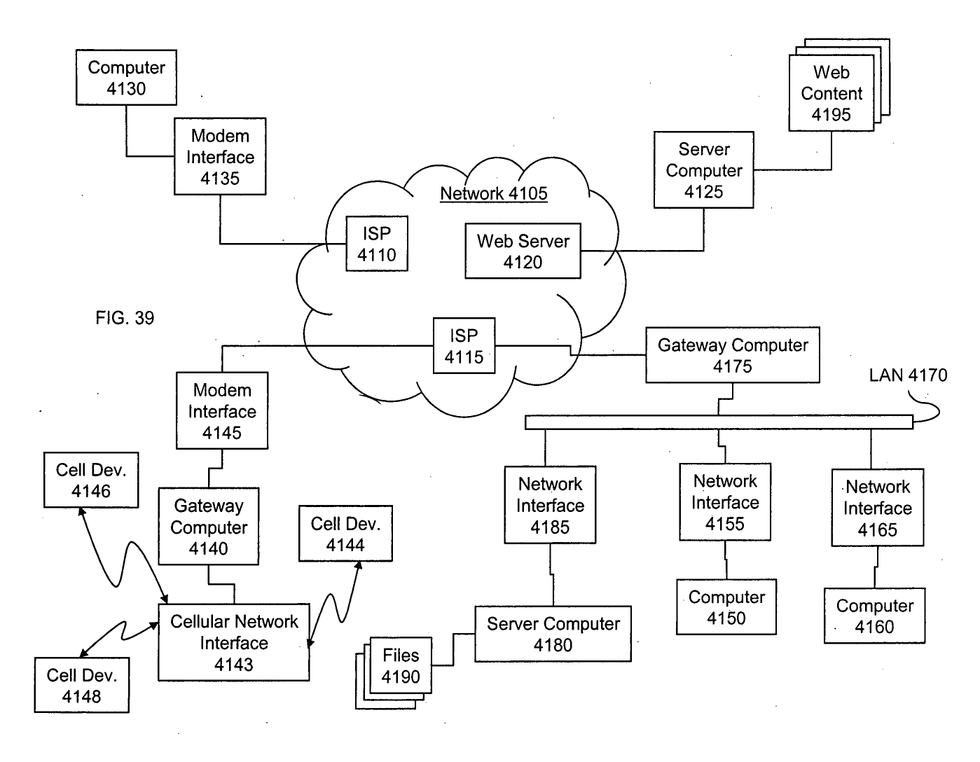

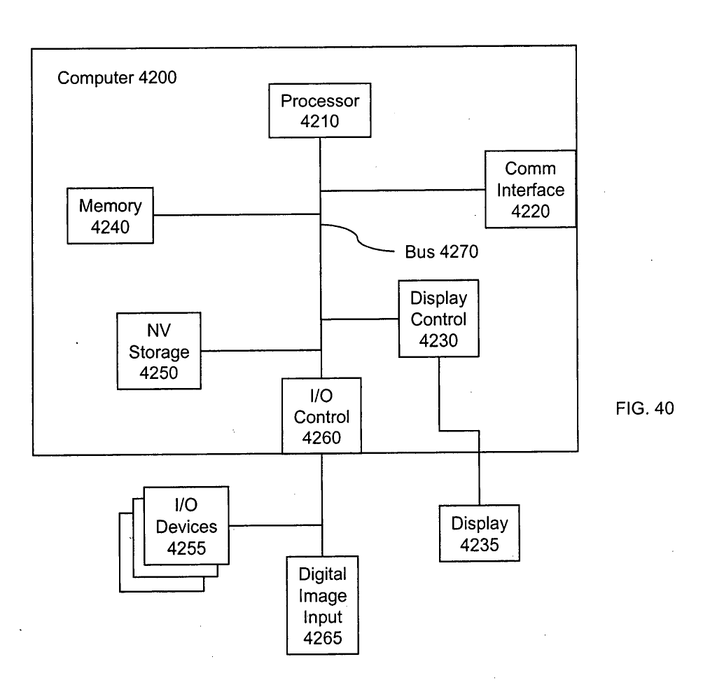

FIG. 39 is a block diagram illustrating an embodiment of a network which may be used with a DLS and related components. FIG. 40 is a block diagram illustrating an embodiment of a machine which may be used with or as a DLS and related components. The following description of FIGS. 41-42 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 39 shows several computer systems that are coupled together through a network 4105, such as the internet, along with a cellular network and related cellular devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 4105 is typically provided by internet service providers (ISP), such as the ISPs 4110 and 4115. Users on client systems, such as client computer systems 4130, 4150, and 4160 obtain access to the internet through the internet service providers, such as ISPs 4110 and 4115. Access to the internet allows users of the client computer systems to exchange information, receive and send e-mails, and view documents, such as documents which have been prepared in the HTML format. These documents are often provided by web servers, such as web server 4120 which is considered to be “on” the internet. Often these web servers are provided by the ISPs, such as ISP 4110, although a computer system can be set up and connected to the internet without that system also being an ISP.

The web server 4120 is typically at least one computer system which operates as a server computer system and is configured to operate with the protocols of the world wide web and is coupled to the internet. Optionally, the web server 4120 can be part of an ISP which provides access to the internet for client systems. The web server 4120 is shown coupled to the server computer system 4125 which itself is coupled to web content 4195, which can be considered a form of a media database. While two computer systems 4120 and 4125 are shown in FIG. 39, the web server system 4120 and the server computer system 4125 can be one computer system having different software components providing the web server functionality and the server functionality provided by the server computer system 4125 which will be described further below.

Cellular network interface 4143 provides an interface between a cellular network and corresponding cellular devices 4144, 4146 and 4142 on one side, and network 4105 on the other side. Thus cellular devices 4144, 4146 and 4142, which may be personal devices including cellular telephones, two-way pagers, personal digital assistants or other similar devices, may connect with network 4105 and exchange information such as email, content, or HTTP-formatted data, for example. Cellular network interface 4143 is coupled to computer 4140, which communicates with network 4105 through modem interface 4145. Computer 4140 may be a personal computer, server computer or the like, and serves as a gateway. Thus, computer 4140 may be similar to client computers 4150 and 4160 or to gateway computer 4175, for example. Software or content may then be uploaded or downloaded through the connection provided by interface 4143, computer 4140 and modem 4145.

Client computer systems 4130, 4150, and 4160 can each, with the appropriate web browsing software, view HTML pages provided by the web server 4120. The ISP 4110 provides internet connectivity to the client computer system 4130 through the modem interface 4135 which can be considered part of the client computer system 4130. The client computer system can be a personal computer system, a network computer, a web tv system, or other such computer system.

Similarly, the ISP 4115 provides internet connectivity for client systems 4150 and 4160, although as shown in FIG. 39, the connections are not the same as for more directly connected computer systems. Client computer systems 4150 and 4160 are part of a LAN coupled through a gateway computer 4175. While FIG. 39 shows the interfaces 4135 and 4145 as generically as a “modem,” each of these interfaces can be an analog modem, isdn modem, cable modem, satellite transmission interface (e.g. “direct PC”), or other interfaces for coupling a computer system to other computer systems.

Client computer systems 4150 and 4160 are coupled to a LAN 4170 through network interfaces 4155 and 4165, which can be ethernet network or other network interfaces. The LAN 4170 is also coupled to a gateway computer system 4175 which can provide firewall and other internet related services for the local area network. This gateway computer system 4175 is coupled to the ISP 4115 to provide internet connectivity to the client computer systems 4150 and 4160. The gateway computer system 4175 can be a conventional server computer system. Also, the web server system 4120 can be a conventional server computer system.

Alternatively, a server computer system 4180 can be directly coupled to the LAN 4170 through a network interface 4185 to provide files 4190 and other services to the clients 4150, 4160, without the need to connect to the internet through the gateway system 4175.

FIG. 40 shows one example of a personal device that can be used as a cellular telephone (4144, 4146 or 4142) or similar personal device, or may be used as a more conventional personal computer, or as a PDA, for example Such a device can be used to perform many functions depending on implementation, such as telephone communications, two-way pager communications, personal organizing, or similar functions. The system 4200 of FIG. 40 may also be used to implement other devices such as a personal computer, network computer, or other similar systems. The computer system 4200 interfaces to external systems through the communications interface 4220. In a cellular telephone, this interface is typically a radio interface for communication with a cellular network, and may also include some form of cabled interface for use with an immediately available personal computer. In a two-way pager, the communications interface 4220 is typically a radio interface for communication with a data transmission network, but may similarly include a cabled or cradled interface as well. In a personal digital assistant, communications interface 4220 typically includes a cradled or cabled interface, and may also include some form of radio interface such as a Bluetooth or 4202.11 interface, or a cellular radio interface for example.

The computer system 4200 includes a processor 4210, which can be a conventional microprocessor such as an Intel pentium microprocessor or Motorola power PC microprocessor, a Texas Instruments digital signal processor, or some combination of the two types or processors. Memory 4240 is coupled to the processor 4210 by a bus 4270. Memory 4240 can be dynamic random access memory (dram) and can also include static ram (sram), or may include FLASH EEPROM, too. The bus 4270 couples the processor 4210 to the memory 4240, also to non-volatile storage 4250, to display controller 4230, and to the input/output (I/O) controller 4260. Note that the display controller 4230 and I/O controller 4260 may be integrated together, and the display may also provide input.

The display controller 4230 controls in the conventional manner a display on a display device 4235 which typically is a liquid crystal display (LCD) or similar flat-panel, small form factor display. The input/output devices 4255 can include a keyboard, or stylus and touch-screen, and may sometimes be extended to include disk drives, printers, a scanner, and other input and output devices, including a mouse or other pointing device. The display controller 4230 and the I/O controller 4260 can be implemented with conventional well known technology. A digital image input device 4265 can be a digital camera which is coupled to an I/O controller 4260 in order to allow images from the digital camera to be input into the device 4200.

The non-volatile storage 4250 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 4200. Rather, a mass storage device on another computer is typically used in conjunction with the more limited storage of the device 4200. Some of this data is often written, by a direct memory access process, into memory 4240 during execution of software in the device 4200. One of skill in the art will immediately recognize that the terms “machine-readable medium” or “computer-readable medium” includes any type of storage device that is accessible by the processor 4210 and also encompasses a carrier wave that encodes a data signal.

The device 4200 is one example of many possible devices which have different architectures. For example, devices based on an Intel microprocessor often have multiple buses, one of which can be an input/output (I/O) bus for the peripherals and one that directly connects the processor 4210 and the memory 4240 (often referred to as a memory bus). The buses are connected together through bridge components that perform any necessary translation due to differing bus protocols.

In addition, the device 4200 is controlled by operating system software which includes a file management system, such as a disk operating system, which is part of the operating system software. One example of an operating system software with its associated file management system software is the family of operating systems known as Windows CE® and Windows® from Microsoft Corporation of Redmond, Wash., and their associated file management systems. Another example of an operating system software with its associated file management system software is the Palm® operating system and its associated file management system. The file management system is typically stored in the non-volatile storage 4250 and causes the processor 4210 to execute the various acts required by the operating system to input and output data and to store data in memory, including storing files on the non-volatile storage 4250. Other operating systems may be provided by makers of devices, and those operating systems typically will have device-specific features which are not part of similar operating systems on similar devices. Similarly, WinCE® or Palms® operating systems may be adapted to specific devices for specific device capabilities.

Device 4200 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

One skilled in the art will appreciate that although specific examples and embodiments of the system and methods have been described for purposes of illustration, various modifications can be made without deviating from the present invention. For example, embodiments of the present invention may be applied to many different types of databases, systems and application programs. Moreover, features of one embodiment may be incorporated into other embodiments, even where those features are not described together in a single embodiment within the present document.

What is claimed is:

1. A method, comprising:
receiving data for archiving from an authenticated user at an archive server of the user's network;
receiving attributes related to the data for archiving; and
archiving the data for archiving and the attributes in a data storage system of the archive server.

2. The method of claim 1, wherein:
the data for archiving is overlay information for a webpage and an attribute is a URL (universal resource locator) for the webpage.

3. The method of claim 1, wherein:
the data for archiving is a document; and
attributes include title, author and creation time.

4. The method of claim 3, further comprising:
extracting attributes from the document.

5. The method of claim 4, further comprising:
requesting attributes of the document from a user.

6. The method of claim 5, further comprising:
determining attributes extracted from the document are insufficient to archive the document.

7. The method of claim 1, wherein:
the data includes data related to an event, and
attributes include attendees, location and time.

8. The method of claim 7, further comprising:
extracting attributes from the data related to the event.

9. The method of claim 8, further comprising:
requesting attributes of the data related to the event from a user.

10. The method of claim 1, wherein:
the method is embodied as instructions in a machine-readable medium, the instructions executable by a processor, the instructions, when executed by a processor, causing the processor to implement the method.

11. A method, comprising:
receiving at a remote server from an authenticated user a request for data;
determining if the data is stored at the remote server; and
providing the data to the authenticated user.

12. The method of claim 11, further comprising:
determining the data is a webpage not stored at the remote server; and
requesting the webpage through the internet.

13. The method of claim 12, further comprising:
determining the webpage has a corresponding overlay within a database of the remote server; and
providing the overlay to the user as part of the data provided to the user.

14. The method of claim 13, further comprising:
retrieving the overlay from a database of the remote server.

15. The method of claim 11, further comprising:
determining the data is a webpage stored at the remote server; and
retrieving the webpage from a local storage system of the remote server.

16. The method of claim 11, further comprising:
determining the data is a document stored at the remote server; and
retrieving the document from a local storage system of the remote server.

17. A system, comprising:
a processor;
a local repository coupled to the processor;
a network interface coupled to the processor;
a local network interface coupled to the processor;
wherein the processor is to:
receive data to be stored from authenticated users through the local network,
store the data to be stored in the local repository,
request data through the network interface from the internet,
receive requests for data stored in the local repository, and
retrieve data stored in the local repository responsive to the requests for data stored in the local repository.

18. The system of claim 17, further comprising:
means for authenticating an identify of a user of the system.

19. The system of claim 17, further comprising:
an authentication engine coupled to the processor.

20. The system of claim 17, wherein:
the processor is further to:
receive a request for data,
retrieve data corresponding to the request for data from the local repository;
retrieve data corresponding to the request from the internet through the network interface; and
combine the data from the local repository and the data from the internet.
